(19) United States
(12) Patent Application Publication
(10) Pub. No.: US 2011/0026121 A1
(43) Pub. Date: Feb. 3, 2011

(54) Laminate, antireflective film, polarizing plate and image display device

(75) Inventors: Masaaki Suzuki, Kanagawa (JP); Hiroyuki Yoneyama, Kanagawa (JP); Katsuyuki Takada, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/805,442

(22) Filed: Jul. 30, 2010

(30) Foreign Application Priority Data
Jul. 31, 2009 (JP) 2009-180221

(51) Int. Cl. G02B 1/11; B32B 27/06; B32B 5/00; G02B 1/04

(52) U.S. Cl. 359/585; 428/532; 428/339

(57) ABSTRACT

A laminate includes a support and a layer formed from a composition containing at least (A) an organic conductive compound and (B) a fluorine-containing curable compound, a common logarithm value (log SR) of surface resistivity SR (Ω/sq) of a surface of the laminate on the layer side is 13.0 or less, and a lower part uneven distribution ratio of the organic conductive compound (A) in the layer defined by the formula as defined herein is from 55 to 100 percent.

### FIELD OF THE INVENTION

The present invention relates to a laminate having an excellent antistatic property, an antireflective film, a polarizing plate using the antireflective film, and an image display device using the antireflective film or the polarizing plate on the outermost surface of the display.

### BACKGROUND OF THE INVENTION

In the field of optics, precision instrument, building material, home appliance or the like, it is useful to apply a film having an antistatic function for the purpose of preventing, for example, dust attachment or electric circuit failure. In particular, in the field of home appliance, from the standpoint of dust resistance, the antistatic property has been recently required for a protective film provided on the surface of image display device, for example, a cathode ray tube display (CRT), a plasma display (PDP), an electroluminescence display (ELD) and a liquid crystal display device (LCD).

The protective film of image display device is required to have various functions, for example, antireflective property, hardcoat property or antifouling property in addition to the antistatic property and thus, it is important to achieve a good balance between these functions.

A protective film (antireflective film) having the antireflective property ordinary comprises a low refractive index layer having a refractive index lower than that of a support and an appropriate layer thickness formed directly or through other layer(s) on the support.

In order to realize a low reflectance in the low refractive index layer of antireflective film, it is desired to use a material having a refractive index as low as possible.

For reducing the reflective index of the material, there are known methods of introducing a fluorine atom, and in particular, it is proposed to use a crosslinkable material containing a fluorine atom (see JP-A-8-92323 (the term “JP-A” as used herein means an “unexamined published Japanese patent application”), JP-A-2003-222702 and JP-A-2003-26732). However, in the case of using a fluorine atom-containing layer on the outermost surface of antireflective film, the increase in a ratio of the fluorine atom in the compound for reducing the reflective index causes that the surface of film tends to be negatively charged to occur a problem in that dust is apt to attach to the surface.

In order to decrease the attachment of dust, it is known to provide a layer (antistatic layer) having conductivity on the antireflective film to release the charge accumulated on the surface of antireflective film.

For instance, in JP-A-2005-196122, JP-A-11-92750 and JP-A-2003-294904, antireflective films provided with an antistatic layer containing conductive particles are described. However, since it is necessary to provide a new layer in addition to the low refractive index layer, the method has a problem of inferior productivity due to the load of facilities and time for the production.

Further, since the conductive particles comprising metal oxide heretofore ordinarily used for the purpose of achieving the antistatic property mostly have a refractive index of approximately from 1.6 to 2.2, the antistatic layer containing such conductive particles has a high reflective index. When the reflective index of antistatic layer increases in an optic film, due to difference in the reflective index from the adjacent layers unintended interference unevenness occurs to cause a problem in that hue of reflected color becomes strong.

In response to the problem, in JP-A-2007-185824, JP-A-2005-316425, JP-A-2007-293325 and JP-A-2007-114772, methods of kneading a conductive agent in a low refractive index layer are described.

SUMMARY OF THE INVENTION

In JP-A-2007-185824, a method of using a silicon alkoxide as a thermosetting binder in combination with an organic antistatic agent is described. However, since the improvement in the antistatic property and the antireflective characteristic are in a tradeoff relationship, it is difficult to achieve both of them. Further, the silicon alkoxide has a problem in that the binder after curing is poor in alkali resistance and it may cause a problem to use an antireflective film on the surface of image display device which may be exposed to an alkaline detergent.

In JP-A-2005-316425 and JP-A-2007-293325, techniques of using an organic antistatic agent in a low refractive index layer containing a binder having alkali resistance are described. It is described that the amount of the organic antistatic agent used in the low refractive index layer is from 0.3 to 5% by weight and the antistatic property is obtained by introduction of a small amount of the antistatic component. It is also described that the concentration of the antistatic agent may be varied in the thickness direction of the low refractive index layer so as to have high concentration of the antistatic component in the surface of the low refractive index layer to form a conductive pass. However, in the cured layer containing a small amount of organic antistatic component localized near the surface thereof, the antistatic characteristic is not necessarily sufficient and sustention of the antistatic characteristic is not enough.

In JP-A-2007-114772, a technique of using fine particles having a coating layer of conductive metal oxide as a low refractive index particles. However, the fine particles are complicated in the step of production and thus, a simpler technique has been requested.

To develop a technique for providing an excellent antistatic property without accompanying degradation of the existing characteristics described above is a common subject not only in the field of antireflective film but also in various fields of technologies.

From the standpoint of cost, development of a technique providing an excellent antistatic property with a small amount of addition has been also strongly requested.

An object of the present invention is to provide a laminate which has an excellent antistatic property and is excellent in productivity. Another object of the invention is to provide an antireflective film having excellent antireflective characteristic, scratch resistance, adhesion property, dust resistance, antifouling property and hardcoat property in case of using the above-described laminate for the antireflective film.

A still another object of the invention is to provide a polarizing plate or image display device using the above-described antireflective film.

As a result of the intensive investigations to solve the above-described problems, the inventors have found that the problems are solved by the constitutions described below to complete the invention. Specifically, the above-described objects can be achieved by the constitutions described below.
(1) A laminate comprising a support and a layer formed from a composition containing at least (A) an organic conductive compound and (B) a fluorine-containing curable compound, wherein a common logarithm value (log SR) of surface resistivity SR (Ω/sq) of a surface of the laminate on the layer side is 13.0 or less and a lower part uneven distribution ratio of the organic conductive compound (A) in the layer defined by a formula shown below is from 55 to 100 percent:

Lower part uneven distribution ratio =[weight of component (A) present in a region from a center to a surface of the layer on the support side in the layer thickness direction of the layer formed from the composition containing component (A) and component (B)]/[total weight of component (A) present in the whole layer formed from the composition containing component (A) and component (B)]×100 (%)
(2) The laminate as described in (1) above, wherein the organic conductive compound (A) is a π-conjugated system conductive polymer or a derivative thereof.
(3) The laminate as described in (2) above, wherein the π-conjugated system conductive polymer is one selected from polythiophene, polyaniline, a polythiophene derivative and a polyaniline derivative.
(4) The laminate as described in any one of (1) to (3) above, wherein the fluorine-containing curable compound (B) includes a repeating unit having a crosslinkable moiety and the crosslinkable moiety is at least any one of a hydroxy group, a silyl group having a hydrolyzable group, a group having a reactive unsaturated double bond, an ring-opening polymerization reactive group, a group having an active hydrogen atom, a group capable of being substituted with a nucleophilic agent, and an acid anhydride.
(5) The laminate as described in any one of (1) to (4) above, wherein the fluorine-containing curable compound (B) is a compound represented by formula (1) shown below.

(MF1)ₐ-(MF2)_{b}-(MF3)_{c}-(MA)_{d}-(MB)ₑ Formula (1)

In formula (1), a to e each represents a mole fraction of each constituting component and represents a value satisfying 0≦a≦70, 0≦b≦70, provided that 30≦a+b≦70, 0≦c≦50, 5≦d≦50 and 0≦e≦50 respectively.

(MF1) represents a constituting component polymerized from a monomer represented by CF₂═CF—Rf₁, wherein Rf₁ represents a perfluoroalkyl group having from 1 to 5 carbon atoms.

(MF2) represents a constituting component polymerized from a monomer represented by CF₂F═Rf₁₂, wherein Rf₁₂ represents a fluorine-containing alkyl group having from 1 to 30 carbon atoms.

(MF3) represents a constituting component polymerized from a monomer represented by CH₂═CH—ORf₁₃, wherein Rf₁₃ represents a fluorine-containing alkyl group having from 1 to 30 carbon atoms.

(MA) represents a constituting component having at least one crosslinkable group.

(MB) represents a constituting component having a polysiloxane structure.
(6) The laminate as described in any one of (1) to (5) above, wherein the composition further contains at least any one of (C) a fluorine-containing antifouling agent and (D) a silicone type antifouling agent.
(7) The laminate as described in any one of (1) to (6) above, wherein the composition further contains at least one good solvent for component (A) and at least one good solvent for component (B).
(8) The laminate as described in any one of (1) to (7) above, wherein a thickness of the layer formed from the composition is from 20 nm to 5 μm.
(9) An antireflective film comprising the laminate as described in any one of (1) to (6) above, wherein the support is a transparent support, and the laminate has a low refractive index layer formed from the composition containing at least (A) an organic conductive compound and (B) a fluorine-containing curable compound.
(10) A polarizing plate comprising a polarizing film and two protective films for protecting a front side and a rare side of the polarizing film, wherein at least one of the protective films is the antireflective film as described in (9) above.
(11) An image display device having the antireflective film as described in (9) above or the polarizing plate as described in (10) above.

According to the present invention, a laminate excellent in the antistatic property and excellent in the productivity can be provided. Since the laminate according to the invention is excellent in the antistatic property and excellent in the productivity, it can be applied to various fields, for example, field of optics, precision instrument, building material or home appliance, requiring the antistatic property for the purpose of preventing, for example, dust attachment or electric circuit failure due to charge.

Further, according to the present invention, an antireflective film excellent in the antistatic property, dust resistance, antifouling property and hardcoat property and having a sufficient antireflective characteristic can be provided.

Moreover, using the antireflective film, a polarizing plate or image display device having high quality can be provided.

### DETAILED DESCRIPTION OF THE INVENTION

The present invention will be described in more detail below. In the specification, when a numerical value represents a physicality value, a characteristic value or the like, the expression “(numerical value 1) to (numerical value 2)” means “from (numerical value 1) or more to (numerical value 2) or less”. Also, the term “(meth)acrylate” means “at least any one of acrylate and methacrylate”. The terms “(meth)acryloyl” and “(meth)acrylic acid” are also same as above.

The laminate according to the invention is a laminate comprising a support and a layer formed from a composition containing at least (A) an organic conductive compound and (B) a fluorine-containing curable compound. In the laminate according to the invention, a common logarithm value (log SR) of surface resistivity SR (Ω/sq) of a surface of the laminate on the layer side is 13.0 or less and a lower part uneven distribution ratio of the organic conductive compound of component (A) in the layer defined by a formula shown below is from 55 to 100 percent.

Lower part uneven distribution ratio=[weight of component (A) present in a region from a center to a surface of the layer on the support side in the layer thickness direction of the layer formed from the composition containing component (A) and component (B)]/[total weight of component (A) present in the whole layer formed from the composition containing component (A) and component(B)]×100 (%)

### [Surface Resistivity]

The common logarithm value (log SR) of surface resistivity SR (Ω/sq) of the laminate according to the invention is 13.0 or less, preferably 11 or less and more preferably 9 or less. By controlling the value of surface resistivity in the range described above, the excellent dust resistance can be imparted.

As the surface resistivity is lower, a more preferable result is obtained from the standpoint of prevention of static charge. The lower limit of the surface resistivity is not particularly restricted but the lower limit of log SR is preferably about 3, and more preferably 5.

The laminate according to the invention has a layer formed from a composition containing (A) an organic conductive compound and (B) a fluorine-containing curable compound as described above. By appropriately selecting kinds and concentrations of (A) the organic conductive compound and (B) the fluorine-containing curable compound, and kinds of (C) a fluorine-containing antifouling agent, (D) a silicone type antifouling agent, a volatile solvent used or the like, the above-describe value of the surface resistivity can be achieved. Although the laminate according to the invention may further have a layer containing other conductive material(s), it is preferred that the layer having conductivity is one from the standpoint of productivity and adhesion property of coated layer or the like.

### [Lower Part Uneven Distribution Ratio of Organic Conductive Compound]

In the laminate according to the invention, the lower part uneven distribution ratio of (A) the organic conductive compound in the layer defined by a formula shown below is from 55 to 100 percent.

Lower part uneven distribution ratio=[weight of component (A) present in a region from a center to a surface of the layer on the support side in the layer thickness direction of the layer formed from the composition containing component (A) and component (B)]/[total weight of component (A) present in the whole layer formed from the composition containing component (A) and component (B)]×100 (%)

The lower part uneven distribution ratio is from 55 to 100 percent, preferably from 60 to 100 percent, more preferably from 70 to 100 percent, and still more preferably from 80 to 100 percent.

As the lower part uneven distribution ratio is higher, intermolecular distance between the organic conductive compounds becomes shorter to exhibit more excellent conductivity. Further, since the amount of the organic conductive compound used can be reduced, it is advantageous in view of cost.

Moreover, by increasing the lower part uneven distribution ratio, when an antireflective film is prepared, the antistatic property can be imparted without accompanying degradation of the antireflective characteristic, scratch resistance or the like, and durability (for example, moisture/heat resistance or light resistance) of the organic conductive compound can be improved.

In order to promote the uneven distribution of organic conductive compound and to increase the conductivity, it is preferred to control compatibility between the fluorine-containing curable compound and the organic conductive compound. When the compatibility between the organic conductive compound and the fluorine-containing curable compound is increased, the organic conductive compounds are averagely distributed and the contact frequency of the organic conductive compounds decreases to result in reduction of the conductivity. On the other hand, when the compatibility is too poor, the surface state of the coated layer is degraded.

According to the invention, as well as decreasing the compatibility between the organic conductive compound and the fluorine-containing curable compound, appropriate affinity is maintained therebetween and further upper part or lower part orientation of the both compounds in the layer is controlled. Thus, the distributions of the compounds in the layer are varied in the layer thickness direction and the organic conductive compound is unevenly distributed in the lower part of the layer to improve the conductivity, adhesion property, scratch resistance and surface state.

In order that the organic conductive compound may be unevenly distributed in the lower part of the layer in the range described above according to the invention, it is preferred to adequately design the factors shown below. The details are described hereinafter with respect to each component.
(1) The organic conductive compound which is component (A) is hydrophobilized so as to have affinity with the fluorine-containing curable compound which is component (B).
(2) Component (B) has a functional group having a high polarity in its molecule.
(3) Component (B) per se or a compound which has high affinity with component (B) has the lowest surface free energy of the components constituting the layer.
(4) A solvent for dissolving component (A) and component (B), coating, drying and curing is adequately selected.
(5) A (surface) composition of a base material for forming the layer containing component (A) and component (B) is adequately selected.

In the laminate according to the invention, a low surface energy of the fluorine-containing curable compound works as a driving force for the formation of uneven distribution and the fluorine-containing curable compound is unevenly dispersed on the side of air interface and the organic conductive compound is unevenly dispersed in the lower part. In the invention, for example, when the composition containing the fluorine-containing curable compound and the organic conductive compound according to the invention is coated and dried to remove the solvent, thereby forming a state of the lower part uneven distribution, a layer construction seemed to be composed of two layers each having a refractive index different from each other depending on the structure of the fluorine-containing curable compound or the coexisting additive composition, and such a case is also regard as one layer.

With respect to the lower part uneven distribution rate according to the invention, the weight of organic conductive compound in the layer can be determined according to the method described below.

First, the laminate is obliquely cut at an angle of 5 to 0.02° by a microtome and the cut section of the layer obtained is analyzed by TOF-SIMS method.

Although a spatial resolution of ion image by the TOF-SIMS method is approximately from 0.1 to 0.2 μm, the oblique cut makes it possible to quantitatively comprehend distribution of the organic conductive compound in the layer thickness direction in the thin layer.

The TOF-SIMS method is an abbreviation of Time-of-Flight Secondary Ion Mass Spectrometry and is a method wherein an ion image reflecting a structure of an organic compound present on the surface of a solid sample can be determined by measuring a secondary ion, for example, a molecular ion or fragment ion, which is discharged from a molecule in the sample by irradiation of a primary ion, for example, Ga⁺ or In⁺.

The detection of secondary ion by the TOF-SIMS method can be conducted by using any of a positive ion and a negative ion. According to the present invention, a positive ion is selected and the total secondary ion image of 0 to 1,000 amu (amu: atommass unit) is measured in a raw data form in the same region of the cut section of the layer. In order to neutralize charge-up on the surface of the sample during the measurement, a flood gun may be used.

The laminate according to the invention comprises a support and a layer formed from a composition containing at least (A) an organic conductive compound and (B) a fluorine-containing curable compound.

Each constitution used in the laminate according to the invention will be described below.

### [(A) Organic Conductive Compound]

The organic conductive compound (A) may be any of a polymer compound and a low molecular weight compound. In order to promote the uneven distribution of the organic conductive compound in the lower part of the layer, it is desirable that diffusion of the organic conductive compound to the upper part of the layer in which the fluorine-containing curable compound constitutes the main component is low and that failure in surface state of the layer is low. Thus, a polymer compound is preferably used.

As the organic conductive compound (A) having a low molecular weight, an ion-conductive compound is used.

As the organic conductive compound (A) of polymer compound, an ionic conductive polymer and a π-conjugated system conductive polymer are exemplified.

### (Ionic Conductive Polymer)

The ionic conductive polymer includes, for example, an ionene type polymer having a dissociable group in its main chain and a cationic polymer compound.

Examples of the ionic conductive polymer include an ionene type polymer having a dissociable group in its main chain as described in JP-B-49-23828 (the term “JP-B” as used herein means an “examined Japanese patent publication”), JP-B-49-23827, JP-B-47-28937, JP-B-55-734, JP-A-50-54672, JP-A-59-14735, JP-A-57-18175, JP-A-57-18176 and JP-A-57-56059, and a cationic polymer compound as described in JP-B-53-13223, JP-B-57-15376, JP-B-53-45231, JP-B-55-145783, JP-B-55-65950, JP-B-55-67746, JP-B-55-11342, JP-B-57-19735, JP-B-58-56858, JP-A-61-27853, JP-A-62-9346, JP-A-10-279833 and JP-A-2000-80169.

A particularly preferable ionic conductive polymer is a polymer type quaternary ammonium salt containing a quaternary ammonium cation. When the polymer type quaternary ammonium salt is used as the organic conductive polymer, the laminate excellent in the surface state of the coated layer and adhesion property is obtained.

The content of the ionic conductive polymer compound in the composition containing components (A) and (B) is preferably from 6 to 70% by weight, more preferably from 6 to 50% by weight, most preferably from 10 to 40% by weight, based on the total solid content of the composition. When the content of the ionic conductive polymer compound is 6% by weight or more, sufficient conductivity is obtained and when it is 70% by weight or less, deterioration of the adhesion property or surface state of the coated layer hardly occur.

### (π-Conjugated System Conductive Polymer)

As the π-conjugated system conductive polymer, any organic polymer the main chain of which is constituted with a π-conjugated system may be used without particular limitation. The π-conjugated system conductive polymer is preferably a π-conjugated system heterocyclic compound or a derivative of π-conjugated system heterocyclic compound in view of compound stability and high conductivity.

The π-conjugated system conductive polymer includes at least one member selected from the group consisting of an aliphatic conjugated system including polyacetylene, polyacene or polyazulene, an aromatic conjugated system including polyphenylene, a heterocyclic conjugated system including polypyrrole, polythiophene or polyisothianaphthene, a hetero atom-containing conjugated system including polyaniline or polythienylenevinylene, a mixed type conjugated system including poly(phenylenevinylene), a multiple chain type conjugated system which is a conjugated system including plural conjugated chains in its molecule, derivatives of these conductive polymers, and a conductive complex which is a polymer formed by graft or block copolymerization of the conjugated polymer chain described above to a saturated polymer.

From the standpoint of stability in the air, polypyrrole, polythiophene, polyaniline or a derivative thereof is preferred, and polythiophene, polyaniline, a polythiophene derivative or a polyaniline derivative is more preferred.

Although the π-conjugated system conductive polymer exhibits sufficient conductivity and compatibility with a binder resin even when it is unsubstituted, it is preferred to introduce a functional group, for example, an alkyl group, a carboxyl group, a sulfo group, an alkoxy group or a hydroxy group into the π-conjugated system conductive polymer in order to more increase the conductivity and compatibility.

Specific examples of the π-conjugated system conductive polymer include, a polypyrrole, for example, polypyrrole, poly(N-methylpyrrole), poly(3-methylpyrrole), poly(3-ethylpyrrole), poly(3-n-propylpyrrole), poly(3-butylpyrrole), poly(3-octylpyrrole), poly(3-decylpyrrole), poly(3-dodecylpyrrole), poly(3,4-dimethylpyrrole), poly(3,4-dibutylpyrrole), poly(3-carboxypyrrole), poly(3-methyl-4-carboxypyrrole), poly(3-methyl-4-carboxyethylpyrrole), poly(3-methyl-4-carboxybutylpyrrole), poly(3-hydroxypyrrole), poly(3-methoxypyrrole), poly(3-ethoxypyrrole), poly(3-butoxypyrrole) or poly(3-methyl-4-hexyloxypyrrole), a polythiophene, for example, polythiophene, poly(3-methylthiophene), poly(3-ethylthiophene), poly(3-propylthiophene), poly(3-butylthiophene), poly(3-hexylthiophene), poly(3-heptylthiophene), poly(3-octylthiophene), poly(3-decylthiophene), poly(3-dodecylthiophene), poly(3-octadecylthiophene), poly(3-bromothiophene), poly(3-chlorothiophene), poly(3-iodothiophene), poly(3-cyanothiophene), poly(3-phenylthiophene), poly(3,4-dimethylthiophene), poly(3,4-dibutylthiophene), poly(3-hydroxythiophene), poly(3-methoxythiophene), poly(3-ethoxythiophene), poly(3-butoxythiophene), poly(3-hexyloxythiophene), poly(3-heptyloxythiophene), poly(3-octyloxythiophene), poly(3-decyloxythiophene), poly(3-dodecyloxythiophene), poly(3-octadecyloxythiophene), poly(3-methyl-4-methoxythiophene), poly(3,4-ethylenedioxythiophene), poly(3-methyl-4-ethoxythiophene), poly(3-carboxythiophene), poly(3-methyl-4-carboxythiophene), poly(3-methyl-4-carboxyethylthiophene) or poly(3-methyl-4-carboxybutylthiophene), a polyaniline, for example, polyaniline, poly(2-methylaniline), poly(3-isobutylaniline), poly(2-anilinesulfonic acid) and poly(3-anilinesulfonic acid).

(Polymer Dopant having Anion Group)

It is preferred that the π-conjugated system conductive polymer is used together with a polymer dopant having an anion group (hereinafter, also referred to as a “polyanion dopant”). Specifically, in such a case, the organic conductive compound is an organic conductive polymer composition containing an organic conductive polymer compound (π-conjugated system conductive polymer) and a polymer dopant having an anion group. By the combination of the π-conjugated system conductive polymer with the polymer dopant having an anion group, high conductivity, the improvement in time-lapse stability of the conductivity and the increase in water resistance as the laminate are achieved.

Examples of the polyanion dopant include a polymer containing any one of structures selected from substituted or unsubstituted polyalkylene, substituted or unsubstituted polyalkenylene, substituted or unsubstituted polyimide, substituted or unsubstituted polyamide and substituted or unsubstituted polyester and a structural unit having an anionic group.

The polyalkylene is a polymer having a main chain constituted from repetition of methylene. Examples of the polyalkylene include polyethylene, polypropylene, polybutene, polypentene, polyhexene, polyvinyl alcohol, polyvinyl phenol, poly(3,3,3-trifluoropropylene), polyacrylonitrile, polyacrylate and polystyrene.

The polyalkenylene is a polymer having a main chain consisted form a structural unit containing an unsaturated double bond (a vinyl group).

The polyimide includes polyamides formed from an acid anhydride, for example, pyromellitic anhydride, biphenyltetracarboxylic anhydride, benzophenonetetracarboxylic anhydride or 2,2′-[4,4′-di(dicarboxyphenylthio)phenyl]propane dihydride and a diamine, for example, oxydiamine, paraphenylenediamine, metaphenylenediamine or benzophenonediamine.

The polyamide includes, for example, polyamide 6, polyamide 6,6 and polyamide 6,10.

The polyester includes, for example, polyethylene terephthalate and polybutylene terephthalate.

In the case where the polyanion dopant has a substituent, examples of the substituent include an alkyl group, a hydroxy group, an amino group, a carboxyl group, a cyano group, a phenyl group, a phenol group, an ester group and an alkoxy group. Considering solubility in an organic solvent, heat resistance, compatibility with a binder resin or the like, an alkyl group, a hydroxy group, a phenol group or an ester group is preferred.

The alkyl group includes, for example, a chain (strait-chain or branched) alkyl group, for example, a methyl group, an ethyl group, a propyl group, a butyl group, an isobutyl group, a tert-butyl group, a pentyl group, a hexyl group, an octyl group, a decyl group or a dodecyl group, and a cycloalkyl group, for example, a cyclopropyl group, a cyclopentyl group or a cyclohexyl group.

The hydroxy group includes a hydroxy group connected directly or through other functional group to the main chain of polyanion dopant. The other functional group includes, for example, an alkyl group having from 1 to 7 carbon atoms, an alkenyl group having from 2 to 7 carbon atoms, an amido group and an imido group. The hydroxy group may be present at the terminal of or in the functional group.

The amino group includes an amino group connected directly or through other functional group to the main chain of polyanion dopant. The other functional group includes, for example, an alkyl group having from 1 to 7 carbon atoms, an alkenyl group having from 2 to 7 carbon atoms, an amido group and an imido group. The amino group may be present at the terminal of or in the functional group.

The phenol group includes a phenol group connected directly or through other functional group to the main chain of polyanion dopant. The other functional group includes, for example, an alkyl group having from 1 to 7 carbon atoms, an alkenyl group having from 2 to 7 carbon atoms, an amido group and an imido group. The phenol group may be present at the terminal of or in the functional group.

The anionic group of the polyanion dopant include, for example, —O—SO₃⁻X⁺, —SO₃⁻X⁺ and —COO⁻X⁺ (wherein X⁺ represents a hydrogen ion or an alkali metal ion). Of the anionic groups, —SO₃⁻X⁺ or —COO⁻X⁺ is preferred from the standpoint of doping ability to the organic conductive polymer compound.

Of the polyanion dopants, in view of the solvent solubility and conductivity, polyisoprenesulfonic acid, a copolymer containing isoprenesulfonic acid, polysulfoethyl methacrylate, a copolymer containing sulfoethyl methacrylate, poly(4-sulfobutyl methacrylate), a copolymer containing 4-sulfobutyl methacrylate, polymethacryloxybenzenesulfonic acid, a copolymer containing methacryloxybenzenesulfonic acid, polystyrenesulfonic acid and a copolymer containing styrenesulfonic acid are preferred.

As for polymerization degree of the polyanion dopant, a number of monomer units is preferably in a range of 10 to 100,000, and, in view of the solvent solubility and conductivity, more preferably in a range of 50 to 10,000.

The content of the polyanion dopant is preferably in arrange of 0.1 to 10 mol, and more preferably in arrange of 1 to 7 mol, per mole of the organic conductive polymer compound. The molar numbers as used herein are defined as a number of structural unit derived from a monomer containing an anionic group for forming the polyanion dopant and a number of structural unit derived from a monomer, for example, pyrrole, thiophene or aniline for forming the organic conductive polymer compound. When the content of polyanion dopant is 0.1 mol or more per mole of the organic conductive polymer compound, the doping effect for the organic conductive polymer compound becomes large to sufficiently exhibit the conductivity. In addition, dispersibility or solubility in a solvent increases to easily prepare a uniform dispersion. When the content of polyanion dopant is 10 mol or less per mole of the organic conductive polymer compound, the organic conductive polymer compound can be contained in a large amount to easily obtain sufficient conductivity.

The total content of the organic conductive polymer compound and polyanion dopant in the composition containing components (A) and (B) is preferably from 6 to 70% by weight, more preferably from 6 to 50% by weight, most preferably from 10 to 40% by weight, based on the total solid content of the composition. When the total content of the organic conductive polymer compound and polyanion dopant is 6% by weight or more, sufficient conductivity is obtained and when it is 70% by weight or less, deterioration of the adhesion property or surface state of the coated layer hardly occur.

### (Solubility in Organic Solvent)

It is preferred that the organic conductive polymer compound is soluble in an organic solvent from the standpoint of coating property or provision of affinity with component (B) according to the invention.

More specifically, it is preferred that the organic conductive polymer compound is soluble at least 1.0% by weight in an organic solvent having a water content of 5% by weight or less and a dielectric constant of 2 to 30.

The term “soluble” as used herein indicates a state where the organic conductive polymer compound exists in the form of a single molecule or an association of plural molecules in the organic solvent or a state where the Organic conductive polymer compound is dispersed as a particle having a particle size of 300 nm or less in the organic solvent.

In general, the organic conductive polymer compound has a high hydrophilicity and is conventionally soluble in a solvent having water as the main component. In order to solubilize such an organic conductive polymer compound in an organic solvent, a method is exemplified where a compound which increases affinity with the organic solvent or a dispersant in the organic solvent is added to a composition containing the organic conductive polymer compound. Also, when the organic conductive polymer compound is used together with the polyanion dopant, it is preferred to conduct hydrophobilizing treatment of the polyanion dopant as described below.

Further, a method is also used where the organic conductive polymer compound is used in an undoped state to increase the solubility in organic solvent and after the formation of a layer the dopant is added to generate conductivity.

In addition to the above, methods described in the references described below are also preferably used as the method of increasing the solubility in organic solvent.

For instance, in JP-A-2002-179911 a method is described where a polyaniline composition is dissolved in an organic solvent in an undoped state, the material is coated on a base material and dried, and then subjected to oxidation and doping treatments with a solution in which a protonic acid and an oxidizing agent are dissolved or dispersed to generate conductivity.

Also, in WO 05/035626 a method of producing a conductive polyaniline capable of being stably dispersed in an organic solvent is described where in oxidation polymerization of aniline or a derivative thereof in a mixed phase composed of an aqueous phase and an organic phase in the presence of at least one of a sulfonic acid and a water-insoluble organic polymer compound having a protonic acid group, a molecular weight modifier and, if desired, a phase-transfer catalyst are caused to coexist.

As a commercially available hydrophobilized conductive polymer composition containing a π-conjugated system conductive polymer and a polymer dopant having an anionic group, for example, SEPLEGYDA SAS-PD: polythiophene dispersion (solid content: 4.2%), produced by Shin-Etsu polymer Co., Ltd. and ELCOAT UVH515: hydrophobilized polythiophene (solid content: 2.7%), produced by Idemitsu Technofine Co., Ltd. are exemplified.

As the organic solvent, for example, an alcohol, an aromatic hydrocarbon, an ether, a ketone and an ester are preferred. Specific examples of the organic solvent are set forth below. The dielectric constant of each organic solvent is also shown in parentheses.

The alcohol includes, for example, a monohydric alcohol and a dihydric alcohol. The monohydric alcohol is preferably a saturated aliphatic alcohol having from 2 to 8 carbon atoms. Specific examples of such an alcohol include ethyl alcohol (25.7), n-propyl alcohol (21.8), isopropyl alcohol (18.6), n-butyl alcohol (17.1), sec-butyl alcohol (15.5) and tert-butyl alcohol (11.4).

Specific examples of the aromatic hydrocarbon include benzene (2.3), toluene (2.2) and xylene (2.2). Specific examples of the ether include tetrahydrofuran (7.5), ethylene glycol monomethyl ether (16), ethylene glycol monomethyl ether acetate (8), ethylene glycol monomethyl ether (14), ethylene glycol monoethyl ether acetate (8) and ethylene glycol monobutyl ether (9). Specific examples of the ketone include acetone (21.5), diethyl ketone (17.0), methyl ethyl ketone (15.5), diacetone alcohol (18.2), methyl isobutyl ketone (13.1) and cyclohexanone (18.3). Specific examples of the ester include methyl acetate (7.0), ethyl acetate (6.0), propyl acetate (5.7) and butyl acetate (5.0).

From the standpoint that both the organic conductive polymer compound and the fluorine-containing curable compound can be dissolved or dispersed, the dielectric constant is more preferably from 2.3 to 24, still more preferably from 4.0 to 21, and most preferably from 5.0 to 21. For example, isopropyl alcohol, acetone, propylene glycol monoethyl ether, cyclohexanone and methyl acetate are preferred and isopropyl alcohol, acetone, propylene glycol monoethyl ether are particularly preferred.

The dielectric constant as used herein is a value measures at 20° C.

In the invention, the organic solvent having a dielectric constant of 2 to 30 may be used as a mixture of two or more thereof. Although an organic solvent having a dielectric constant higher than 30 or not more than 5% by weight of water may be used together with the above-described organic solvent, it is preferred that in a mixed organic solvent system containing the above-described organic solvent, a weight average dielectric constant of plural organic solvent and water is not exceed 30. In the range described above, a coating composition containing both the organic conductive polymer compound and the fluorine-containing curable compound dissolved or dispersed therein can be formed, thereby preparing a laminate having a good surface state of the coated layer.

According to the invention, the organic conductive polymer compound is soluble at least 1.0% by weight in the organic solvent.

In the organic solvent, the organic conductive polymer compound may be present in the form of particle. In this case, an average particle size of the particle is preferably 300 nm or less, more preferably 200 nm or less, and still more preferably 100 nm or less. By controlling the average particle size to the range described above, sedimentation of the particle can be prevented. The lower limit of the particle size is not particularly restricted.

In order to remove coarse particles or to promote dissolution, a high pressure disperser may be used. Examples of the high pressure disperser include Gaulin (produced by APV Gaulin), Nanomizer (produced by Nanomizer Inc.), Microfluidizer (produced by Microfluidics Corp.), Multimizer (produced by Sugino Machine Ltd.) and DeBEE (produced by BEE). The particle size is determined by skimming the organic solvent solution with a grid for an electron microscope and observing after the volatilization of the solvent.

In the case of using the polyanion dopant together with the organic conductive polymer compound as described above, it is preferred that the composition containing the organic conductive polymer compound and the polymer dopant is subjected to a hydrophobilizing treatment. By performing the hydrophobilizing treatment of the composition, solubility of the organic conductive polymer compound in an organic solvent can be increased to improve the affinity to the fluorine-containing curable compound (B). The hydrophobilizing treatment can be performed by modifying an anionic group of the polyanion dopant.

Specifically, a first method of the hydrophobilizing treatment includes, for example, a method of esterification, etherification, acetylation, tosylation, tritylation, alkylsilylation or alkylcarbonylation of the anionic group. Among them, the esterification or etherification is preferred. The method of hydrophobilization by the esterification includes a method where an anionic group of the polyanion dopant is chlorinated with a chlorinating agent and then esterified with an alcohol, for example, methanol or ethanol. Also, using a compound having a hydroxy group or a glycidyl group and an unsaturated double bond group, esterification is conducted with a sulfo group or a carboxyl group to hydrophobilize.

In the invention, heretofore known various methods can be used and examples thereof are specifically described, for example, in JP-A-2005-314671 and JP-A-2006-28439.

A second method of the hydrophobilizing treatment includes a method of connecting a basic compound to an anionic group of the polyanion dopant to conduct hydrophobilization. The basic compound is preferably an amine compound and includes, for example, a primary amine, a secondary amine, a tertiary amine or an aromatic amine. Specific examples thereof include a primary, secondary or tertiary amine substituted with an alkyl group having from 1 to 20 carbon atoms, imidazole substituted with an alkyl group having from 1 to 20 carbon atoms and pyridine. For the purpose of increasing solubility in organic solvent, a molecular weight of the amine compound is preferably from 50 to 2,000, more preferably from 70 to 1,000, and most preferably from 80 to 500.

An amount of the amine compound as the basic hydrophobilizing agent is preferably from 0.1 to 10.0 molar equivalents, more preferably from 0.5 to 2.0 molar equivalents, particularly preferably from 0.85 to 1.25 molar equivalents, based on the anionic groups of polyanion dopant which do not contribute to doping of the organic conductive polymer compound. In the range described above, the solubility in organic solvent, conductivity and strength of the coated layer are fulfilled.

Further, with respect to the details of the hydrophobilizing treatment, descriptions, for example, in JP-A-2008-115215 and JP-A-2008-115216 can be referred to.

### (Solubilization Aid)

The organic conductive polymer compound may be used together with a compound (hereinafter referred to as a solubilization aid) containing a hydrophilic moiety and a hydrophobic moiety and preferably, an ionizing radiation curable functional group in its molecule.

By using the solubilization aid, the solubilization of the organic conductive polymer compound in an organic solvent having a low water content is assisted and further improvement in the surface state of the coated layer and increase in the strength of the cured layer are achieved in the layer formed from the composition according to the invention.

The solubilization aid is preferably a polymer containing a hydrophilic moiety, a hydrophobic moiety and an ionizing radiation curable functional group, and particularly preferably a block type or graft type copolymer wherein these segments are present separately. Such a copolymer may be obtained by living anion polymerization, living radical polymerization or polymerization using a macromonomer having the segment described above.

The solubilization aid is described, for example, in Paragraph Nos. [0022] to [0038] of JP-A-2006-176681.

### (Low Molecular Weight Dopant)

According to the invention, a low molecular weight dopant is preferably used in addition to the polyanion dopant. The low molecular weight dopant is a compound having a molecular weight of 1,000 or less and two or less anionic groups in its molecule. Among them, it is preferred to contain at least one compound selected from 2-acrylamido-2-methyl-1-propanesulfonic acid, sodium 1,1-oxybistetrapropylene derivative benzenesulfonate and vinylallylsulfonic acid.

### (Preparation Method of Solution Containing Organic Conductive Polymer Compound)

The organic conductive polymer compound is prepared in the form of a solution thereof using the organic solvent described above.

Although several methods are known for the preparation of a solution of the organic conductive polymer compound, three methods shown below are preferred.

A first method is a method comprising polymerizing a organic conductive polymer compound in water in the presence of a polyanion dopant, then, if desired, treating by adding the solubilization aid or basic hydrophobilizing agent described above, and thereafter replacing the water with the organic solvent. A second method is a method comprising polymerizing a organic conductive polymer compound in water in the presence of a polyanion dopant, then, if desired, treating by adding the solubilization aid or basic hydrophobilizing agent described above, evaporating the water to dryness, and thereafter adding the organic solvent to solubilize. A third method is a method comprising preparing separately a π-conjugated system conductive polymer and a polyanion dopant, mixing and dispersing the both in a solvent to prepare a dope of a conductive polymer composition, and replacing water with the organic solvent when the solvent contains the water.

In the methods described above, an amount of the solubilization aid used is preferably from 1 to 100% by weight, more preferably from 2 to 70% by weight, most preferably from 5 to 50% by weight, based on the total amount of the organic conductive polymer compound and polyanion dopant. In the first method, the method of replacing water with the organic solvent is preferably a method of adding a highly water-miscible solvent, for example, ethanol, isopropyl alcohol or acetone to prepare a uniform solution and removing the water by ultrafiltration. Also, a method of lowering the water content to some extent by adding a highly water-miscible solvent, mixing a more hydrophobic solvent and removing the highly volatile component under a reduced pressure to prepare a solvent composition is exemplified. Further, a method is also possible where the hydrophobilization is sufficiently conducted using the basic hydrophobilizing agent, an organic solvent of low miscibility with water is added to form a separated two phases system and the organic conductive polymer compound in the aqueous phase is extracted to the organic solvent phase.

### [(B) Fluorine-Containing Curable Compound]

According to the invention, it is essential to use the fluorine-containing curable compound in addition to the organic conductive compound for the purpose of controlling the uneven distribution ratio of the organic conductive compound in the desired range.

Also, in order to improve the antireflective performance of the laminate according to the invention, it is preferred to reduce the refractive index of the layer by the fluorine-containing curable compound.

The fluorine-containing curable compound according to the invention may be any of a polymer and a monomer. In case of using the fluorine-containing polymer, a polymer having a molecular weight of 1,000 or more and containing a fluorine-containing moiety and a moiety having a functional group capable of being involved in a crosslinking reaction is preferred. On the other hand, in case of using the fluorine-containing monomer, a polymerizable group of a polyfunctional fluorine-containing monomer is preferably any one group selected from an acryloyl group, a methacryloyl group and —C(O)OCH═CH₂.

Also, the fluorine-containing polymer and the fluorine-containing monomer may be used in combination. The fluorine-containing polymer and the fluorine-containing monomer will be described in detail below.

### [Fluorine-Containing Polymer]

The fluorine-containing polymer preferably has a structure represented by formula (1) shown below.

(MF1)ₐ-(MF2)_{b}-(MF3)_{c}-(MA)_{d}-(MB)ₑ Formula (1)

In formula (1), a to e each represents a mole fraction of each constituting component and represents a value satisfying 0≦a≦70, 0≦b≦70, provided that 30≦a+b≦70, 0≦c≦50, 5≦d≦50 and 0≦e≦50 respectively.

(MF1) represents a constituting component polymerized from a monomer represented by CF₂═CF—Rf₁, wherein Rf₁ represents a perfluoroalkyl group having from 1 to 5 carbon atoms.

(MF2) represents a constituting component polymerized from a monomer represented by CF₂═CF—ORf₁₂, wherein Rf₁₂ represents a fluorine-containing alkyl group having from 1 to 30 carbon atoms.

(MF3) represents a constituting component polymerized from a monomer represented by CH₂═CH—ORf₁₃, wherein Rf₁₃ represents a fluorine-containing alkyl group having from 1 to 30 carbon atoms.

(MA) represents a constituting component having at least one crosslinkable group.

(MB) represents an optional constituting component.

Monomers (compounds represented by formulae (1-1) to (1-3)) in (MF 1) to (MF2) will be described below.

CF₂═CF—Rf₁ Formula (1-1)

In formula (1-1), Rf₁ represents a perfluoroalkyl group having from 1 to 5 carbon atoms.

As the compound of formula (1-1), perfluoropropylene or perfluorobutylene is preferred from the standpoint of polymerization reactivity, and perfluoropropylene is particularly preferred from the standpoint of availability.

CF₂═CF—ORf₁₂ Formula (1-2)

In formula (1-2), Rf₁₂ represents a fluorine-containing alkyl group having from 1 to 30 carbon atoms. The fluorine-containing alkyl group may have a substituent. Rf₁₂ is preferably a fluorine-containing alkyl group having from 1 to 20 carbon atoms, more preferably a fluorine-containing alkyl group having from 1 to 10 carbon atoms, and still more preferably a perfluoroalkyl group having from 1 to 10 carbon atoms. Specific examples of Rf₁₂ are set forth below, but the invention should not be construed as being limited thereto.

—CF₃, —CF₂CF₃, —CF₂CF₂CF₃, —CF₂CF(OCF₂CF₂CF₃)CF₃

CH₂═CH—ORf₁₃ Formula (1-3)

In Formula (1-3), Rf₁₃ represents a fluorine-containing alkyl group having from 1 to 30 carbon atoms. The fluorine-containing alkyl group may have a substituent. Rf₁₃ may have a straight-chain or branched structure. Also, Rf₁₃ may have an alicyclic structure (preferably a 5-membered ring or a 6-membered ring). Further, Rf₁₃ may have an ether bond between the carbon atoms. Rf₁₃ is preferably a fluorine-containing alkyl group having from 1 to 20 carbon atoms, and more preferably a fluorine-containing alkyl group having from 1 to 15 carbon atoms. Specific examples of Rf₁₃ are set forth below, but the invention should not be construed as being limited thereto.

### (Straight-Chain Structure)

—CF₂CF₃, —CH₂(CF₂)ₐH, —CH₂CH₂(CF₂)ₐF (a represents an integer of 2 to 12)

### (Branched Structure)

—CH(CF₃)₂, —CH₂CF(CF₃)₂, —CH(CH₃)CF₂CF₃, —CH(CH₃)(CF₂)₅CF₂H

### (Alicyclic Structure)

a perfluorocyclohexyl group, a perfluorocyclopentyl group, an alkyl groups substituted with them

### (Others)

—CH₂OCH₂CF₂CF₃, —CH₂CH₂OCH₂(CF₂)_{b}H, —CH₂CH₂OCH₂(CF₂)_{b}F (b represents an integer of 2 to 12), —CH₂CH₂OCF₂CF₂OCF₂CF₂H

In addition, as the monomer represented by formula (1-3), compounds described in Paragraph Nos. [0025] to [0033] of JP-A-2007-298974 are used.

It is preferred that the fluorine-containing curable compound (B) contains a repeating unit having a crosslinkable moiety, and It is more preferred that the crosslinkable moiety is at least any one of a hydroxy group, a silyl group having a hydrolyzable group, a group having a reactive unsaturated double bond, an ring-opening polymerization reactive group, a group having an active hydrogen atom, a group capable of being substituted with a nucleophilic agent, and an acid anhydride.

(MA) in formula (1) represents a constituting component having at least one crosslinkable moiety (a reactive moiety capable of being involved in a crosslinking reaction).

The crosslinkable moiety includes, for example, a silyl group having a hydroxy group or a hydrolysable group (for example, an alkoxysilyl group or acyloxysilyl group), a group having a reactive unsaturated double bond (for example, a (meth)acryloyl group, an allyl group or a vinyloxy group), a ring opening polymerization reactive group (for example, an epoxy group, an oxetanyl group or an oxazolyl group), a group having an active hydrogen atom (for example, a hydroxy group, a carboxyl group, an amino group, a carbamoyl group, a mercapto group, a β-ketoester group, a hydrosilyl group or a silanol group), an acid anhydride, and a group capable of being substituted with or a nucleophilic agent (for example, an active halogen atom or a sulfonic acid ester).

The crosslinkable group in (MA) is preferably a group having a reactive unsaturated double bond or a ring opening polymerizable group, and more preferably a group having a reactive unsaturated double bond.

Preferable specific examples of the constituting component represented by (MA) in formula (1) are set forth below, but the invention should not be construed as being limited thereto.

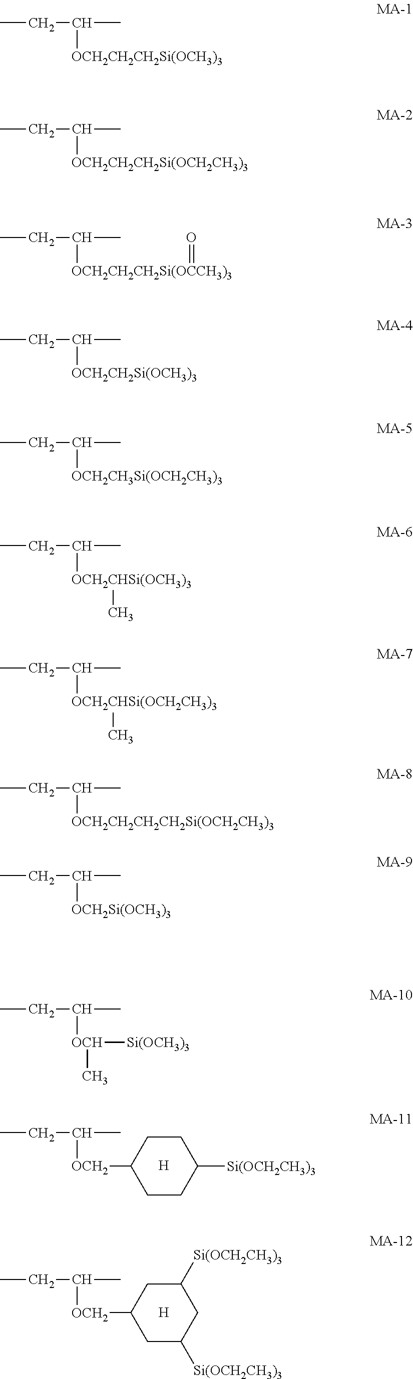

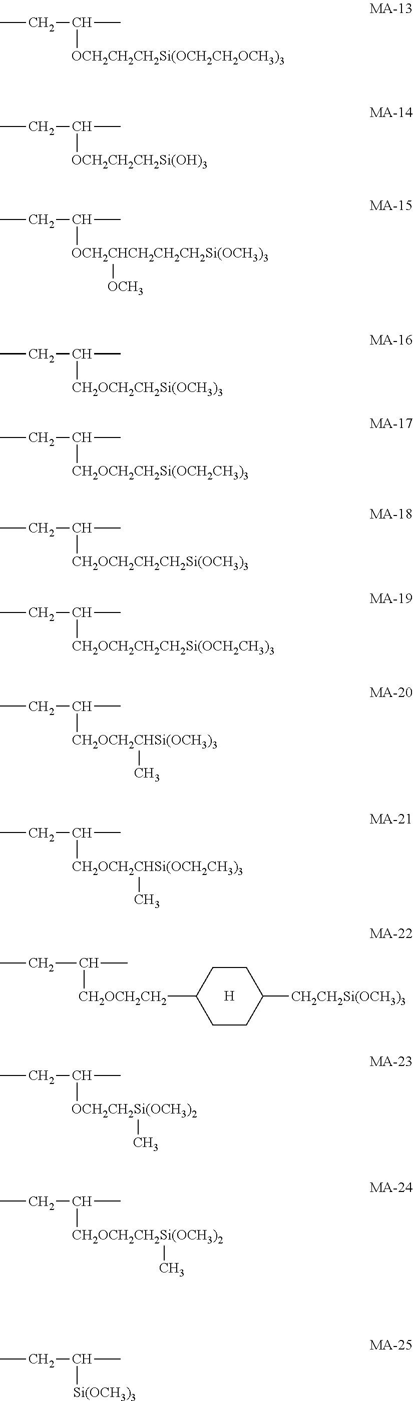

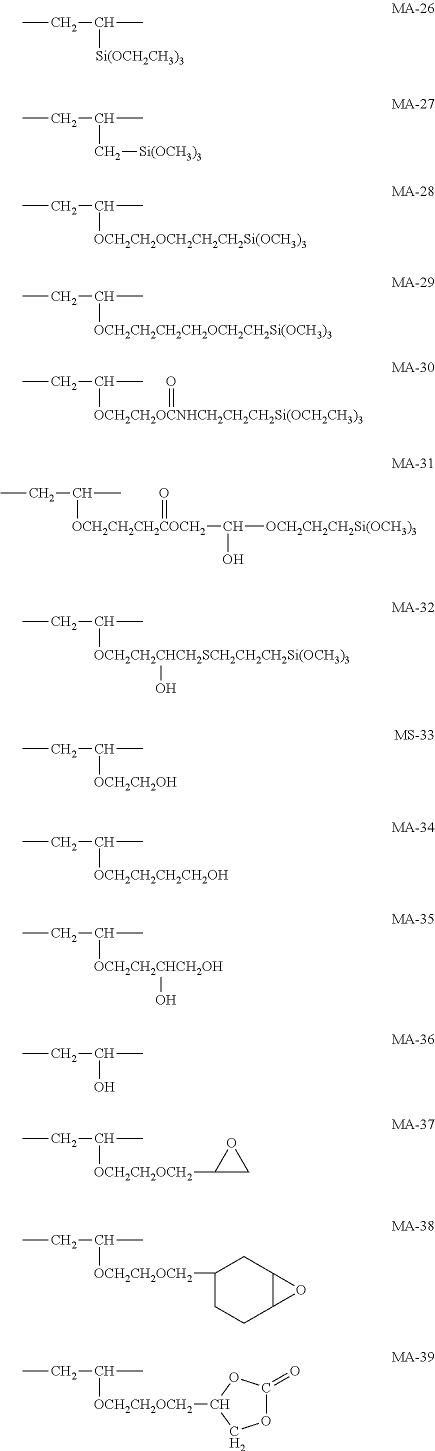

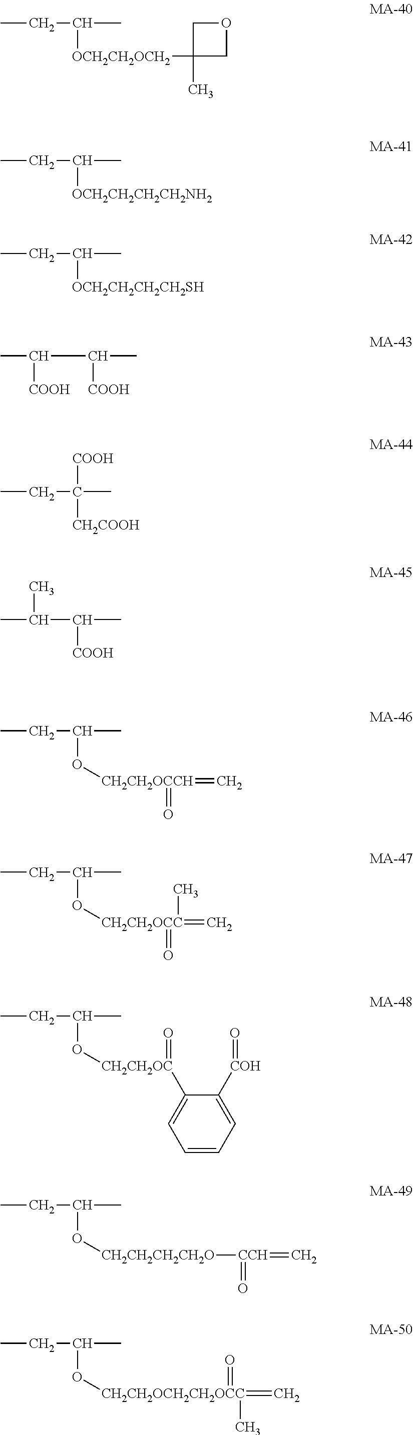

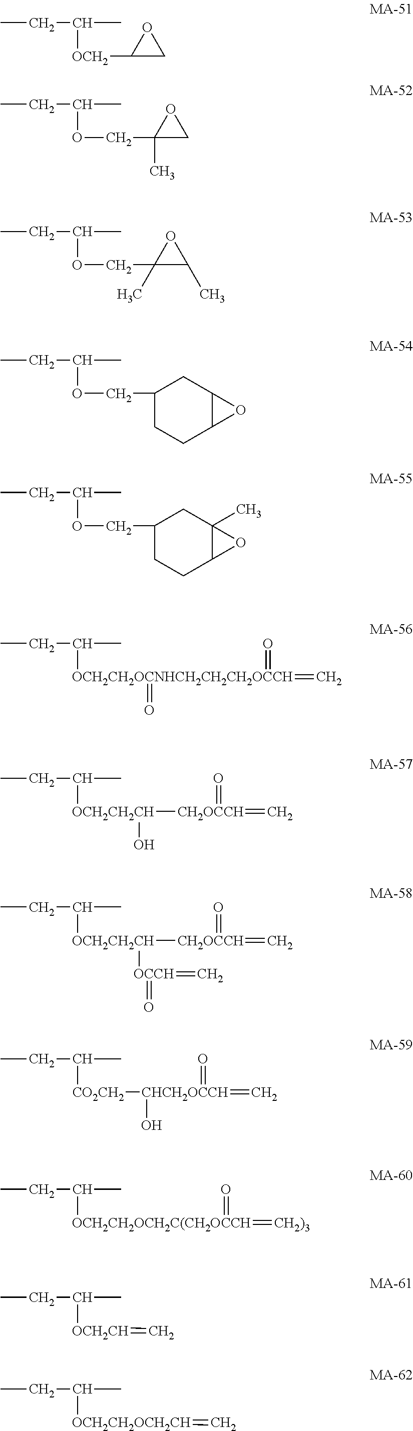

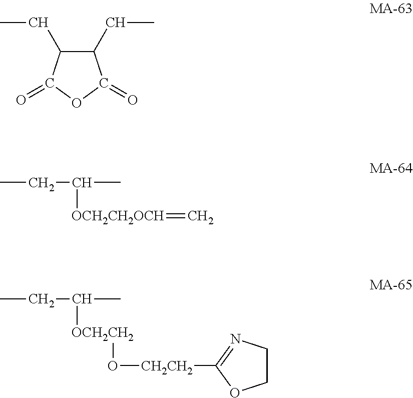

(MB) in formula (1) represents an optional constituting component. (MB) is not particularly restricted as far as it is a constituent component of a monomer copolymerizable with monomers represented by (MF1) and (MF2) and with a monomer forming a constituent component represented by (MA), and can be appropriately selected in view of various points, for example, adhesion property to a substrate, Tg of polymer (contributing to film hardness), solubility in a solvent, transparency, sliding property, dust resistance or antifouling property.

Examples of the unit for forming (MB) include a vinyl ester, for example, methyl vinyl ether, ethyl vinyl ether, n-butyl vinyl ether, cyclohexyl vinyl ether or isopropyl vinyl ether and a vinyl ester, for example, vinyl acetate, vinyl propionate, vinyl butyrate or vinyl cyclohexanecarboxylate.

It is preferred that (MB) contains a constituting component having a polysiloxane structure. By including the polysiloxane structure as (MB), the lower part uneven distribution of the conductive polymer in the layer of antireflective film is easily accelerated and slipping property and antifouling property can be improved.

More specifically, it is preferred that (MB) contains a polysiloxane repeating unit represented by formula (2) shown below in its main chain or side chain.

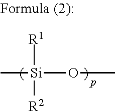

In formula (2), R¹ and R² each independently represents an alkyl group or aryl group.

The alkyl group preferably has from 1 to 4 carbon atoms, and which may have a substituent. Specific examples thereof include a methyl group, a trifluoromethyl group and an ethyl group.

The aryl group preferably has from 6 to 20 carbon atoms, and which may have a substituent. Specific examples thereof include a phenyl group and a naphthyl group.

R¹ and R² each preferably represents a methyl group or a phenyl group, and more preferably a methyl group.

p represents an integer of 2 to 500, preferably 5 to 350, and more preferably 8 to 250.

The polymer having a polysiloxane structure represented by formula (2) in its side chain can be synthesized as described, for example, in J. Appl. Polym. Sci., 2000, 78, 1955 and JP-A-56-28219, by a method where into a polymer having a reactive group (for example, an epoxy group, a hydroxy group, a carboxyl group or an acid anhydride group), a polysiloxane having a counterpart reactive group (for example, an amino group, a mercapto group, a carboxyl group or a hydroxyl group for an epoxy group or an acid anhydride group) in its one terminal (for example, SILAPLANE series (produced by Chisso Corp.)) is introduced by a polymer reaction, or a method of polymerization of a polysiloxane-containing silicone macromer.

The polymer having a polysiloxane structure represented by formula (2) in its main chain can be synthesized by a method using polymer initiator, for example, an azo group-containing polysiloxaneamide described in JP-A-6-93100 (commercially available product: VPS-0501 or VPS-1001, produced by Wako Pure Chemical Industries, Ltd.), a method where a reactive group derived from a polymerization initiator or a chain transfer agent (for example, a mercapto group, a carboxyl group or a hydroxyl group) is introduced into a terminal of a polymer and then, reacted with a polysiloxane containing one terminal or both terminal reactive groups (for example, an epoxy group or an isocyanate group), or a method where a cyclic siloxane oligomer, for example, hexamethylcyclotrisiloxane is copolymerized by anionic ring opening polymerization. Among them, the method of using an initiator having a polysiloxane partial structure is easy and preferred.

In formula (1), a to e each represents a mole fraction of each constituting component and represents a value satisfying 0≦a≦70, 0≦b≦70, provided that 30≦a+b≦70, 0≦c≦50, 5≦d≦50, and 0≦e≦50, respectively.

In order to attain low refractive index, it is desired to increase the mole fractions (%) a+b of the component (MF 1) and the component (MF2), however, an introduction ratio of about 50 to about 70% is an upper limit and a value higher than this is ordinarily difficult in a conventional solution type radical polymerization reaction in view of the polymerization reactivity. In the invention, a+b is preferably 40% or more, and more preferably 45% or more.

The introduction of (MF3) also contributes to the attainment of low refractive index. The mole fraction c of the component (MF3) is 0≦c≦50 as described above, and preferably 5≦c≦20.

The sum of the mole fractions of the fluorine-containing monomer components is preferably in the range of 40≦a+b+c≦90, and preferably 50≦a+b+c≦75.

When the proportion of the polymer unit represented by (MA) is too small, the strength of cured layer decreases. According to the present invention, the mole fraction of the component (MA) is preferably in the range of 5≦d≦40, and particularly preferably in the range of 15≦d≦30.

The mole fraction e of the optional constituting component represented by (MB) is preferably in the range of 0≦e≦50, more preferably in the range of 0≦e≦20, and still more preferably in the range of 0≦e≦10.

According to the invention, it is preferred that the fluorine-containing polymer has a functional group of high polarity in its molecule from the standpoint of improvement in surface state of the coated layer, increase in conductivity and improvement in scratch resistance of the layer. Therefore, it is preferred the component (MB) has a functional group of high polarity in its molecule. As the functional group of high polarity, a hydroxy group, an alkylether group, a silanol group, a glycidyl group, an oxatanyl group, a polyalkylene oxide group or a carboxyl group is preferred, and a hydroxy group, an alkylether group or a polyalkylene oxide group is more preferred.

A content of the polymerization unit having the functional group is preferably from 0.1 to 15%, more preferably from 1 to 10%, in terms of mole fraction.

As described above, it is preferred to introduce a polysiloxane structure into the fluorine-containing polymer from the standpoint of the surface state of the coated layer and scratch resistance. By introducing the polysiloxane structure into the fluorine-containing polymer, the upper part uneven distribution of the fluorine-containing polymer can be increased and as a result, the lower part uneven distribution of the organic conductive compound is accelerated to result in increase in the conductivity. A content of the polysiloxane structure in the fluorine-containing polymer is preferably from 0.5 to 15% by weight, more preferably from 1 to 10% by weight, in the polymer.

A number average molecular weight of the fluorine-containing polymer is preferably from 1,000 to 1,000,000, more preferably 5,000 to 500,000, and still more preferably from 10,000 to 100,000.

The number average molecular weight as used herein is a molecular weight determined by a differential refractive index detector using a GPC analyzer with a column of TSKgel GMHxL, TSKgel G4000HxL, TSKgel G2000HxL (produced by Tosoh Corp.) and THF as a solvent and calculated in terms of polystyrene.

Specific examples of the copolymer represented by formula (1) are set forth below, but the invention should not be construed as being limited thereto. In Table 1 below, there are described combinations of monomers (MF 1), (MF2), (MF3), (MA) and (MB) which form the fluorine-containing polymer represented by formula (1) by polymerization. Also, a to e each represents a mole ratio (%) of monomer of the respective component. Further, an indication of wt % for the component (MB) means a percent by weight of the component in the polymer. Moreover, with respect to the component(s) other than EVE in the column of “(MB)”, content(s) (percent by weight: wt %) of the component(s) in the polymer are indicated in the order from the left to the right following the mole ratio of EVE in the column “e”.

TABLE 1

| | | | | | | | | | | | Molecular |
|---|---|---|---|---|---|---|---|---|---|---|---|
| | | | | | | | | | | | Weight |
| | (MF1) | (MF2) | (MF3) | (MA) | (MB) | a | b | c | d | e | (×10⁴) |
| P-1 | HFP | — | — | MA-33 | EVE | 50 | 0 | 0 | 20 | 30 | 3.1 |
| P-2 | HFP | — | — | MA-33 | EVE/VPS-1001 | 50 | 0 | 0 | 20 | 30/4 wt % | 3.2 |
| P-3 | HFP | — | — | MA-33 | EVE/FM-0721 | 50 | 0 | 0 | 20 | 30/4 wt % | 2.9 |
| P-4 | HFP | — | — | MA-33 | EVE/VPS-1001/NE-30 | 50 | 0 | 0 | 20 | 30/4 wt %/1 wt % | 3.4 |
| P-5 | HFP | FFVE | — | MA-33 | EVE/VPS-1001/NE-30 | 40 | 10 | 0 | 20 | 30/4 wt %/1 wt % | 3.2 |
| P-6 | HFP | FFVE | — | MA-35 | EVE/VPS-1001 | 40 | 10 | 0 | 15 | 35/4 wt % | 2.7 |
| P-7 | HFP | FFVE | — | MA-34 | EVE/VPS-1001/NE-30 | 40 | 10 | 0 | 25 | 25/4 wt %/1 wt % | 3.1 |
| P-8 | HFP | FFVE | MF3-1 | MA-33 | EVE/NE-30 | 40 | 10 | 10 | 25 | 15/1 wt % | 3.3 |
| P-9 | HFP | FFVE | MF3-2 | MA-33 | EVE/FM-0721 | 40 | 10 | 10 | 25 | 15/4 wt % | 3.4 |
| P-10 | HFP | — | — | MA-37 | EVE/VPS-1001 | 50 | 0 | 0 | 25 | 25/4 wt % | 3.2 |
| P-11 | HFP | — | — | MA-46 | — | 50 | 0 | 0 | 50 | 0 | 3.3 |
| P-12 | HFP | — | — | MA-33/MA-46 | — | 50 | 0 | 0 | 15/35 | 0 | 3.2 |
| P-13 | HFP | — | — | MA-33/MA-46 | EVE | 50 | 0 | 0 | 10/35 | 5 | 3.5 |
| P-14 | HFP | — | — | MA-33/MA-46 | EVE/VPS-1001 | 50 | 0 | 0 | 10/35 | 5/4 wt % | 3.6 |
| P-15 | HFP | — | — | MA-33/MA-46 | EVE/VPS-1001/NE-30 | 50 | 0 | 0 | 10/35 | 5/1 wt %/4 wt % | 3.4 |
| P-16 | HFP | FFVE | — | MA-33/MA-46 | EVE/VPS-1001 | 40 | 10 | 0 | 10/35 | 5/4 wt % | 3.1 |
| P-17 | HFP | FFVE | MF3-1 | MA-33/MA-46 | EVE/VPS-1001 | 40 | 10 | 5 | 5/35 | 5/4 wt % | 3.5 |
| P-18 | HFP | FFVE | MF3-1 | MA-33/MA-46 | EVE/FM-0721/NE-30 | 40 | 10 | 5 | 5/35 | 5/1 wt %/4 wt % | 3.0 |
| P-19 | HFP | — | — | MA-35/MA-58 | EVE/VPS-1001 | 50 | 0 | 0 | 5/35 | 10/4 wt % | 3.3 |
| P-20 | HFP | — | — | MA-33/MA-56 | EVE/VPS-1001 | 50 | 0 | 0 | 5/35 | 10/4 wt % | 3.4 |

In Table 1, each abbreviation means the meaning described below.

### Component (MF1)

HFP: Hexafluoropropylene

### Component (MF2)

FPVE: Perfluoropropyl vinyl ether

### Component (MF3)

MF3-1: CH₂═CH—O—CH₂CH₂—O—CH₂(CF₂)₄H

MF3-2: CH₂═CH—O—CH₂CH₂(CF₂)₈F

### Component (MB)

EVE: ethyl vinyl ether

VPS-1001: Azo group-containing polydimethylsiloxane (molecular weight of polysiloxane portion: about 10,000), produced by Wako Pure Chemical Industries, Ltd.

FM-0721: Methacryloyl-modified dimethylsiloxane (average molecular weight: 5,000), produced by Chisso Corp.

NE-30: Reactive nonionic emulsifier containing an ethylene oxide portion, produced by ADEKA Corp.

When the fluorine-containing polymer contains a silyl group having a hydrolyzable group (a hydrolyzable silyl group) as the crosslinkable moiety, a known acid or base catalyst may be incorporated as a catalyst for a sol gel reaction. The amount of the curing catalyst may be varied depending on the kind of the catalyst or difference of the curing-reactive moiety and in general, it is preferably form about 0.1 to 15% by weight, more preferably from about 0.5 to 5% by weight, based the total solid content of the coating composition.

Also, when the fluorine-containing polymer contains a hydroxy group as the crosslinkable moiety, the composition according to the invention preferably contains a compound (curing agent) capable of reacting with the hydroxy group in the fluorine-containing polymer.

The curing agent has preferably two or more, more preferably four or more, moieties reacting with the hydroxy group.

The structure of the curing agent is not particularly restricted as far as it has the above-described number of functional groups capable of reacting with a hydroxy group. Examples thereof include a polyisocyanate, a partial condensate or multimer of isocyanate compound, an addition product with a polyhydric alcohol or a low molecular weight polyester film, a blocked polyisocyanate compound in which an isocyanate group is blocked with a blocking agent, for example, phenol, an aminoplast, a polybasic acid or anhydride thereof.

As the curing agent, an aminoplast capable of undergoing a crosslinking reaction with a hydroxy group-containing compound under an acidic condition is preferred from the standpoint of compatibility between stability in preservation and activity of crosslinking reaction and the standpoint of strength of the layer formed. The aminoplast is a compound containing an amino group which is capable of reacting with a hydroxy group present in the fluorine-containing polymer, specifically, a hydroxyalkylamino group or an alkoxyalkylamino group, or a carbon atom adjacent to a nitrogen atom and substituted with an alkoxy group. Specifically, for example, a melamine compound, a urea compound or a benzoguanamine compound is exemplified.

The melamine compound is ordinarily known as a compound having a skeleton in which a nitrogen atom is connected to a triazine ring, and specifically includes melamine, alkylated melamine, methylolmelamine and alkoxylated methylmelamine. In particular, methylolated melamine and alkoxylated methylmelamine obtained by reacting melamine and formaldehyde under a basic condition and derivatives thereof are preferred, and alkoxylated methylmelamine is particularly preferred from the standpoint of preservation stability. The methylolated melamine and alkoxylated methylmelamine are not particularly restricted, and various kinds of resins obtained by a method as described, for example, in Plascic Zairyo kouza, (Plastic Material Course) [8] Urea•Melamine Resin, The Nikkan Kogyo Shimbun Ltd. may also be used.

As the urea compound, in addition to urea, polymethylolated urea and alkoxylated methyl urea which is a derivative thereof, and a compound having a glycol uryl skeleton or 2-imidazolidinone skeleton which is a cyclic urea structure are also preferred. With respect to the amino compound, for example, the urea derivative, various resins described, for example, in Urea Melamine Resin described above may be used.

As a compound which is suitably used as the curing agent, a melamine compound and a glycol uryl compound are particularly preferred from the standpoint of compatibility with the fluorine-containing polymer. In particular, it is preferred from the standpoint of reactivity that the curing agent is a compound containing a nitrogen atom and containing two or more carbon atoms substituted with an alkoxy group adjacent to the nitrogen atom. Particularly preferable compounds are compounds having structures represented by H-1 and H-2 shown below, and partial condensates thereof.

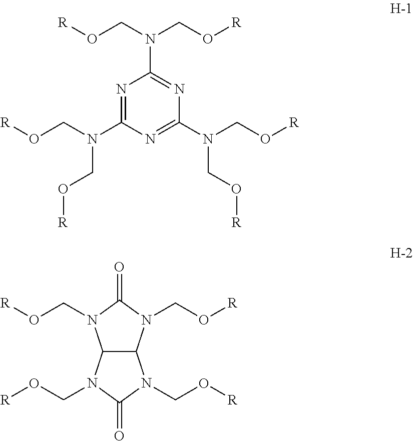

In the formulae, R represents an alkyl group having from 1 to 6 carbon atoms or a hydroxy group.

The amount of the aminoplast to the fluorine-containing polymer is preferably from 1 to 50 parts by weight, more preferably from 3 to 40 parts by weight, still more preferably from 5 to 30 parts by weight, based on 100 parts by weight of the fluorine-containing polymer. When the amount is 1 part by weight or more, durability as a thin layer can be sufficiently exhibited, whereas when it is 50 parts by weight or less, a low refractive index can be maintained and thus, the above-described range is preferred.

In the reaction of the fluorine-containing polymer containing a hydroxy group and the curing agent, it is preferred to use a curing catalyst. In the system, since the curing is promoted by an acid, it is desired to use an acidic substance as the curing catalyst. However, when a conventional acid is added, the crosslinking reaction progresses also in the coating solution to cause failure (for example, unevenness or repellency). Therefore, in order to achieve both the preservation stability and curing activity in the thermo-curing system, it is more preferred to add a compound generating an acid by heating or a compound generating an acid by light as the curing catalyst. Specific compounds are described in Paragraph Nos. [0220] to [0230] of JP-A-2007-298974.

### [Fluorine-Containing Monomer]

The fluorine-containing monomer is a compound having an atomic group (hereinafter, also referred to as a “fluorine-containing core portion”) mainly composed of plural fluorine atoms and carbon atoms (provided that oxygen atom(s) and/or hydrogen atom(s) may partially contained), which is not substantially involved in polymerization, and a polymerizable group, for example, a radical polymerizable group, an ionic polymerizable group or a condensation polymerizable group, through a connecting group, for example, an ester bond or an ether bond. The fluorine-containing monomer is preferred to have two or more polymerizable groups.

The fluorine-containing monomer is preferably a compound (polymerizable fluorine-containing compound) represented by formula (I) shown below.

Rf{-(L)ₘ-Y}ₙ Formula (I)

In formula (I), Rf represents an n-valent chained or cyclic group containing at least a carbon atom and a fluorine atom, which may contain any of an oxygen atom and a hydrogen atom, n represents an integer of 2 or more, L represents a single bond or a divalent connecting group, m represents 0 or 1, and Y represents a polymerizable group.

In formula (I), Y represents a polymerizable group. Y is preferably a radical polymerizable group, an ionic polymerizable group or a condensation polymerizable group, more preferably a polymerizable unsaturated group or a ring-opening polymerizable group, and still more preferably a polymerizable unsaturated group. Specifically, a group selected from a (meth)acryloyl group, an allyl group, an alkoxysilyl group, an α-fluoroacryloyl group, an epoxy group and —C(O)OCH═CH₂ is further more preferred. Among them, from the standpoint of polymerizability, a (meth)acryloyl group, an allyl group, an α-fluoroacryloyl group, an epoxy group or —C(O)OCH═CH₂ each having radical polymerizability or ionic polymerizability is more preferred, a (meth)acryloyl group, an allyl group, an α-fluoroacryloyl group or —C(O)OCH═CH₂ each having radical polymerizability is particularly preferred, and a (meth)acryloyl group or —C(O)OCH═CH₂ is most preferred.

The polymerizable fluorine-containing compound may be a crosslinking agent in which the polymerizable group is a crosslinkable group.

The crosslinkable group includes, for example, a silyl group having a hydroxy group or a hydrolyzable group (for example, an alkoxysilyl group or acyloxysilyl group), a group having a reactive unsaturated double bond (for example, a (meth)acryloyl group, an allyl group or a vinyloxy group), a ring opening polymerization reactive group (for example, an epoxy group, an oxetanyl group or an oxazolyl group), a group having an active hydrogen atom (for example, a hydroxy group, a carboxyl group, an amino group, a carbamoyl group, a mercapto group, a β-ketoester group, a hydrosilyl group or a silanol group), an acid anhydride, and a group capable of being substituted with or a nucleophilic agent (for example, an active halogen atom or a sulfonic acid ester).

L represents a single bond or a divalent connecting group, and is preferably an alkylene group having from 1 to 10 carbon atoms, an arylene group having from 6 to 10 carbon atoms, —O—, —S—, —N(R)— or a divalent connecting group obtained by the combination of two or more of these groups. R represents a hydrogen atom or an alkyl group having from 1 to 5 carbon atoms.

When L represents an alkylene group or an arylene group, the alkylene group or arylene group represented by L is preferably substituted with a halogen atom, and more preferably substituted with a fluorine atom.

The term “calculated value of intercrosslink molecular weight” means a total atomic weight of all atomic groups sandwiched between (a) and (a), (b) and (b), or (a) and (b), when all polymerizable groups in the polymerizable fluorine-containing compound undergo polymerization to form a polymer, wherein (a) is a carbon atom substituted with 3 or more carbon atoms and/or silicon atoms and/or oxygen atoms in total and (b) is a silicon atom substituted with 3 or more carbon atoms and/or oxygen atoms in total. When the calculated value of intercrosslink molecular weight increases, the fluorine content in the fluorine-containing monomer can be increases to improve the conductivity and antifouling property, although the strength and hardness of the coated layer decrease to lead insufficient scratch resistance and abrasion resistance of the surface of the coated layer. On the other hand, when the calculated value of intercrosslink molecular weight decreases, the intercrosslink density increases to improve the layer strength, although the fluorine content decreases to lead increase in the reflectance. From the standpoint of crosslink density and fluorine content, thus, the calculated value of intercrosslink molecular weight when all polymerizable groups in the polymerizable fluorine-containing compound undergo polymerization is preferably 2,000 or less, more preferably less than 1,000, and most preferably more than 50 and less than 800. The polymerizable fluorine-containing compound preferably contains a carbon atom substituted with 3 or more carbon atoms and/or silicon atoms and/or oxygen atoms in total (exclusive of an oxygen atom of a carbonyl group) in its molecule. The inclusion of the carbon atom makes it possible to build a sophisticated crosslink network structure at the curing, thereby tending to increase the hardness of the coated layer.

A more preferable embodiment of the polymerizable fluorine-containing compound represented by formula (1) includes a compound represented by formula (I-1), (I-2) or (I-3) shown below.

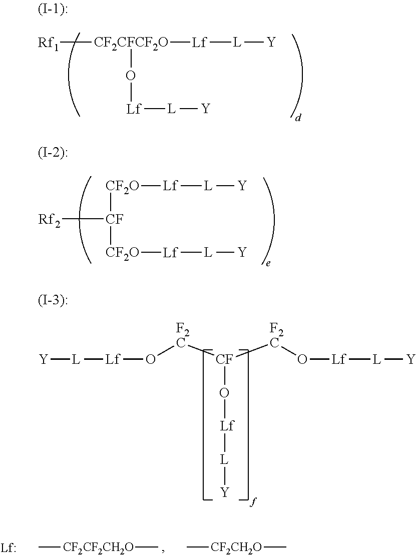

In formulae (I-1), (I-2) and (I-3), Rf₁ represents an oxygen atom, a d-valent organic group substantially constituting from only a carbon atom and a fluorine atom, or a d-valent organic group constituting from only a carbon atom, a fluorine atom and an oxygen atom. Rf₂ represents an oxygen atom, an e-valent organic group substantially constituting from only a carbon atom and a fluorine atom, or an e-valent organic group constituting from only a carbon atom, a fluorine atom and an oxygen atom. Lf represents —CF₂CF₂CH₂O— or —CF₂CH₂O— (connecting to the oxygen atom in formula (I-1) on the carbon atom side). L and Y have the same meanings as L and Y defined in Formula (I), respectively. d and e each independently represents an integer of 2 or more. f represents an integer of 1 or more.

A number of carbon atoms included in Rf₁ or Rf₂ is preferably from 0 to 30, and more preferably from 0 to 10.

A still more preferable embodiment of the polymerizable fluorine-containing compound represented by formula (I-1), (I-2) or (I-3) includes a compound represented by formula (I-1′), (I-2′) or (I-3′) shown below.

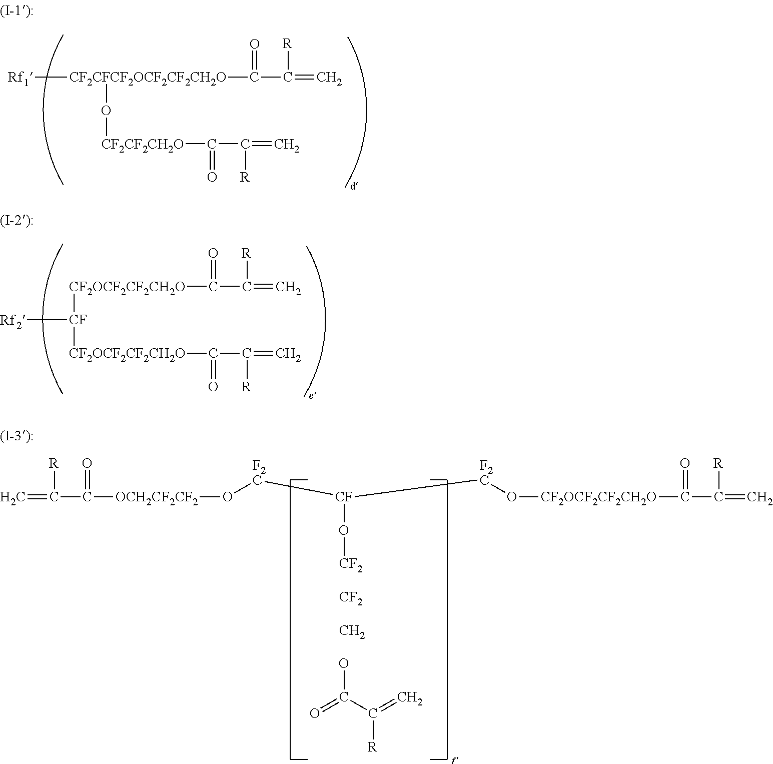

In formulae (I-1), (I-2) and (I-3), Rf₁′ represents an oxygen atom, a d′-valent organic group substantially constituting from only a carbon atom and a fluorine atom, or a d′-valent organic group constituting from only a carbon atom, a fluorine atom and an oxygen atom. Rf₂′ represents an oxygen atom, an e′-valent organic group substantially constituting from only a carbon atom and a fluorine atom, or an e′-valent organic group constituting from only a carbon atom, a fluorine atom and an oxygen atom. R represents a hydrogen atom, a fluorine atom, an alkyl group (preferably an alkyl group having from 1 to 5 carbon atoms) or a fluoroalkyl group (preferably a perfluoroalkyl group having from 1 to 5 carbon atoms). d′ and e′ each independently represents an integer of 2 or 3. f′ represents an integer of 1 to 4.

A number of carbon atoms included in Rf₁′ or Rf₂′ is preferably from 0 to 30, and more preferably from 0 to 10.

Specific examples of the polymerizable fluorine-containing compound represented by formula (I) according to the invention are set forth below, but the invention should not be construed as being limited thereto.

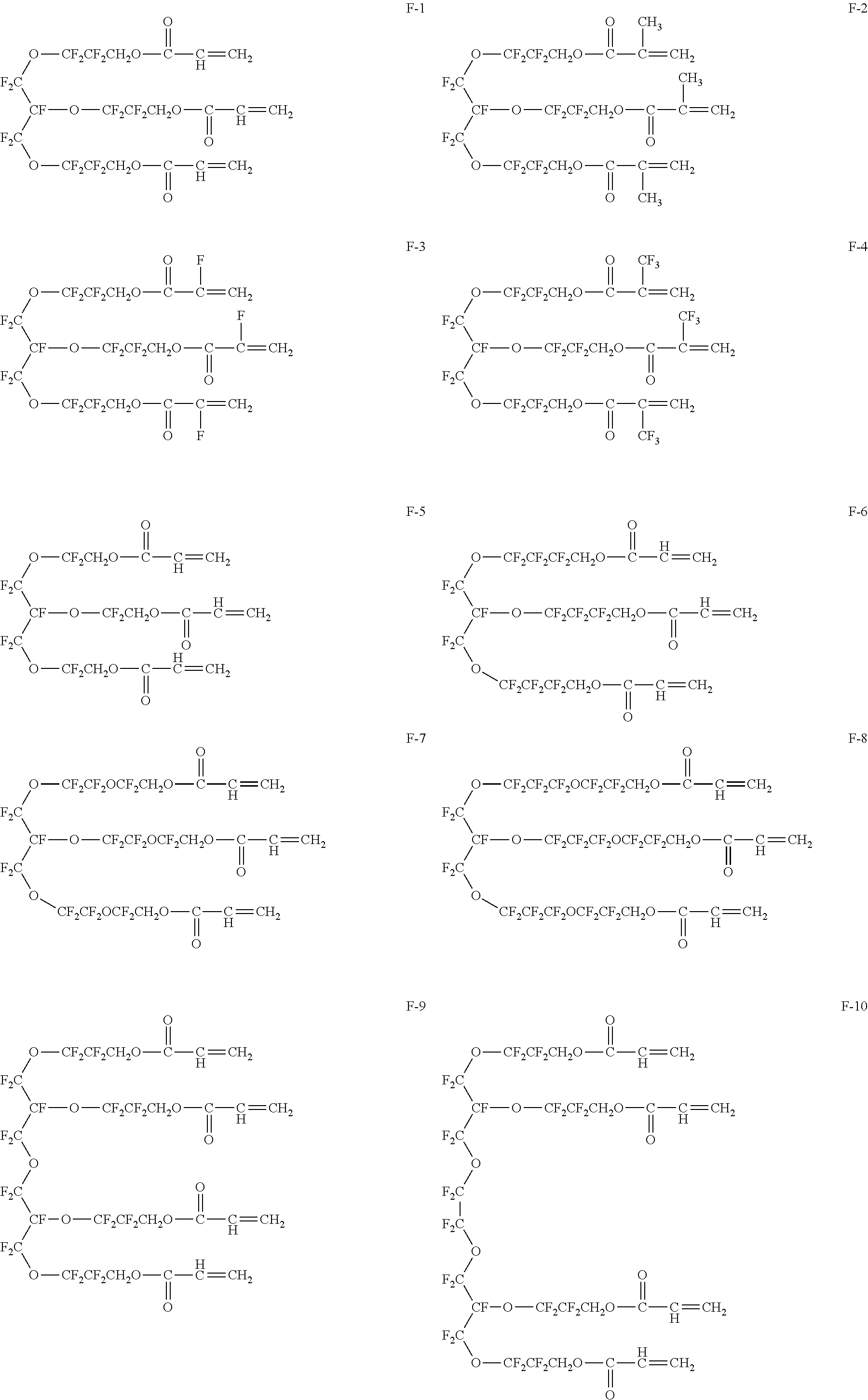

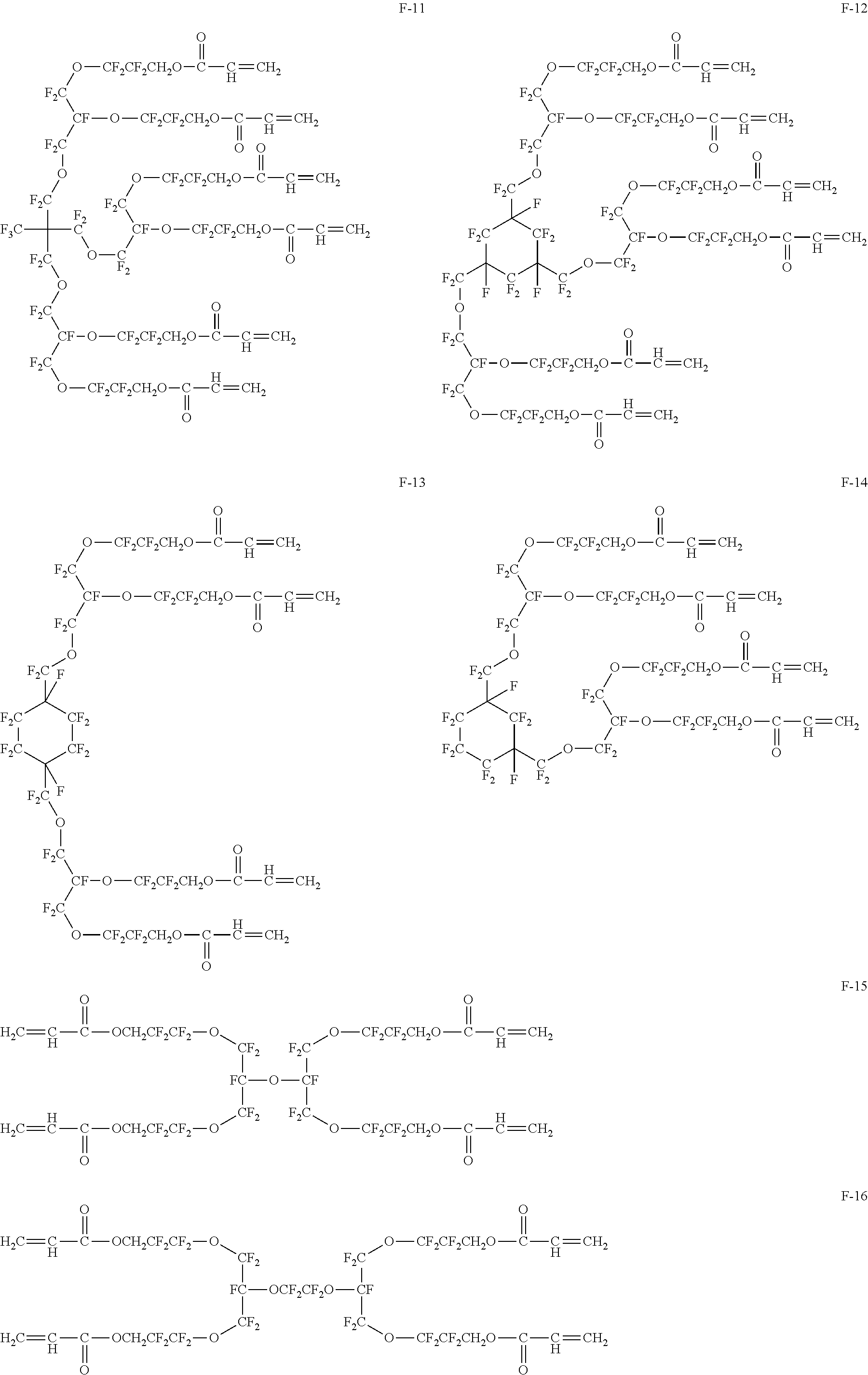

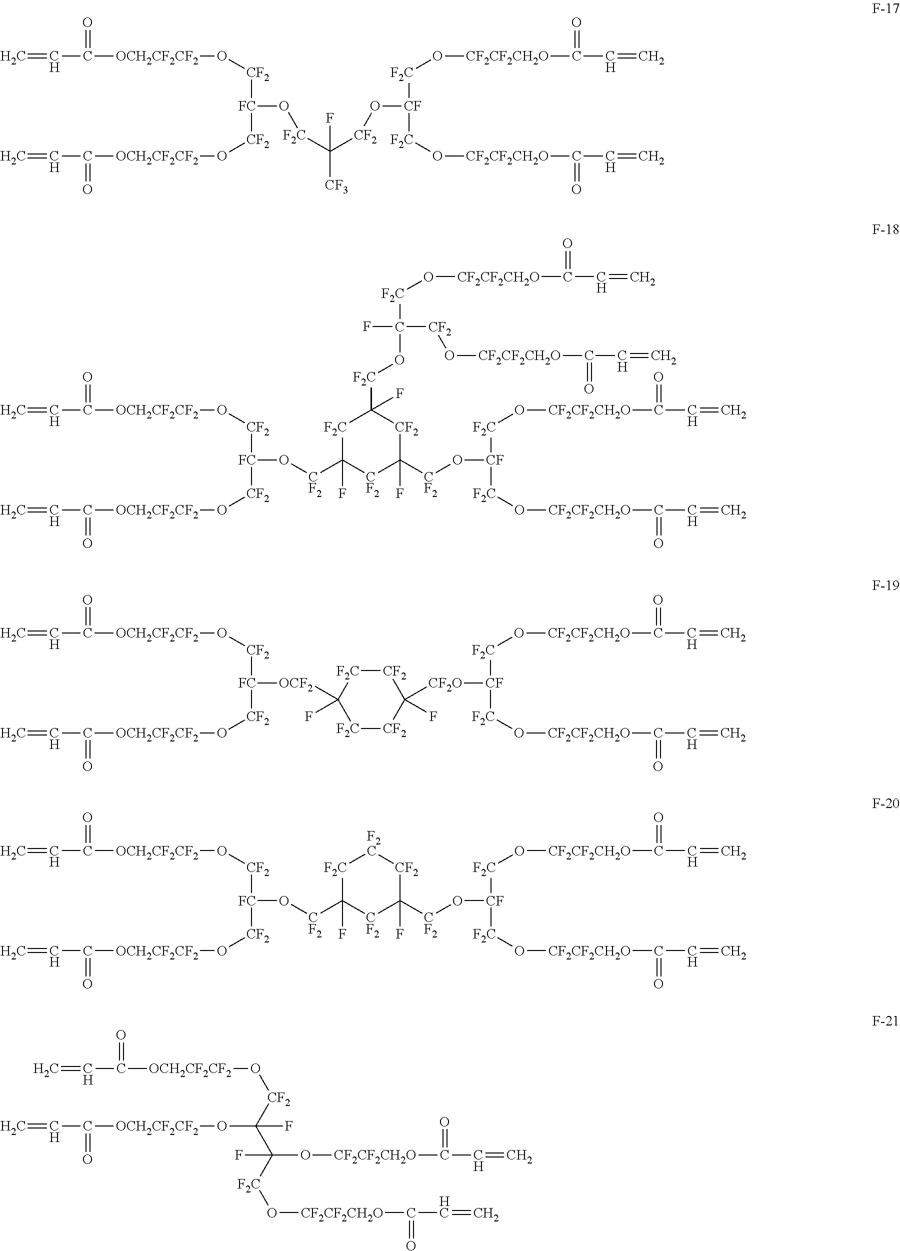

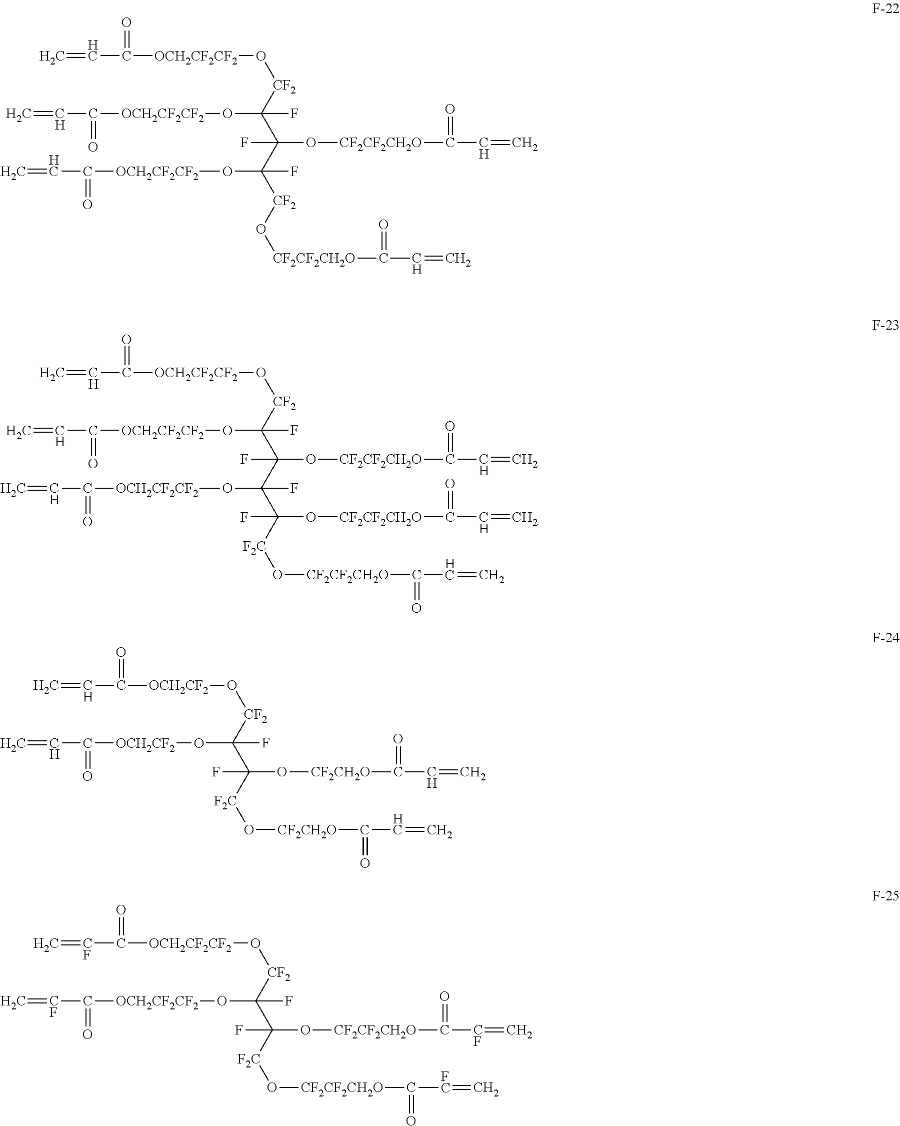

The production method of the polymerizable fluorine-containing compound represented by formula (I) is not particularly restricted and can be produced, for example, a combination of known methods as described below. In the following description, the symbols same as those used hereinbefore have the same meanings as defined above unless otherwise particularly indicated.
Step 1: A step of obtaining a methyl ester of Rf(CO₂CH₃)ₐ by an aqueous phase fluorination reaction of a compound represented by Rh(CO₂R₁)ₐ or Rh(CH₂OCOR₂)ₐ described in U.S. Pat. No. 5,093,432 and WO 00/56694 and a subsequent reaction with methanol. In the formula above, R₁ represents a lower alkyl group, for example, a methyl group or an ethyl group, R₂ represents an alkyl group, preferably a fluorine-containing alkyl group, more preferably a perfluoroalkyl group, and Rh represents a group capable of forming Rf by the aqueous phase fluorination reaction.
Step 2: A step of obtaining an alcohol represented by Rf(CH₂OH)ₐ by reducing the compound represented by Rf(CO₂CH₃)ₐ with a reducing agent, for example, hydrogenated lithium aluminum or halogenated boron sodium.
Step 3: A step of obtaining Rf(CH₂O-L-H)ₐ by adding as a block or at random at least one of ethylene carbonate, ethyleneoxide and glycidyl alcohol to the compound represented by Rf(CH₂OH)ₐ. Step 3 is not necessary when both b and c are 0.
Step 4: A step of obtaining a compound Rf(CH₂O-L-Y)ₐ represented by formula (I) by introducing a polymerizable group to the compound represented by Rf(CH₂O-L-H)ₐ.

When Y is —COC(R₀)═CH₂, as the reaction of introducing a polymerizable group, an esterification reaction of the alcohol of Rf(CH₂O-L-H)ₐ with an acid halide of XCOC(R₀)═CH₂ (wherein X represents a halogen atom, preferably a chlorine atom) or dehydration condensation of the alcohol of Rf(CH₂O-L-H)ₐ with a carboxylic acid of HOCOC(R₀)═CH₂ can be utilized. When Y is other polymerizable group, for example, a nucleophilic substitution reaction of the alcohol of Rf(CH₂O-L-H)ₐ with a corresponding halide can be utilized.

Preferable specific examples of the fluorine-containing monomer are set forth below, but the invention should not be construed as being limited thereto.

Further, from the standpoint of improvement in the surface state of the coated layer, increase in the conductivity and improvement in the scratch resistance of the layer in case of using together with the π-conjugated system conductive polymer, in addition to X-2 to X-4, X-6, X-8 to X-14 and X-21 to X-32 described in Paragraph Nos. [0023] to [0027] of JP-A-2006-28409, Compound (X-33) shown below is also preferably used as the fluorine-containing monomer.

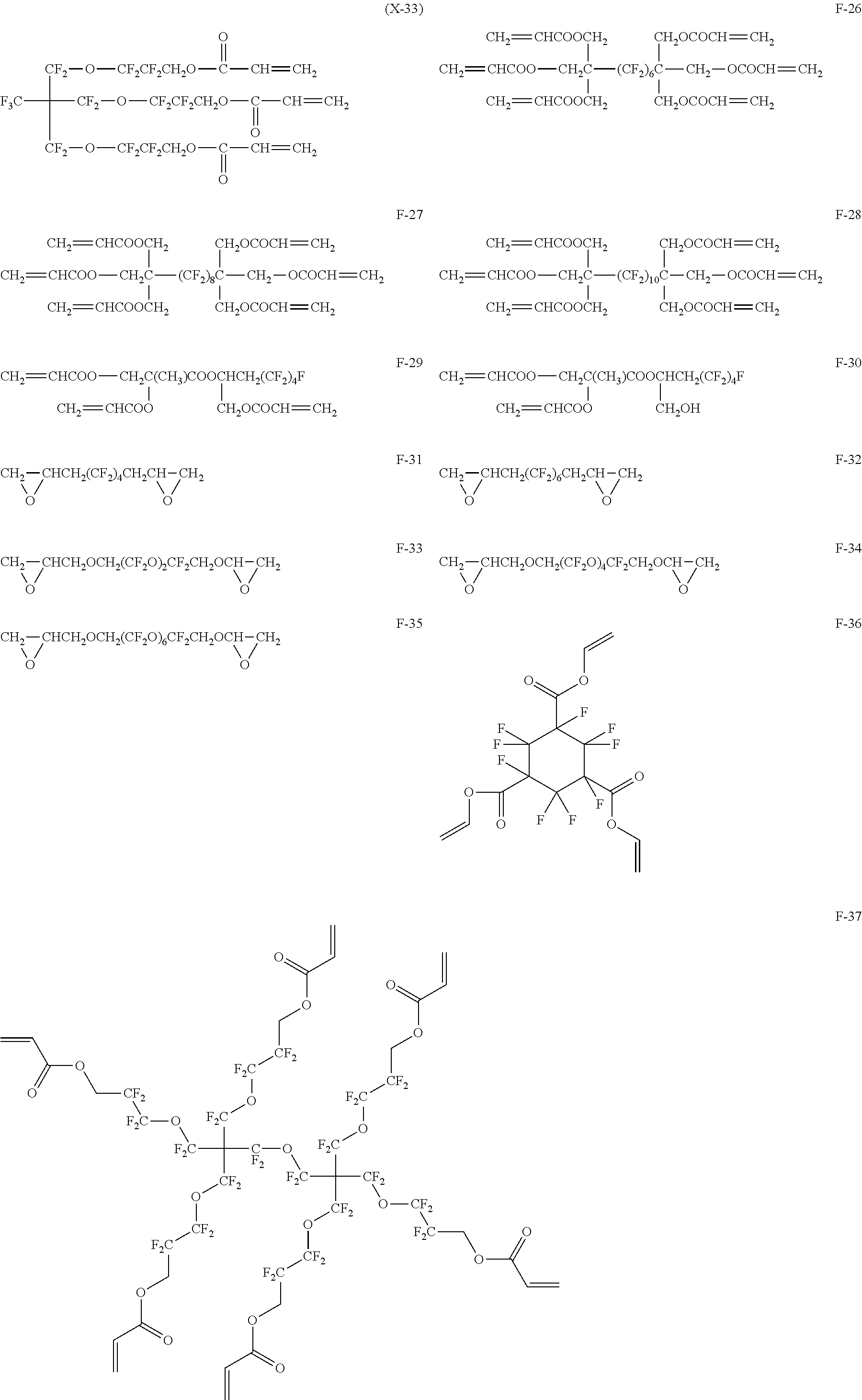

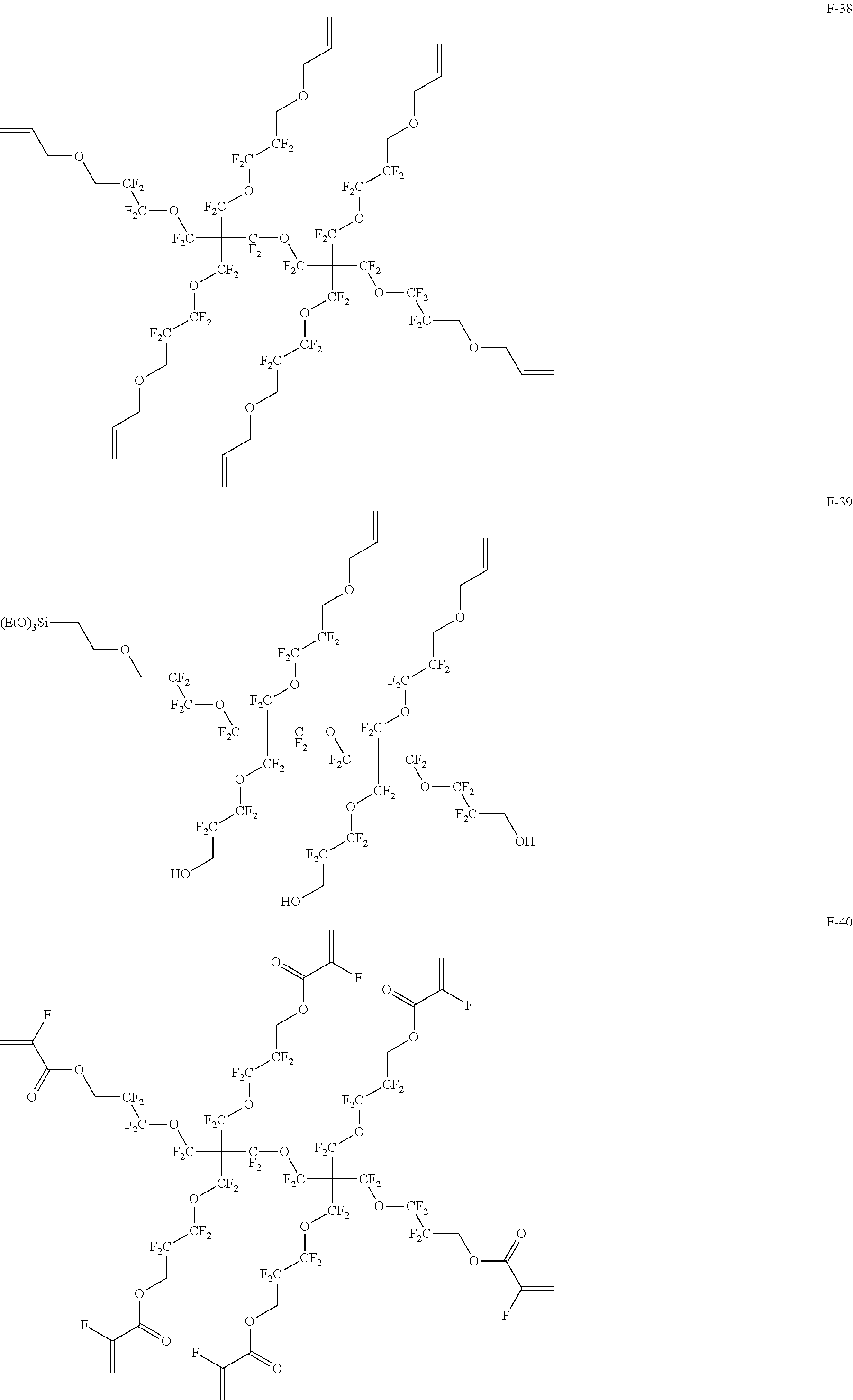

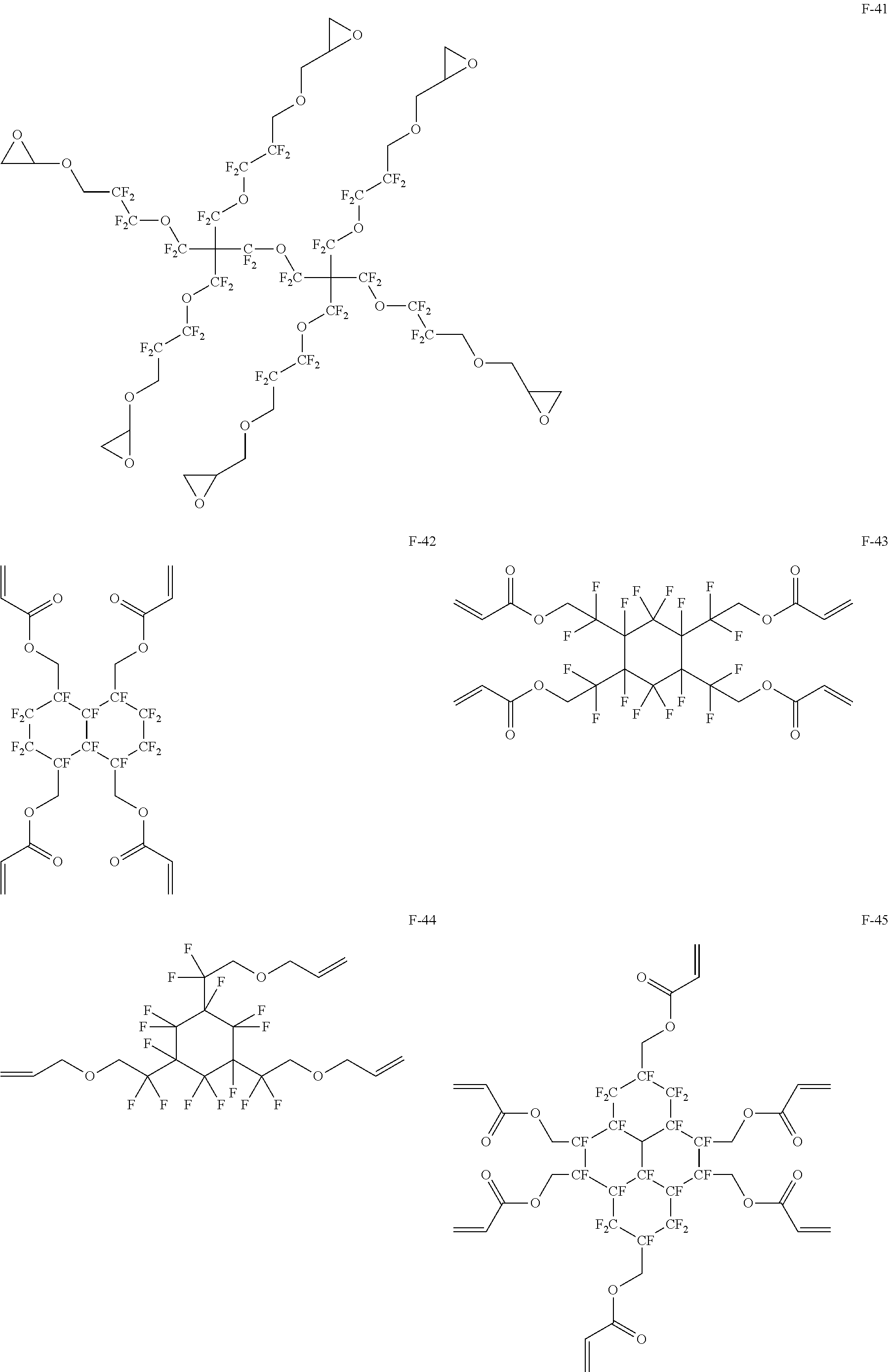

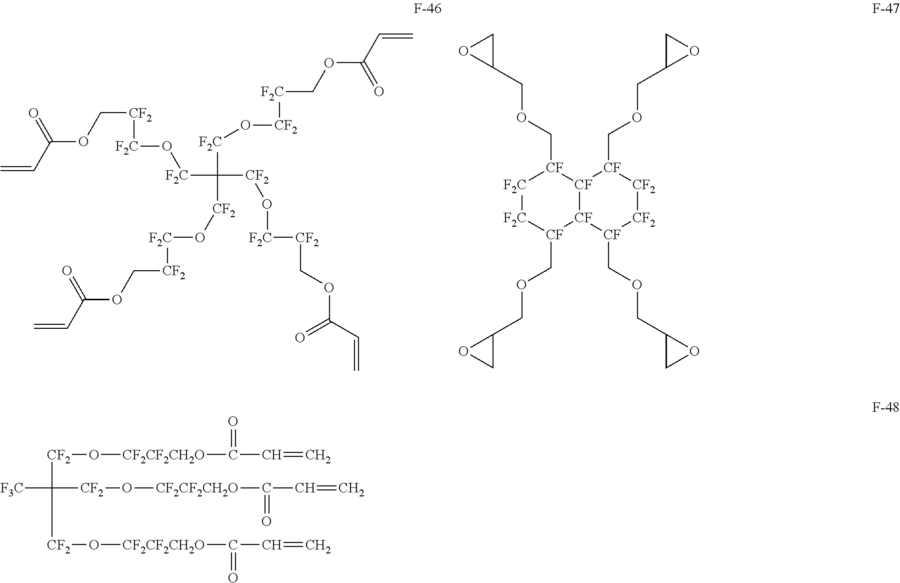

Moreover, the compounds shown below are also preferably used.

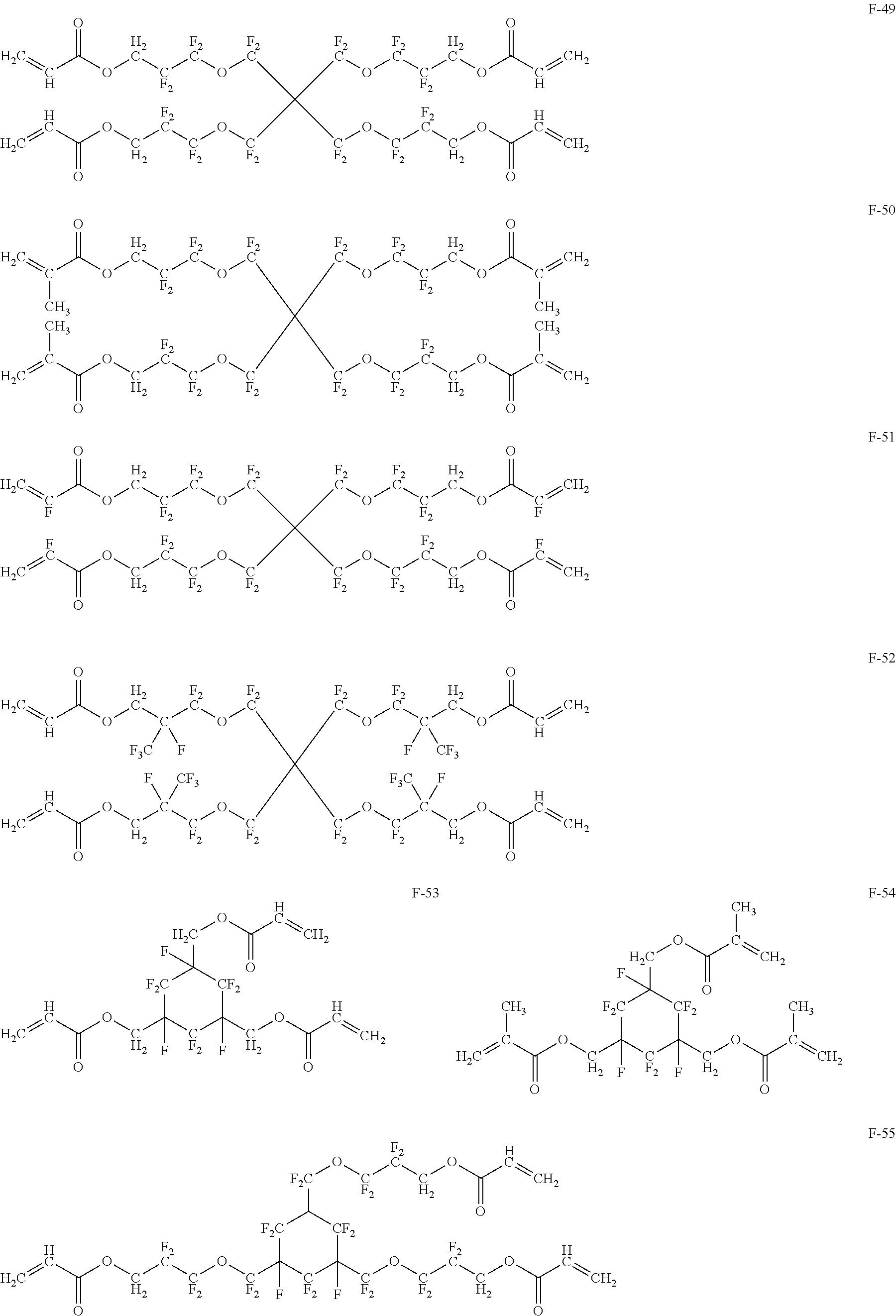

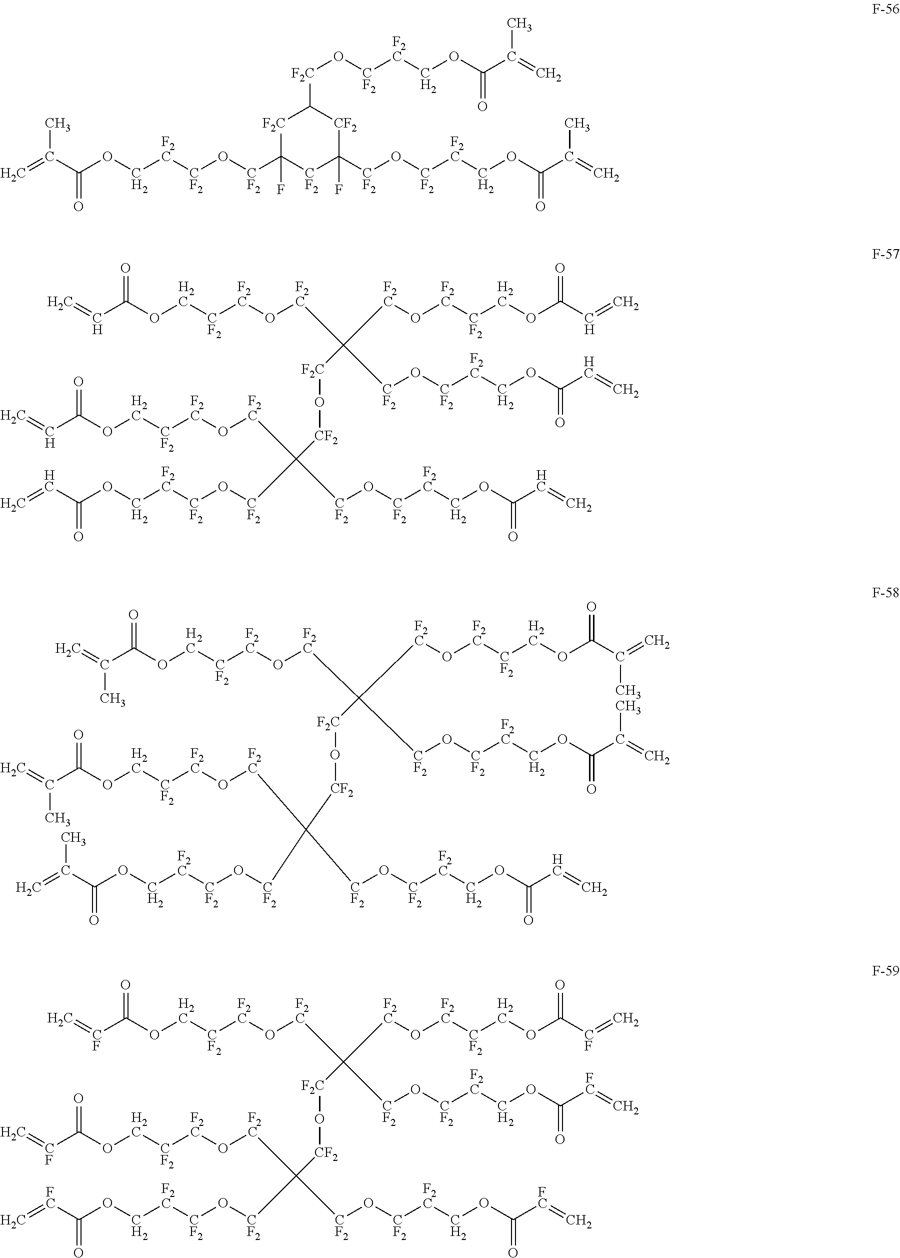

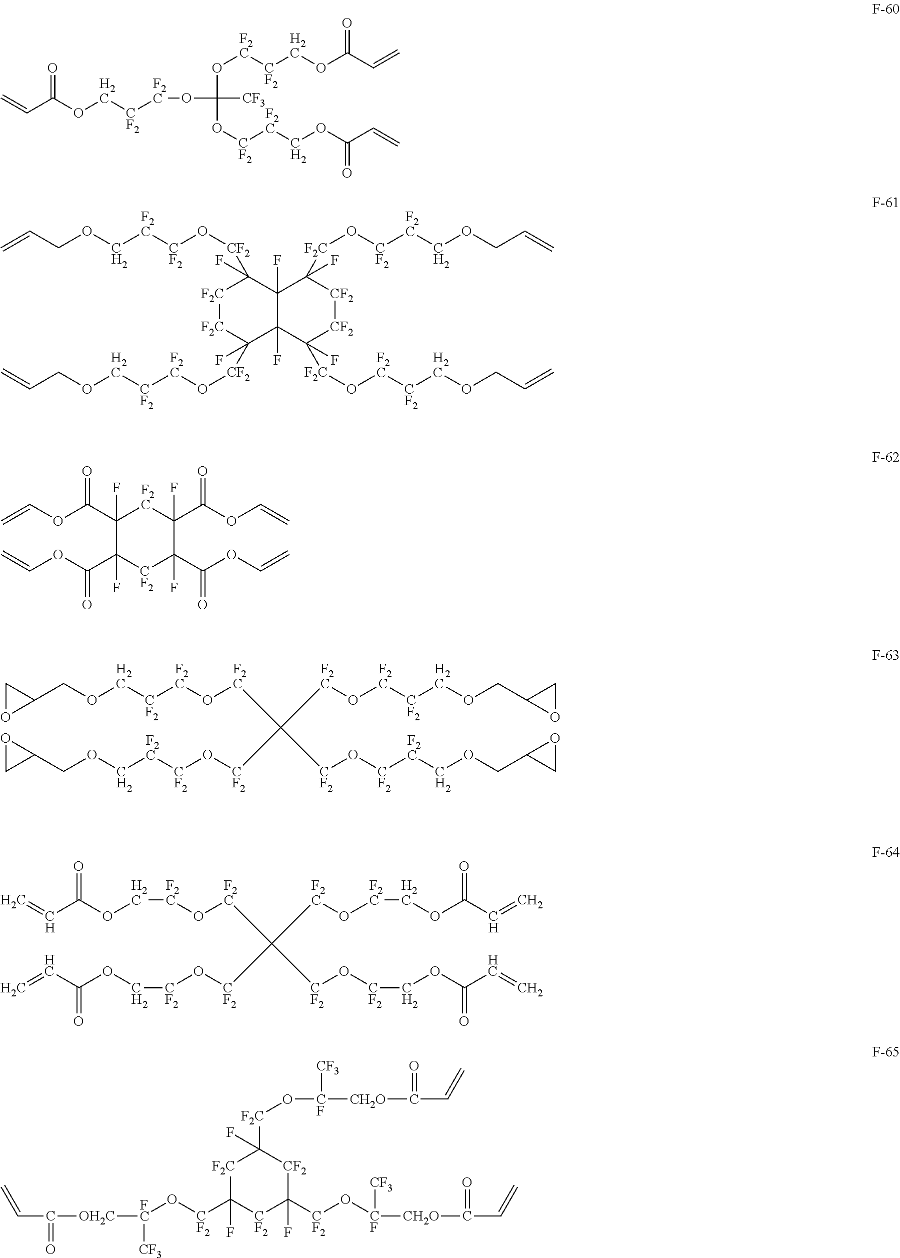

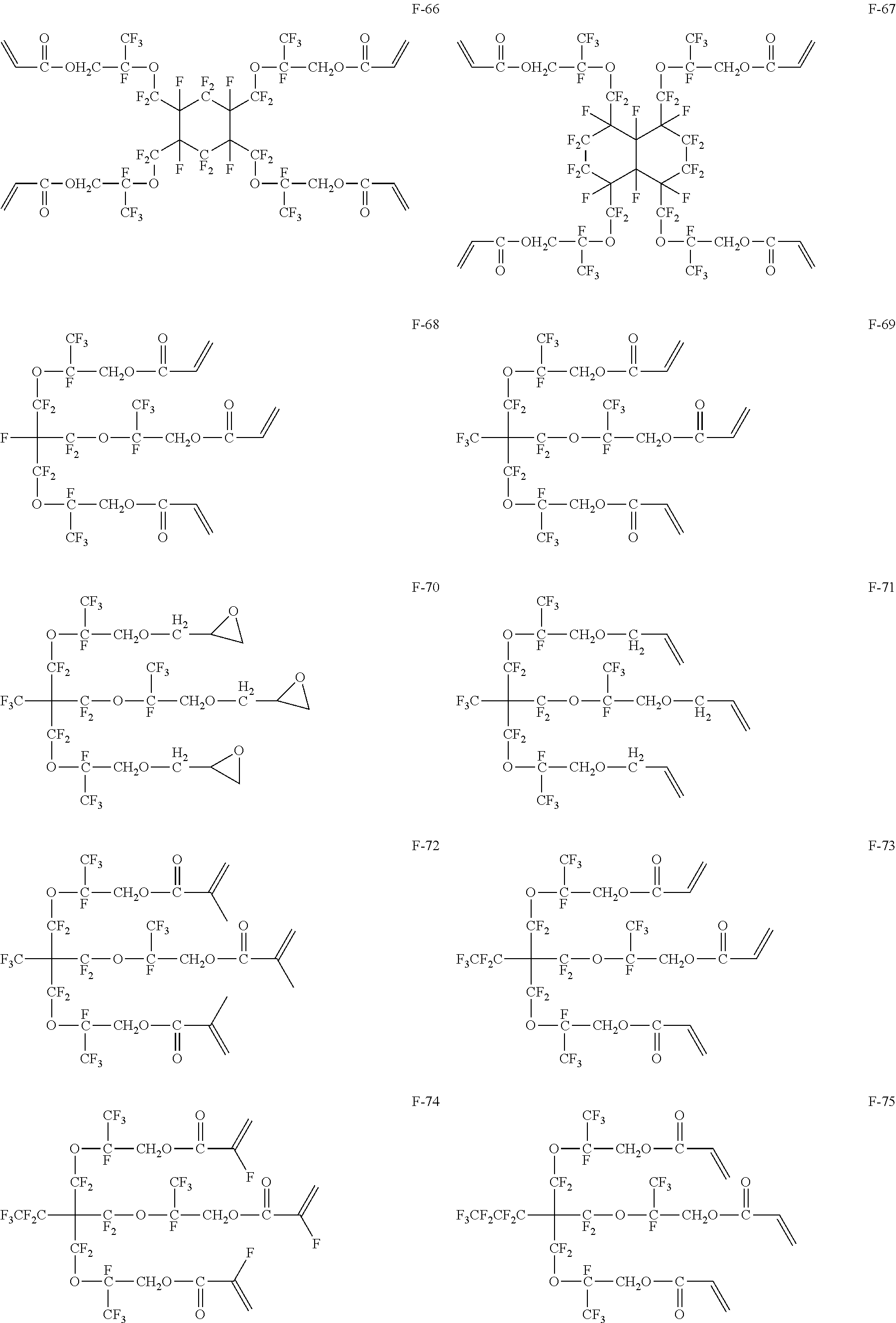

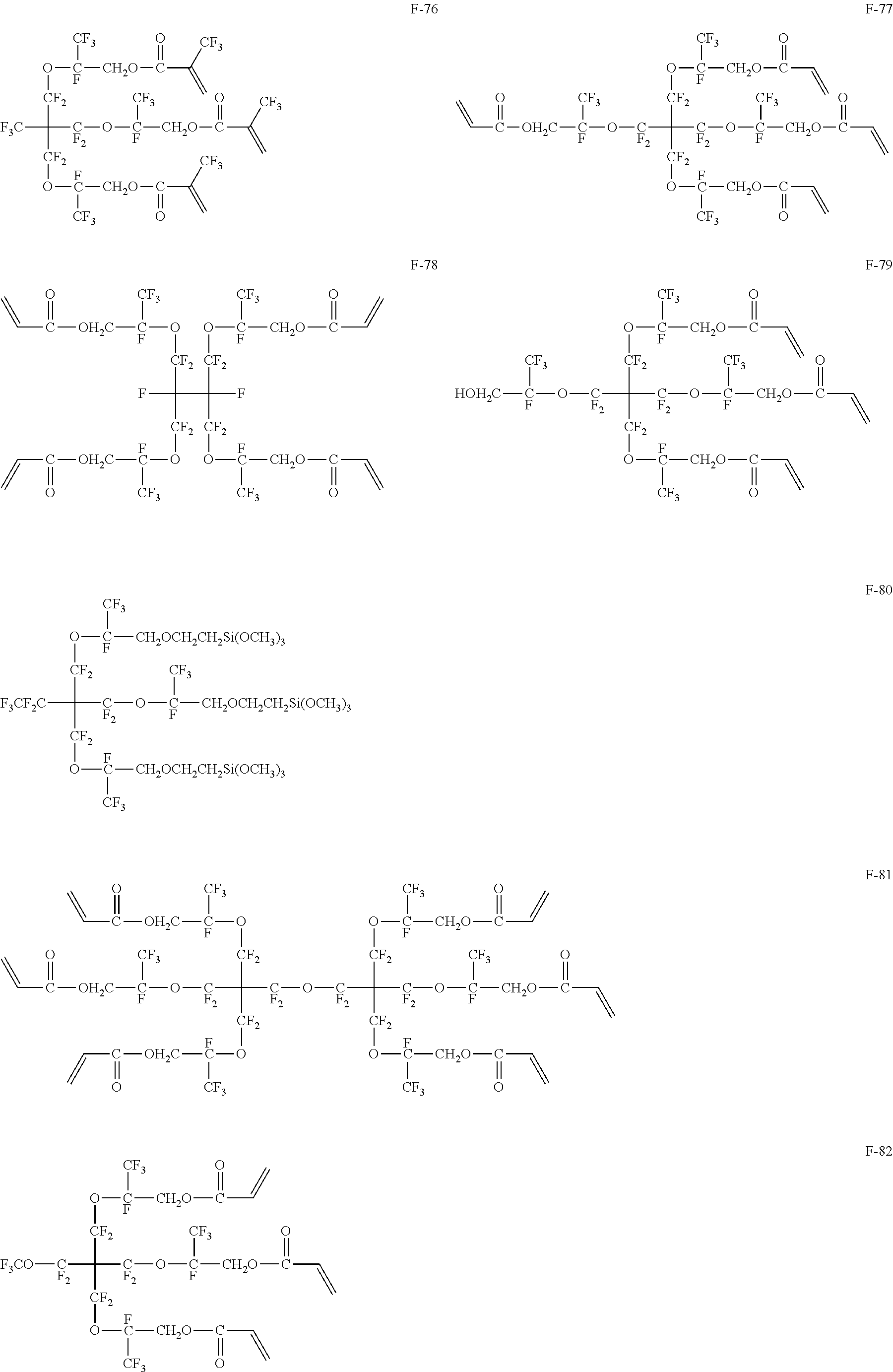

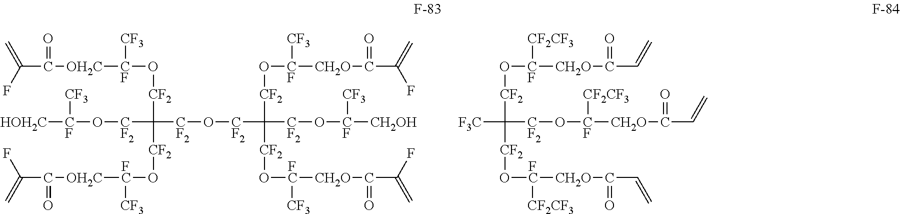

Furthermore, from the standpoint of compatibility with other binder or a non-fluorine-containing monomer, a monomer having a repeating unit of an alkyl chain substituted with a fluorine atom through an ether bond, represented by formula (II) shown below is used as the fluorine-containing monomer.

Y—(CF₂—CFX—O)ₙ₂—Y Formula (II)

In formula (II), X represents —F or —CF₃, n2 represents an integer of 1 to 20, and Y represents a polymerizable group.

The preferable range and specific example of Y are same as those described for Y in formula (I).

Specific examples of the fluorine-containing polyfunctional monomer represented by formula (II) are set forth below, but the invention should not be construed as being limited thereto.
FP-1: CH₂═CH—COOCH₂(CF₂CF₂—O)₂CH₂OCOCH═CH₂
FP-2: CH₂═CH—COOCH₂(CF₂CF₂—O)₄CH₂OCOCH═CH₂
FP-3: CH₂═C(CH₃)—COOCH₂(CF₂CF₂—O)₂CH₂OCOC(CH₃)CH₂
PF-4: CH₂═C(CH₃)—COOCH₂(CF₂C(CF₃)F—O)₂CH₂OCOC(CH₃)═CH₂
PF-5: CH₂═C(CH₃)—COOCH₂(CF₂C(CF₃)F—O)₈CH₂OCOC(CH₃)═CH₂

Further, from the standpoint of capability of forming a crosslinking structure and high strength and hardness of the cured layer, fluorine-containing polyfunctional (meth)acrylate described below are also preferably used as the fluorine-containing monomer. Specifically, for example, 1,3-bis{(meth)acryloyloxy}-2,2-difluoropropane, 1,4-bis{(meth)acryloyloxy}-2,2,3,3-tetrafluorobutane, 1,5-bis{(meth)acryloyloxy}-2,2,3,3,4,4-hexafluoropentane, 1,6-bis{(meth)acryloyloxy}-2,2,3,3,4,4, 5,5-octafluorohexane, 1,7-bis{(meth)acryloyloxy}-2,2,3,3,4,4,5,5,6,6-decafluoroheptane, 1,8-bis{(meth)acryloyloxy}-2,2,3,3,4,4,5,5,6,6,7,7-dodecafluorooctane, 1,9-bis{(meth)acryloyloxy}-2,2,3,3,4,4,5,5,6,6,7,7,8,8-tetradecafluorononane, 1,10-bis{(meth)acryloyloxy}-2,2,3,3,4,4,5,5,6,6,7,7,8,8,9,9-hexadecafluorodecane, 1,11-bis{(meth)acryloyloxy}-2,2,3,3,4,4,5,5,6,6,7,7,8,8,9,9,10,10-octadecafluoroundecane, 1,12-bis{(meth)acryloyloxy}-2,2,3,3,4,4,5,5,6,6,7,7,8,8,9,9,10,10,11,11-eicosafluorododecane, 1,8-bis{(meth)acryloyloxy}-2,7-dihydroxy-4,4,5,5-tetrafluorooctane, 1,7-bis{(meth)acryloyloxy}-2,8-dihydroxy-4,4,5,5-tetrafluorooctane, 2,7-bis{(meth)acryloyloxy}-1,8-dihydroxy-4,4,5,5-tetrafluorooctane, 1,10-bis{(meth)acryloyloxy}-2,9-dihydroxy-4,4,5,5,6,6,7,7-octafluorodecane, 1,9-bis{(meth)acryloyloxy}-2,10-dihydroxy-4,4,5,5,6,6,7,7-octafluorodecane, 2,9-bis{(meth)acryloyloxy}-1,10-dihydroxy-4,4,5,5,6,6,7,7-octafluorodecane, 1,2,7,8-tetrakis{(meth)acryloyloxy}-4,4,5,5-tetrafluorodecane, 1,2,8,9-tetrakis{(meth)acryloyloxy}-4,4,5,5,6,6-hexafluorononane, 1,2,9,10-tetrakis{(meth)acryloyloxy}-4,4, 5,5,6,6,7,7-octafluorodecane, 1,2,10,11-tetrakis{(meth)acryloyloxy}-4,4,5,5,6,6,7,7,8,8-decafluoroundecane, 1,2,11,12-tetrakis{(meth)acryloyloxy}-4,4,5,5,6,6,7,7,8,8,9,9-dodecafluorododecane, 1,10-bis(α-fluoroacryloyloxy)-2,9-dihydroxy-4,4,5,5,6,6,7,7-octafluorodecane, 1,9-bis(α-fluoroacryloyloxy)-2,10-dihydroxy-4,4,5,5,6,6,7,7-octafluorodecane, 2,9-bis(α-fluoroacryloyloxy)-1,10-dihydroxy-4,4,5,5,6,6,7,7-octafluorodecane, 1,2,9,10-tetrakis(α-fluoroacryloyloxy)-4,4,5,5,6,6,7,7-octafluorodecane and 1,2,11,12-tetrakis(α-fluoroacryloyloxy)-4,4,5,5,6,6,7,7,8,8,9,9-dodecafluorododecane are exemplified.

The fluorine-containing polyfunctional (meth)acrylate can be synthesized according to a known method. For instance, it is produced by a ring-opening reaction of a corresponding fluorine-containing epoxy compound with (meth)acrylic acid or an esterification reaction of a corresponding fluorine-containing polyhydric alcohol or a fluorine-containing meth(acrylate) having a hydroxy group obtained as an intermediate compound in the ring-opening reaction described above with (meth)acrylic chloride.

### (Fluorine Content in Fluorine-Containing Monomer)

The fluorine content in the fluorine-containing monomer is preferably 25.0% by weight or more, more preferably from 45.0 to 80.0% by weight, most preferably from 50.0 to 80.0% by weight, based on the molecular weight of the fluorine-containing monomer, from the standpoint of forming the lower part uneven distribution of the organic conductive compound to improve the conductivity. When the fluorine content exceeds 80.0% by weight, the strength and hardness of the coated layer decrease to lead insufficient scratch resistance and abrasion resistance of the surface of the coated layer, although the content of fluorine atom in the cured layer is high.

As the fluorine-containing curable compound used as component (B) according to the invention, a polymer is preferred from the standpoint of stability of the surface state of the coated layer. On the other hand, from the standpoint of improvement in the solubility of the coating composition and improvement in the adhesion property, a fluorine-containing curable monomer is preferred. The use of the polymer together with the monomer is particularly preferred because these properties can be achieved at a high level.

The content of the fluorine-containing curable compound in the composition containing component (A) and component (B) according to the invention is preferably from 3 to 94% by weight, more preferably from 5 to 90% by weight, most preferably from 10 to 80% by weight, based on the total solid content of he composition. When the content of the fluorine-containing curable compound is in the range described above, the laminate has low reflection, is excellent in the scratch resistance and can achieve the lower part uneven distribution of the organic conductive compound.

The composition containing component (A) and component (B) according to the invention may further contain a non-fluorine-containing polyfunctional monomer in addition to the fluorine-containing monomer. In the laminate according to the invention, distribution in the concentration of the curable material also takes place in the layer with the formation of the lower part uneven distribution of the organic conductive compound. By using together a non-fluorine-containing curable compound having high affinity to the organic conductive compound, the density of the curable group in the vicinity of the organic conductive compound unevenly distributed in the lower part can be increased to cure both the upper part and the lower part in a proper balance, thereby improving the adhesion property and scratch resistance of the laminate.

### (Non-Fluorine-Containing Polyfunctional Monomer)

The non-fluorine-containing polyfunctional monomer includes a compound which has two or more polymerizable groups and does not contain a fluorine atom in its molecule. The polymerizable groups include those described with respect to the fluorine-containing monomer described above and the preferred ranges are also same. In particular, (meth)acryloyl group is particularly preferred. When the fluorine content in the monomer for forming a binder is increased in order to decrease the refractive index of the layer, the density of the crosslinkable group is decreased in the layer and the strength of the coated layer deteriorates, thereby tending to decrease the scratch resistance. Further, the fluorine-containing monomer and the organic conductive compound are poor in affinity with each other because the polarities of both compounds are largely different. This is particularly remarkable when the organic conductive compound is a polymer compound. Therefore, in the formation of layer by coating and drying the coating solution containing an organic solvent, interfacial bond between the organic conductive compound and the fluorine-containing monomer is weak to tend to deteriorate the strength of the coated layer after curing. In particular, when the composition is used for a low refractive index layer which forms the outermost surface of an antireflective film, it is easily affected by the polymerization inhibition due to oxygen, thereby tending to moreover deteriorate the curing. In response, by using together the non-fluorine-containing polyfunctional monomer, the affinity between the organic conductive compound and the fluorine-containing monomer is further improved to increase the strength of the coated layer, thereby improving the scratch resistance.

The non-fluorine-containing polyfunctional monomer having two or more (meth)acryloyl groups includes, for example, a (meth)acrylic acid diester of polyhydric alcohol and a (meth)acrylic acid diester of ethyleneoxide or propyleneoxide adduct. Specific examples thereof are described in Paragraph No. [0116] of JP-A-2009-98658 and they are preferably used in the invention.

Further, an epoxy(meth)acrylate, a urethane(meth)acrylate and a polyester(meth)acrylate are also preferably used as a photopolymerizable polyfunctional monomer.

Among them, an ester of polyhydric alcohol and (meth)acrylic acid is preferred and a polyfunctional monomer having three or more (meth)acryloyl groups in its molecule is more preferred.

Of the compounds, those having a hydroxy group, an amido group, an ethyleneoxide group or a propyleneoxide group in the molecules thereof are preferred. The compound having such a functional group is excellent in the affinity with both the organic conductive compound and the fluorine-containing monomer to achieve improvement in the surface state of the coated layer, improvement in the time-lapse stability of a coating solution, increase in the hardness of the layer and improvement in the scratch resistance.

As the polyfunctional acrylate compound having a (meth)acryloyl group, commercially available products may also be used. For example, DPHA produced by Nippon Kayaku Co., Ltd. is exemplified. Also, the compounds described in Paragraph No. [0119] of JP-A-2009-98658 are preferably used.

Of the compounds having a polymerizable unsaturated group, those having both of a glycidyl group and/or a hydroxy group and at least one group selected from a methacryl group, an acryl group, a methacrylamido group and an acrylamido group are preferably used from he standpoint of improvement in the affinity with both the organic conductive compound and the fluorine-containing monomer. Specific examples of such a compound include compounds shown below.

Examples of the compound having a glycidyl group and a methacryl group (acryl group) include glycidyl methacrylate and glycidyl acrylate are exemplified.

Examples of the compound having a hydroxy group and any one of a methacryl group, an acryl group, a methacrylamido group and an acrylamido group include 2-hydroxyethyl methacrylate, 2-hydroxyethyl acrylate, 2-hydroxypropyl methacrylate, 2-hydroxypropyl acrylate, 4-hydroxybutyl methacrylate, 4-hydroxybutyl acrylate, ethyl α-(hydroxymethyl)acrylate, pentaerythritol acrylate, dipentaerythritol monohydroxy pentaacrylate, 2-hydroxyethylacrylamide and 2-hydroxyethylmethacrylamide.

The compounds may be used either individually or as a mixture of two or more thereof. Of the examples of the compound, 2-hydroxyethylacrylamide, 2-hydroxyethylmethacrylamide, 2-hydroxyethyl acrylate or dipentaerythritol monohydroxy pentaacrylate is preferred, and 2-hydroxyethylacrylamide is more preferred, in view of high affinity with the conductive polymer composition according to the invention. The compound is excellent in the surface state of the coated layer, can increase crosslink density in the transparent conductive layer and can improve the heat resistance, high temperature and high humidity resistance and scratch resistance.

Moreover, a resin having three or more (meth)acryloyl groups, for example, a relatively low molecular weight polyester resin, polyether resin, acrylic resin, epoxy resin, urethane resin, alkyd resin, spiroacetal resin, polybutadiene resin or polythiolpolyene resin, or an oligomer or prepolymer of a polyfunctional compound, for example, a polyhydric alcohol is exemplified.

As the non-fluorine-containing polyfunctional monomer, a dendrimer described, for example, in JP-A-2005-76005 and JP-A-2005-36105, or a norbornene ring-containing monomer described, for example, in JP-A-2005-60425 may also be used.

Two or more kinds of the non-fluorine-containing polyfunctional monomers may be used in combination.

The amount of the non-fluorine-containing polyfunctional monomer added to the composition according to the invention is preferably from 0.1 to 50% by weight, more preferably from 1 to 30% by weight, particularly preferably from 3 to 20% by weight, based on the total solid content of the composition. In the range of amount described above, increase in the hardness of the layer, immobilization of the antifouling agent described hereinafter in the surface layer and improvement in the interfacial adhesion to an adjacent layer are preferably achieved.

Further, an oligomer or polymer having a polymerizable group may also be used.

### [(D) Inorganic Fine Particle]

When reduction of the refractive index and improvement in the scratch resistance are intended in the layer formed from the composition containing component (A) and component (B), it is preferred to use an inorganic fine particle. The inorganic fine particle is not particularly restricted as long as it has an average particle size of 1 to 200 nm. From the standpoint of the reduction of refractive index, an inorganic low refractive index particle is preferred.

The inorganic fine particle includes a magnesium fluoride fine particle and a silica fine particle because of its low refractive index. In particular, from the standpoint of refractive index, dispersion stability and cost, a silica fine particle is preferred. The size (primary particle size) of the inorganic fine particle is preferably from 1 to 200 nm, more preferably from 5 to 150 nm, still more preferably from 20 to 100 nm, and most preferably from 40 to 90 nm.

When the particle size of the inorganic fine particle is too small, the effect of improving the scratch resistance decreases, whereas when it is too large, fine irregularities are generated on the surface of the layer and the appearance, for example, dense blackness or the integrated reflectivity may be deteriorated. The inorganic fine particle may be crystalline or amorphous, and it may be a monodisperse particle or an aggregate particle as long as the predetermined particle size is satisfied. The shape is most preferably sphere, but it may be other than sphere, for example, an amorphous form.

The coating amount of the inorganic fine particle is preferably from 1 to 100 mg/m², more preferably from 5 to 80 mg/m², and still more preferably from 10 to 60 mg/m². When the coating amount is too small, the effect of improving the scratch resistance decreases, whereas when it is too large, fine irregularities are generated on the surface of the layer and the appearance, for example, dense blackness or the integrated reflectivity may be deteriorated.

(Fine Particle having Porous or Hollow Structure)

For the purpose of reducing the refractive index, the inorganic fine particle (D) is preferably a porous inorganic fine particle or an inorganic fine particle having a hollow structure inside. Particularly, a silica fine particle having a hollow structure inside is preferably used. The void percentage of the fine particle having a hollow structure is preferably from 10 to 80%, more preferably from 20 to 60%, and most preferably from 30 to 60%. The void percentage of the hollow fine particle in the range described above is preferred from the standpoint of reducing the refractive index and maintaining the durability of the particle.

In the case where the porous or hollow particle is a silica fine particle, the refractive index of the fine particle is preferably from 1.10 to 1.40, more preferably from 1.15 to 1.35, and most preferably from 1.15 to 1.30. The refractive index as used herein indicates a refractive index of the particle as a whole, and does not indicate a refractive index of only silica in the outer shell forming the silica particle.

The coating amount of the porous or hollow silica particle is preferably from 1 to 100 mg/m², more preferably from 5 to 80 mg/m², and still more preferably from 10 to 60 mg/m². When the coating amount is too small, the effect of reducing the refractive index or improving the scratch resistance decreases, whereas when it is too large, fine irregularities are generated on the surface of the layer and the appearance, for example, dense blackness or the integrated reflectivity may be deteriorated.

When the particle size of the silica fine particle is too small, a rate of void region decreases and the reduction of refractive index is not expected, whereas when it is too large, fine irregularities are generated on the surface of the layer and the appearance, for example, dense blackness or the integrated reflectivity may be deteriorated. The silica fine particle may be crystalline or amorphous. The silica fine particle is preferably a monodisperse particle. The shape is most preferably sphere, but it may be other than sphere, for example, an amorphous form.

Two or more hollow silica particles having average particle sizes different from each other may be used together. The average particle size of the hollow silica particle can be determined from electron micrographs.

The specific surface area of the hollow silica particle is preferably from 20 to 300 m²/g, more preferably from 30 to 120 m²/g, and most preferably from 40 to 90 m²/g. The surface area can be determined by a BET method using nitrogen.

In the invention, a void-free silica particle may be used together with the hollow silica. The particle size of the void-free silica particle is preferably from 30 to 150 nm, more preferably from 35 to 100 nm, and most preferably from 40 to 80 nm.

Preferred embodiments of the inorganic fine particle and porous or hollow fine particle, preparation method, surface treatment method, and organosilane compound and metal chelate compound used in the surface treatment method are described in Paragraph Nos. to [0078] of JP-A-2009-98658, and they are similarly applied to the invention.

### [Antifouling Agent]

The composition according to the invention preferably contain an antifouling agent for the purposes of imparting a property, for example, an antifouling property, water resistance, chemical resistance or a slipping property and accelerating the uneven distribution of the organic conductive compound in the layer thickness direction. As the antifouling agent, (C) a fluorine-containing antifouling agent or (D) a silicone type antifouling agent is preferred.

The fluorine-containing antifouling agent preferably contains a polymerizable unsaturated group. By using such an antifouling agent, prevention the fluorine-containing antifouling agent from transferring to the rare surface during the preservation of the coated film in the form of roll, improvement in the scratch resistance of the coated layer and improvement in the durability against the repetition of wiping off of stain can be achieved.

The amount of the antifouling agent added is preferably in a range from 0.01 to 20% by weight, more preferably from 0.05 to 10% by weight, particularly preferably from 0.1 to 5% by weight, based on the total solid content of the composition.

The fluorine-containing antifouling agent preferably contains a polymerizable unsaturated group. By using such an antifouling agent, prevention the fluorine-containing antifouling agent from transferring to the rare surface during the preservation of the coated film in the form of roll, improvement in the scratch resistance of the coated layer and improvement in the durability against the repetition of wiping off of stain can be achieved.

Preferred embodiments and specific examples of the fluorine-containing antifouling agent are described in Paragraph Nos. [0218] to [0219] of JP-A-2007-301970, and they are similarly applied to the invention.

The silicone type antifouling agent is used for the purposes of imparting a slipping property to improve the scratch resistance and imparting the antifouling property and is preferably a compound having a polysiloxane structure. Preferred embodiments and specific examples of the silicone type antifouling agent are described in Paragraph Nos. [0212] to [0217] of JP-A-2007-301970, and they are similarly applied to the invention.

### [Polymerization Initiator]

The composition according to the invention preferably contains a polymerization initiator. As the polymerization initiator, various kinds of polymerization initiators may be used and a photo-polymerization initiator is preferred. Examples of the photo-polymerization initiator includes an acetophenone, a benzoin, a benzophenone, a phosphine oxide, a ketal, an anthraquinone, a thioxanthone, an azo compound, a peroxide, a 2,3-dialkyldione compound, a disulfide compound, a fluoroamine compound, an aromatic sulfonium, a lophine dimer, an onium salt, a borate salt, an active ester, an active halogen, an inorganic complex and a coumarin.

Specific examples, preferred ranges, preferred embodiments, commercially available products of the photo-polymerization initiator are described in Paragraph Nos. [0131] to of JP-A-2009-98658, and they are similarly applied to the invention. Also, other polymerization initiators are described in Paragraph Nos. [0232] to [0236] of JP-A-2006-293329.

In the laminate according to the invention, distribution in the concentration of the curable material or polymerization initiator also takes place in the layer with the formation of the lower part uneven distribution of the organic conductive compound. By using together a non-fluorine-containing curable compound having high affinity to the organic conductive compound, the density of the curable group in the vicinity of the organic conductive compound unevenly distributed in the lower part can be increased to cure both the upper part and the lower part in a proper balance, thereby improving the adhesion property and scratch resistance of the laminate.

It is effective in view of improvements in the adhesion property and scratch resistance of the laminate that the position of the polymerization initiator existing in the layer is controlled to undergo polymerization at a proper balance in the lower part where the organic conductive compound of component (A) is unevenly distributed and in the upper part where the fluorine-containing curable compound of component (B) is unevenly distributed.

The polymerization initiator which is effective for the uneven distribution in the upper part according to the invention includes a fluoroalkyl group-containing polymerization initiator and a silicone-containing polymerization initiator. In particular, a fluoroalkyl group-containing polymerization initiator having a high affinity with the fluorine-containing curable compound unevenly distributed in the upper part is preferably used. The fluoroalkyl group-containing polymerization initiators include those represented by formula (1) described in JP-T-8-508733 (the term “JP-T” as used herein means a published Japanese translation of a PCT patent application) and those represented by formulae (1) to (5) described in JP-A-2007-11309.

The polymerization initiator which is effective for the uneven distribution in the lower part according to the invention includes a non-fluorine-containing polymerization initiator. In particular, a highly polar polymerization initiator having an SP value of 20 or more (35 or less) is preferably used. The SP value of compound is a solubility parameter and a numerical value indicating how much the compound can dissolve in a solvent or the like. It has the same meaning as polarity ordinarily used with respect to an organic compound and as the SP value is larger, it is meant that the polarity is greater. With the fluorine-containing curable compound of component (B), the SP value calculated by Fedors' estimation method is approximately 20 or less. The SP value as used herein is a numerical value calculated by Fedors' estimation method (Hideki Yamamoto, SP Chi Kiso Oyo to Keisanhoho (Fundament, Application and Calculation Method of SP Value), page 66, published by Johokiko Co., Ltd. (Mar. 31, 2005)).

In the invention, the polymerization initiator suitable for the lower part uneven distribution preferably has as a partial structure, a hydroxy group, an alkoxysilyl group, a carboxyl group or a quaternary ammonium group in order to increase the polarity of the molecule. Of the compounds known as water-soluble polymerization initiators, polymerization initiators soluble in the composition containing component (A) and component (B) according to the invention are also preferably used. The polymerization initiators are described in Paragraph Nos. [0195] to [0207] of JP-A-2007-168429.

In the invention, it is preferred to use a polymerization initiator having high tendency to form the upper part uneven distribution together with a polymerization initiator having high tendency to form the lower part uneven distribution. A mixing ratio of both polymerization initiators is preferably from 1:9 to 9:1, more preferably from 2:8 to 8:2, in terms of weight ratio. The amount of the polymerization initiator added is preferably from 0.2 to 10% by weight, more preferably from 0.5 to 8% by weight, most preferably from 1 to 6% by weight, based on the total solid content of the layer.

### [Solvent for Coating]

As the solvents for use in the layer formed from the composition according to the invention and other respective layers, various solvents can be used which are selected by considering their properties, for example, in that they can dissolve or disperse the respective components, in that they are easily form a uniform surface state in the coating step and a drying step, in that they can ensure solution preservation property and in that they have appropriate saturated vapor pressures. The solid content concentration in the coating composition is preferably from 0.5 to 50% by weight, more preferably from 1 to 10% by weight, and most preferably from 1 to 8% by weight.

In particular, according to the invention, since component (A) and component (B) are intrinsically difficult to mix with each other, when the both are dissolved or dispersed uniformly in a solvent together with other components to prepare a composition for coating and the solvent evaporates in a drying process of the coating layer, the uniform dissolution or dispersion of each component can not be maintained to cause the uneven distribution.

From the standpoint of stability of the surface state of the coated layer and prevention of deterioration of the surface state or increase in haze caused by the unnecessary occurrence of sea-island like phase separation, two kinds of solvents may be used as a mixture.

In case of using two kinds of solvents as a mixture, it is preferred that at least one solvent is a good solvent for the organic conductive compound of component (A) and at least one solvent is a good solvent for the fluorine-containing curable compound of component (B). A mixing ratio (weight ratio) of the solvents is preferably from 1:9 to 9:1, and more preferably from 2:8 to 8:2. The boiling point of the solvent is not particularly restricted and is preferably from 50 to 200° C., from the standpoint of the handling property at room temperature and the reduced load for drying. In view of stability of the surface state of the coated layer, it is preferred that the boiling point of the good solvent for component (A) is lower than the boiling point of the good solvent for component (B).

Specific examples of the solvent are set forth below, but the invention should not be construed as being limited thereto. The boiling point of each solvent is also shown in parentheses.

Specific examples of the good solvent for component (A) include tetrahydrofuran (66° C.), acetone (56° C.), ethanol (78° C.), isopropyl alcohol (IPA) (82° C.), acetonitrile (82° C.), propylene glycol monomethyl ether (120° C.), propylene glycol monoethyl ether (132° C.), propylene glycol monobutyl ether (171° C.), propylene glycol monomethyl ether acetate (PGMEA) (146° C.), propylene glycol monoethyl ether acetate (145° C.), ethylene glycol monomethyl ether (124° C.), ethylene glycol monoethyl ether (135° C.), ethylene glycol monoethyl ether acetate (156° C.) and ethylene glycol diethyl ether (121° C.).

Specific examples of the good solvent for component (B) include methyl ethyl ketone (MEK) (80° C.), cyclohexanone (156° C.), methyl isobutyl ketone (MIBK) (116° C.), toluene (111° C.), xylene (138° C.), ethyl acetate (77° C.), isopropyl acetate (89° C.), propylene glycol monoethyl ether (132° C.) and propylene glycol monoethyl ether acetate (145° C.).

In addition, the solvent further used for the formation of coating composition according to the invention includes compounds described in JP-A-2008-151866.

Another preferable example of using two or more kinds of organic solvents is to use two kinds of solvents where a difference of the boiling points thereof is larger than a specific value. The difference of the boiling points of two solvents is preferably 25° C. or more, more preferably 35° C. or more, and still more preferably 50° C. or more. When the difference of the boiling points is large, the lower layer uneven distribution of the organic conductive compound and separation of binder are apt to occur.

[Method for Formation of Layer Formed from Composition Containing Component (A) and Component (B)]

With respect to the method for formation of a layer formed from the composition containing component (A) and component (B), a curing condition suitable for a curable functional group contained in each component used in the layer is selected. Preferred embodiments are described below.

(A) System Using Fluorine-Containing Curable Compound having a Hydroxy Group Together with Compound Capable of Reacting with Hydroxy Group

The curing temperature is preferably from 60 to 200° C., more preferably from 80 to 130° C., and most preferably from 80 to 110° C. In the case where the support is liable to deteriorate at high temperature, the curing temperature is preferably low. The time required for heat curing is preferably from 30 seconds to 60 minutes, and more preferably from 1 to 20 minutes.

Particularly, in the case where the under surface is an optical film constituting layer containing ionizing radiation-curable (meth)acrylate group, the interface bonding can be strengthened by adding a (meth)acrylate group-containing compound to the composition. Preferred curing conditions are described hereinafter together with those in system (B) below.

(B) System Using Fluorine-Containing Curable Compound having (meth)acrylate Group

In the case where the fluorine-containing curable compound has a (meth)acrylate group, it is preferred to use together with a compound having a (meth)acrylate group, from the standpoint of increase in the strength of the coated layer. It is effective to perform the curing by combining irradiation of ionizing radiation and a heat treatment before, simultaneous with or after the irradiation.

A few patterns of the production process are set forth below, but the invention should not be construed as being limited thereto.

In addition, a process of performing a heat treatment simultaneously with the ionizing radiation curing is also preferred.

| | Before Irradiation | Simultaneous with Irradiation | After Irradiation |
|---|---|---|---|
| (1) | Heat Treatment | Ionizing Radiation Curing | — |
| (2) | Heat Treatment | Ionizing Radiation Curing | Heat Treatment |
| (3) | — | Ionizing Radiation Curing | Heat Treatment |

In the table above, “-” denotes that the heat treatment is not performed.

### (Heat Treatment)

According to the invention, as described above, the heat treatment is preferably performed in combination with the irradiation of ionizing radiation. The heat treatment is not particularly limited as long as it does not impair the support and constituting layers of optical film and is preferably from 60 to 200° C., more preferably from 80 to 130° C., and most preferably from 80 to 110° C.

The orientation or distribution of each component in the coated layer may be adjusted or the photo-curing reaction may be controlled by the increase in temperature. Each component is not immobilized and orientation of each component relatively promptly occurs before the curing by the irradiation of ionizing radiation or heat, whereas after the initiation of curing, each component is immobilized and the orientation occurs only partially. The time required for the heat treatment may vary depending, for example, on the molecular weight of the component used, the interaction with other components or the viscosity and is ordinarily from 30 seconds to 24 hours, preferably from 60 seconds to 5 hours, and most preferably from 3 to 30 minutes.

### (Condition for Irradiation of Ionizing Radiation)

The layer surface temperature at the irradiation of ionizing radiation is not particularly limited and is ordinarily from 20 to 200° C., preferably from 30 to 150° C., and most preferably from 40 to 120° C., in view of the handling property and uniformity of performance in the layer. The layer surface temperature of not more than the above-described upper limit is preferred because problems are avoided in that the flowability of the low molecular component in the binder excessively increases to deteriorate the surface state and in that the support is damaged due to heat. The film surface temperature of not lower than the above-describe lower limit is also preferred because the curing reaction proceeds sufficiently and good scratch resistance of the layer is obtained.

### (Oxygen Concentration)

The oxygen concentration at the irradiation of ionizing radiation is preferably 3% by volume or less, more preferably 1% by volume or less, and still more preferably 0.1% by volume or less. When a step of maintaining the layer in an atmosphere having an oxygen concentration of 3% by volume or less is provided immediately before or immediately after the step of irradiating the ionizing radiation at an oxygen concentration of 3% by volume or less, the curing of the layer can be sufficiently promoted and a layer excellent in the physical strength and chemical resistance can be formed.

### [Layer Construction of Laminate of Invention]

The layer construction of the laminate of the invention comprises a support and a layer (antistatic layer) formed from the composition containing component (A) and component (B). An easily adhesive layer or other functional layers may be formed between the support and the antistatic layer. The thickness of the antistatic layer according to the invention is preferably from 20 nm to 5 μm, more preferably from 50 nm to 3 μm, and most preferably from 70 to 900 nm.

### [Layer Construction of Antireflective Film]

When the laminate of the invention is an antireflective film, the antireflective film has a low refractive index layer having a refractive index lower than that of the support. Also, the antireflective film may have a hardcoat layer described hereinafter for the purpose of increasing the physical strength of the antireflective film. The hardcoat layer is preferably formed between the support and the low refractive index layer.

Further, the antireflective film may have a high refractive index layer having a refractive index higher than that of the support for the purpose of more decreasing the reflectance. Examples of the construction include a construction where two layers of high refractive index layer/low refractive index layer are laminated in order from the support side on the support or hardcoat layer on the support, and a construction where three layers differing in the refractive index are laminated in the order of a middle refractive index layer (a layer having a refractive index higher than that of the support or hardcoat layer but lower than that of the high refractive index layer)/a high refractive index layer/a low refractive index layer from the support side. Each layer on the support may be formed by considering, or example, the refractive index, layer thickness, number of layers or order of layers so as to decrease the reflectance as a whole by the optical interference.

More specific examples of the layer construction of the antireflective film according to the invention are set forth below.
Support/low refractive index layer
Support/antiglare layer/low refractive index layer
Support/hard coat layer/low refractive index layer
Support/hard coat layer/antiglare layer/low refractive index layer
Support/hard coat layer/high refractive index layer/low refractive index layer
Support/hard coat layer/medium refractive index layer/high refractive index layer/low refractive index layer
Support/hard coat layer/antiglare layer/high refractive index layer/low refractive index layer
Support/hard coat layer/antiglare layer/medium refractive index layer/high refractive index layer/low refractive index layer
Support/antiglare layer/high refractive index layer/low refractive index layer
Support/antiglare layer/medium refractive index layer/high refractive index layer/low refractive index layer

Although the low refractive index layer according to the invention has the antistatic function, a second antistatic layer (layer containing a conductive material) may be formed in addition to the low refractive index layer having the antistatic function according to the invention, if desired. In this case, the second antistatic layer may be provided at any position of the antireflective film and specific examples of the layer construction thereof containing the second antistatic layer are set forth below.
Support/second antistatic layer/low refractive index layer
Support/antiglare layer/second antistatic layer/low refractive index layer
Support/hard coat layer/antiglare layer/second antistatic layer/low refractive index layer
Support/hard coat layer/second antistatic layer/antiglare layer/low refractive index layer
Support/hard coat layer/second antistatic layer/high refractive index layer/low refractive index layer
Support/second antistatic layer/hard coat layer/medium refractive index layer/high refractive index layer/low refractive index layer
Second antistatic layer/support/hard coat layer/medium refractive index layer/high refractive index layer/low refractive index layer
Support/second antistatic layer/antiglare layer/medium refractive index layer/high refractive index layer/low refractive index layer
Second antistatic layer/support/antiglare layer/medium refractive index layer/high refractive index layer/low refractive index layer
Second antistatic layer/support/antiglare layer/high refractive index layer/low refractive index layer/high refractive index layer/low refractive index layer

The layer constitution of the antireflective film is not limited to those above-described as long as the resulting anti-reflective film can reduce reflectance by the optical interference.

The high refractive layer may be a light diffusible layer having no antiglare property. The antistatic layer is preferably a layer containing a conductive polymer particle or a metal oxide fine particle (for example, ATO or ITO), and can be provided, for example, by coating or treating with atmospheric pressure plasma. In the case of providing an antifouling layer, it can be provided as the uppermost layer of the above layer constitution.

### [Low Refractive Index Layer]

In the case where the layer formed from the composition containing component (A) and component (B) is used as the low refractive index layer, the refractive index of the layer is preferably from 1.20 to 1.46, more preferably from 1.25 to 1.46, and particularly preferably from 1.30 to 1.46.

The thickness of the low refractive index layer is preferably from 50 to 200 nm, and more preferably from 70 to 120 nm.

According to the invention, when the lower part uneven distribution ratio of the organic conductive compound becomes large, a layer construction seemed to be composed of two or more layers each having a refractive index different from each other may be formed. In such a case, the total thickness of the layer formed from the composition is preferably from 70 to 900 nm, more preferably from 100 to 700 nm, and most preferably from 120 to 400 nm. The thickness of 70 nm or more is effective for the reduction of the reflectivity. The thickness of 900 nm or less the lower part uneven distribution of the organic conductive polymer is easily formed.

The haze of the low refractive index layer is preferably 3% or less, more preferably 2% or less, and most preferably 1% or less.

The strength of the low refractive index layer is preferably is preferably H or more, more preferably 2H or more, most preferably 3H or more, in the pencil hardness test applied a load of 500 g.

Further, in order to improve the antifouling property of the antireflective film, the contact angle of the surface with water is preferably 90 degrees or more, more preferably 95 degrees or more, and particularly preferably 100 degrees or more.

### [High Refractive Index Layer]

The high refractive index layer preferably contains an inorganic filler which is composed of an oxide of at least one metal selected from titanium, zirconium, aluminum, indium, zinc, tin and antimony and has an average particle size of preferably 0.2 μm or less, more preferably 0.1 μm or less, and still more preferably 0.06 μm or less, in order to increase the refractive index of the layer and to reduce the cure shrinkage.

Similar to the hard coat layer described above, the high refractive index layer may contain a mat particle or the inorganic filler in the range of amount similar to that of the hard coat layer.

Further, in the high refractive index layer containing a high refractive index mat particle, in order to increase the difference of refractive index between the mat particle and the layer, the high refractive index layer preferably contains silicon oxide for maintaining the refractive index of the layer at a low level. A preferable particle size of the silicon oxide is same as that described for the inorganic fine particle used in the low refractive index layer above.

The bulk refractive index of a mixture of a binder and the inorganic filler constituting the high refractive index layer according to the invention is preferably from 1.48 to 2.00, and more preferably from 1.50 to 1.80. By appropriately selecting the kind and proportion of the binder and the inorganic filler, the refractive index can be controlled to the above-described range. How to make the selection can be easily known by preliminary experiments.

The high refractive index layer is described in Paragraph Nos. [0197] to [0206] of JP-A-2009-98658.

### [Hardcoat Layer]

The hard coat layer is provided on the surface of support, if desired, in order to impart the physical strength to the anti-reflective film. In particular, it is preferably provided between the support and the high refractive index layer (or medium refractive index layer). The hard coat layer may also be functioned as the high refractive index layer by incorporating the high refractive index particle or the like as described above into the layer.

The hard coat layer is preferably formed by a crosslinking reaction or a polymerization reaction of an ionizing radiation curable resin. For example, it can be formed by coating a coating composition containing an ionizing radiation curable polyfunctional monomer or polyfunctional oligomer on a support and causing a crosslinking reaction or a polymerization reaction of the polyfunctional monomer or polyfunctional oligomer.

Similar to the high refractive index layer, the hard coat layer may contain a mat particle or the inorganic filler, in the range of amount similar to that of the high refractive index layer.

### (Surface State Improving Agent)

A coating solution used for preparing any of the layers on the support may contain a surface state improving agent in order to relieve defects of the surface state (for example, coating unevenness, drying unevenness or point defect). As the surface state improving agent, at least any of fluorine-based and silicone-based surface state improving agents is preferred.

The surface state improving agent is described in Paragraph Nos. [0258] to [0285] of JP-A-2006-293329 and it may also be used in the invention.

### [Support]

As the support of the laminate according to the invention, for example, a glass substrate, an inorganic oxide material substrate, a metal material substrate, a plastic substrate, a plastic film, paper or cloth may be used. In view of the ease of post processing, ease of continuous production and large market for optical use, a transparent plastic film is preferably used. Examples of a polymer for forming the plastic film include a cellulose ester (for example, triacetyl cellulose or diacetyl cellulose, typically, for example, TAC-TD80U or TAC-TD80UF, produced by FUJIFILM Corp.), a polyamide, a polycarbonate, a polyester (for example, polyethylene terephthalate or polyethylene naphthalate), a polystyrene, a polyolefin, a norbornene resin (for example, ARTON, trade name, produced by JSR Corp.) and an amorphous polyolefin (for example, ZEONEX, trade name, produced by Zeon Corp.). Among them, triacetyl cellulose, polyethylene terephthalate or polyethylene naphthalate is preferred, and triacetyl cellulose is particularly preferred. Further, a cellulose acylate film substantially free from a halogenated hydrocarbon, for example, dichloromethane and a production method thereof are described in Journal of Technical Disclosure by The Japan Institute of Invention and Innovation (Technical Disclosure No 2001-1745, issued on Mar. 15, 2001, hereinafter referred to as “Journal of Technical Disclosure No. 2001-1745”) and the cellulose acylate described therein are also preferably used.

According to the invention, a base material to which the layer formed from the composition containing component (A) and component (B) is directly contacted preferably contains a functional group described below in order to increase the lower part uneven distribution ratio of the organic conductive compound. By containing such a functional group, the affinity with the organic conductive compound increases, whereby as well as increase in the lower part uneven distribution ratio, the effect of improving adhesion to the base material is obtained.

Examples of the functional group which the base material contains include a hydroxy group, a carboxyl group, a phospho group, a sulfo group, an amido group, an amino group, a quaternary ammonium group and a silanol group. In the case of the dissociable functional group, it may form a salt. The functional group may be introduced into the base material in any form.

In the case where the base material is a support per se, the support may contain the functional group. For instance, a partially hydrophilized glass (containing a silanol group), a metal plate treated with a coupling agent (containing a silanol group, a titanium-hydroxy group, a zirconium-hydroxy group or aluminum-hydroxy group), a cellulose ester plastic film support (containing a hydroxy group), a cellulose ester plastic film support hydrophilized with saponification treatment (containing a hydroxy group) and a plastic support subjected to corona treatment or plasma treatment (containing a hydroxy group or a carboxyl group).

In the case of using the base material in which the functional group described above is provided between the support and the layer formed from the composition containing component (A) and component (B), it is preferred that the above-described functional group is introduced into a binder forming the surface layer of the base material or that a filler having the above-described functional group introduced is introduced the functional group.

Specifically, an acrylate monomer or silane coupling agent having the above-described functional group in its molecule is preferably used. Also, a surface of an inorganic or organic filler itself or a surface subjected to modification to introduce the above-described functional group may also be used.

According to the invention, the surface free energy of the base material is preferably from 25 to 72 mN/m, more preferably from 30 to 72 mN/m, most preferably from 35 to 65 mN/m, in order to progress the lower part uneven distribution of the organic conductive compound.

### [Performances of Antireflective Film]

The haze value of the antireflective film according to the invention is preferably from 3 to 70%, and more preferably from 4 to 60%.

The average reflectance of the antireflective film according to the invention in the range of 450 to 650 nm is preferably 3.0% or less, and more preferably 2.5% or less. When the antireflective film according to the invention has the haze value and average reflectance in the ranges described above, good antiglare property and good antireflective property are obtained without accompanying the degradation of transmission image, in the case of using the antireflective film in an image display device.

The common logarithm value (Log SR) of surface resistivity SR (Ω/sq) of the antireflective film according to the invention is 13.0 or less, preferably 11 or less and more preferably 9 or less. By controlling the value of surface resistivity in the range described above, the excellent dust resistance can be imparted.

As the surface resistivity is lower, a more preferable result is obtained from the standpoint of prevention of static charge. The lower limit of the surface resistivity is not particularly restricted but the lower limit of Log SR is preferably about 3, and more preferably 5. According to the invention, by controlling the refractive index of the low refractive index layer to the range described above and the surface resistivity of the antireflective film to the range described above, the dust resistance and low reflectance are well maintained. When Log SR is larger than 13.0, the dust resistance is poor.

### [Production Method of Antireflective Film]

The antireflection film of the invention can be produced according to the methods described below, but the method should not be construed as being limited thereto.

First, a coating solution containing the components for forming each layer is prepared. The resulting coating solution is coated to a support by using, for example, a dip coating method, an air knife coating method, a curtain coating method, a roller coating method, a wire bar coating method, a gravure coating method or an extrusion coating method (see U.S. Pat. No. 2,681,294), followed by heating and drying. Of the coating methods, a gravure coating method is preferably used, because the coating solution can be coated in a small coating amount with a high uniformity of layer thickness as in the formation of each layer of the antireflective film. Of the gravure coating methods, a microgravure coating method is more preferred because of the high uniformity of layer thickness.

Further, a die coating method is also preferably used. When the die coating method is used, the coating solution can be coated in a small coating amount with high uniformity of layer thickness. In addition, since the die coating method is a pre-metering system, the layer, thickness control is relatively easy, and vaporization of the solvent in a coating unit is small.

Two or more layers may be simultaneously coated. A method of simultaneous coating is described in U.S. Pat. Nos. 2,761,791, 2,941,898, 3,508,947, and 3,526,528 and Yuji Harazaki, Coating Kogaku (Coating Engineering), page 253, Asakura Publishing Co., Ltd. (1973).

### [Saponification Treatment]

In the case of using the antireflective film according to the invention in a liquid crystal display device, ordinarily, for example, an adhesive layer is provided on one surface of the antireflective film and then it is placed as the outermost surface of the display. For instance, when the support is triacetyl cellulose, since triacetyl cellulose is used as a protective film for protecting a polarizing film of polarizing plate, it is preferred in view of cost that the antireflective film according to the invention is used as it is as the protective film.

As described above, in the case where the antireflective film according to the invention is placed on the outermost surface of display or is used as it is as the protective film for polarizing plate, it is preferred to perform saponification treatment after formation of the low refractive index layer on the support.

The saponification treatment is described in Paragraph Nos. [0289] to [0293] of JP-A-2006-293329 and it may also be used in the invention.

### [Polarizing Plate]

A polarizing plate is mainly composed of two protective films sandwiching a polarizing film from the both surfaces thereof. It is preferred that the antireflective film according to the invention is used as at least one of the two protective films sandwiching a polarizing film from the both surfaces thereof. When the antireflective film according to the invention also functions as a protective film, the production cost of the polarizing plate can be reduced. Further, by using the antireflective film according to the invention as the outermost surface layer, it is possible to form a polarizing plate which is prevented, for example, from reflection of external light and which is excellent, for example, in the scratch resistance or antifouling property. As the polarizing film, known polarizing film can be used. The polarizing film is described in Paragraph Nos. [0299] to [0301] of JP-A-2006-293329 and it may also be used in the invention.

### [Image Display Device]

The antireflective film according to the invention can be used for an image display device, for example, a liquid crystal display device (LCD), a plasma display panel (PDP), an electroluminescence display device (ELD), a cathode ray tube display device (CRT), a field emission display (FED) or a surface-conduction electron-emitter display (SED) in order to prevent reduction in contrast due to reflection of external light or reflected glare image. The anti-reflective film or polarizing plate having the anti-reflective film according to the invention is preferably placed on the surface (on the viewing side of the display screen) of a display of the liquid crystal display device.

In case of using the anti-reflective film according to the invention as one side of a surface protective film of a polarizing film, it can be preferably used for transmission type, reflection type or semi-transmission type liquid crystal display devices of a twisted nematic (TN) mode, a super twisted nematic (STN) mode, a vertical alignment (VA) mode, an in-plane switching (IPS) mode, an optically compensated bend cell (OCB) mode, an electrically controlled birefringence (ECB) mode or the like. The liquid crystal display device is described in Paragraph Nos. [0303] to [0307] of JP-A-2006-293329.

The laminate according to the present invention can be applied, for example, to an antireflective film for solar battery cell, a material for non-display surface of home appliance (antifouling and antistatic layer), decorative laminate, wallpaper or a base material for protecting clock face, as well as the antireflective film for image display device described above.

### Examples

The present invention will be described with reference to the following examples, but the invention should not be construed as being limited thereto. Unless otherwise specifically indicated, all “part” and “%” are on a weight basis.

### [Preparation of Coating Solution for Hardcoat Layer (HC-1)]

The composition containing each component shown below was prepared and filtered through a polypropylene filter having a pore size of 30 μm to prepare a coating solution for hardcoat layer.

Coating Solution for Hardcoat Layer (HC-1)

| | |
|---|---|
| Binder | DPCA-20: 40.5 parts by weight |
| Polymerization initiator | IRGACURE 184: 2.7 parts by weight |
| Light diffusion particle | — |
| Solvent | MEK: 48.6 parts by weight |
| | Cyclohexanone: 5.4 parts by weight |
| Other | Silica sol: 2.7 parts by weight |

The compounds shown above are described below.
DPCA-20: Partially caprolactone-modified polyfunctional acrylate (produced by Nippon Kayaku Co., Ltd.)
Silica sol: MIBK-ST (produced by Nissan Chemical Industries, Ltd.)
IRGACURE 184: Polymerization initiator (produced by Ciba Specialty Chemicals Inc.)

### [Preparation of Coating Solutions for Low Refractive Index Layer (Ln-1) to (Ln-24)]

### 1. Preparation of Dispersion of Organic Conductive Compound

### Preparation Example 1

### Preparation of Dispersion of Organic Conductive Compound (A)

A mixture of 200 g of toluene, 2 g of aniline, 4.2 g of dodecylbenzenesulfonic acid, 1.0 g of polyacrylic acid derivative and 0.03 g of 4-methylaniline was dissolved to prepare a solution and 60 g of distilled water containing 3.58 ml of 6N hydrochloric acid dissolved was added thereto.

To the resulting mixture was added 180 mg of tetrabutylammonium bromide, the mixture was cooled to 5° C. or lower and then 30 g of distilled water containing 5.4 g of ammonium persulfate dissolved was added thereto. The mixture was subjected to oxidation polymerization at the state of 5° C. or lower for 4 hours and then toluene was removed by vacuum distillation.

The resulting polyaniline precipitate was collected by filtration and washed with water to obtain the desired polyaniline. The polyaniline was dispersed in 200 g of toluene, the aqueous layer was removed, and the concentration was adjusted to 2% by weight to obtain toluene dispersion (A). The organic conductive compound obtained is a compound in which dodecylbenzenesulfonic acid is doped in polyaniline. The specific dielectric constant of toluene of the solvent is 2.2.

### Preparation Example 2

### Preparation of Dispersion of Organic Conductive Compound (B)

Using 6,000 g of distilled water and 400 ml of 36% hydrochloric acid, 400 g of aniline was dissolved. To the resulting solution was added 500 g of a 5 mol/l aqueous sulfuric acid solution and the mixture was cooled to −5° C.

In a beaker, 980 g (4.295 mol) of ammonium peroxodisulfate was added to 2,293 g of distilled water and dissolved to prepare an aqueous solution of oxidizing agent. The aqueous ammonium peroxodisulfate solution was gradually added dropwise to the aqueous acidic solution of aniline with stirring while cooling at −5° C. to obtain blackish green precipitate. The resulting polymer precipitate was collected by filtration, washed with water and then with acetone and vacuum-dried at room temperature to obtain power of quinonediimine-phenylenediamine type conductive polyaniline. In 90 g of N-methyl-2-prrolidone was dissolved 1.49 g of phenylhydrazine and then was dissolved 10 g of the solvent-soluble quinonediimine-phenylenediamine type polyaniline with stirring. Separately, 5 g of 1,5-naphthalenedisulfonic acid tetrahydrate and 2.92 g of diethanolamine were dissolved in 58.92 g of N-methyl-2-prrolidone. With 5 g of the polyaniline solution was mixed 3.33 g of the solution of 1,5-naphthalenedisulfonic acid and the mixture was subjected to defoaming treatment. The solution was diluted so as to have a solvent composition of N-methyl-2-prrolidone and methyl ethyl ketone in a mixing ratio of 1:1 by weight to obtain polyaniline dispersion (B) having a solid content concentration of 4% by weight. The organic conductive compound obtained is a compound in which 1,5-naphthalenedisulfonic acid is doped in polyaniline. The average specific dielectric constant of the solvents is 23.8.

### Preparation Example 3

### Preparation of Dispersion of Organic Conductive Compound (C)

To 1,000 ml of a 2% by weight aqueous solution of polystyrenesulfonic acid having a molecular weight of about 100,000 (PS-5, produced by Tosoh Organic Chemical Co., Ltd.) was added 8.0 g of 3,4-ethylenedioxythiophene, followed by mixing at 20° C. To the mixed solution was added 100 ml of an oxidation catalyst solution (containing 15% by weight of ammonium persulfate and 4.0% by weight of ferric sulfate), the mixture was stirred at 20° C. for 3 hours to undergo reaction.

To the resulting reaction solution was added 1,000 ml of ion-exchanged water and then about 1,000 ml of the liquid was removed using an ultrafiltration method. These operations were repeated 3 times.

To the resulting solution were added 100 ml of an aqueous 10% by weight sulfuric acid solution and 1,000 ml of ion-exchanged water and then about 1,000 ml of the liquid was removed using an ultrafiltration method. To the resulting solution was added 1,000 ml of ion-exchanged water and then about 1,000 ml of the liquid was removed using an ultrafiltration method. These operations were repeated 5 times. Thus, about 1.1% by weight aqueous solution of PEDOT-PSS was obtained. The solid content concentration of the solution was adjusted with ion-exchanged water to make a 1.0% by weight aqueous solution, thereby preparing organic conductive polymer solution (C). The solution (C) is an aqueous solution and the dielectric constant of water is 80.

### Preparation Example 4

### Preparation of Acetone Solution of Organic Conductive Polymer (D)

To the 200 ml of the aqueous solution (C) of PEDOT-PSS prepared in Preparation Example 3 was added 200 ml of acetone and 210 ml of water and acetone was removed using an ultrafiltration method. These operations were repeated one more time and the solid content concentration was adjusted with acetone to prepare a 1.0% by weight water/acetone solution. To 200 ml of solution was added 500 ml of acetone containing 2.0 g of trioctylamine dissolved and the mixture was stirred by a stirrer for 3 hours. Using an ultrafiltration method, 510 ml of water and acetone was removed. The solid content concentration of the solution was adjusted with acetone to make a 1.0% by weight acetone solution, thereby preparing organic conductive polymer solution (D).

The water content of the solution was 2% by weight and the dielectric constant of the solvent was 22.7.

### Preparation Example 5

### Preparation of Methyl Ethyl Ketone Solution of Organic Conductive Polymer (E)

To the 200 ml of the solution (D) of PEDOT-PSS prepared in Preparation Example 4 was added 300 ml of methyl ethyl ketone and the mixture was concentrated under a reduced pressure at room temperature until the total volume became 200 ml. The solid content concentration of the solution was adjusted with methyl ethyl ketone to make a 1.0% by weight methyl ethyl ketone solution, thereby preparing organic conductive polymer solution (E). The water content of the solution was 0.05% by weight and the residual ratio of acetone was 1% by weight or less. The dielectric constant of the solvent was 15.5.

### 2. Synthesis of Fluorine-Containing Curable Compound

### 2-1: Synthesis of Compound F-1

Compound F-1 described hereinbefore as the specific example of the polyfunctional fluorine-containing monomer was synthesized according to a route shown below.

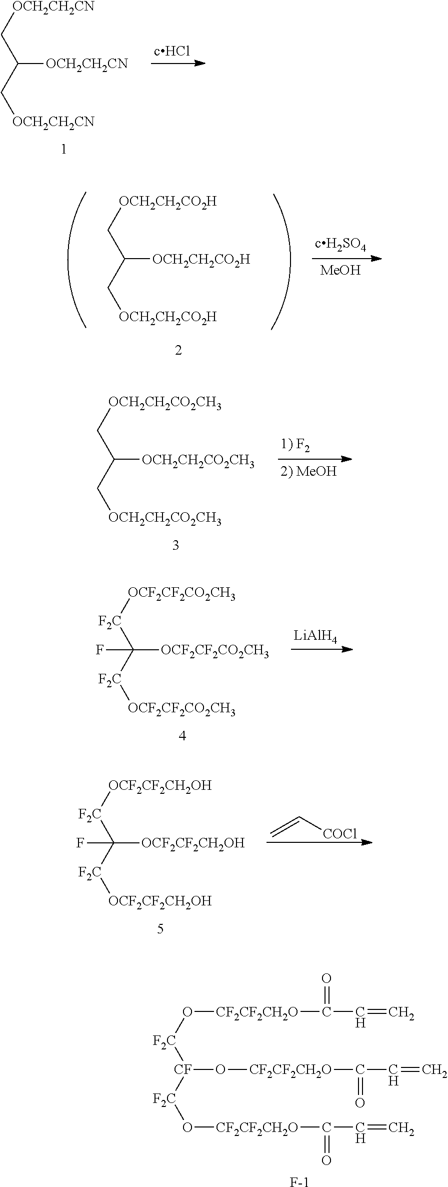

### (Synthesis of Compound 3)

To 110 ml of concentrated hydrochloric acid was dropwise added 4 ml of a methanol solution containing 36.6 g (145.6 mmol) of Compound 1 known in literature (for example, Journal of American Chemical Society, 70, 214 (1948)) at 50° C. over a period of one hour. The reaction solution was stirred at 65° C. for 6 hours, cooled to 35° C., and 80 ml of methanol was added thereto, followed by stirring at the temperature for 5 hours. The reaction solution was extracted with a mixture of 150 ml of toluene and 100 ml of a 10% by weight aqueous sodium chloride solution, and the organic layer was concentrated to obtain Compound 2. To the concentrated residue of Compound 2 were added 40 ml of methanol and one ml of concentrated sulfuric acid, and the mixture was stirred at room temperature for 4 hours. The reaction solution was extracted with a mixture of 150 ml of toluene and 150 ml of a 7.5% by weight aqueous sodium hydrogen carbonate solution, and the organic layer was washed with 150 ml of a 25% by weight aqueous sodium chloride solution and dried over sodium sulfate. The solvent was removed by distillation under a reduced pressure and the residue was purified by column chromatography (developing solvent: ethyl acetate/hexane=1/3) to obtain 40.8 g (116.5 mmol, yield of 80%) of Compound 3.

### (Synthesis of Compound 4)

In a 1-liter reaction vessel made of Teflon® equipped with a raw material inlet, a fluorine inlet, a helium gas inlet and air outlet which was connected to a fluorine trap through a reflux apparatus cooled with dry ice was charged 750 ml of a chlorofluorocarbon solvent. Helium gas was introduced at a flow rate of 100 ml/min into the reaction vessel at an inner temperature of 30° C. for 30 minutes. Sequentially, 20% by volume F₂/N₂ gas was introduced thereinto at a flow rate of 100 ml/min for 30 minutes. Then, the fluorine flow rate was controlled to 200 ml/min, and a mixed solution of 15 g (42.8 mmol) of Compound 3 and 4.0 ml of hexafluorobenzene was added at a rate of 1.1 ml/h. The fluorine flow rate was decreased to 100 ml/min, 1.2 ml of hexafluorobenzene was added at a rate of 0.6 ml/h, and 20% by volume F₂/N₂ gas was introduced thereinto at a flow rate of 100 ml/min for 15 minutes. After substituting the gas in the reaction vessel with helium gas, 100 ml of methanol was added to the reaction vessel, the mixture was stirred for one hour and the solvent was removed at a reduced pressure. The concentrated residue was washed with an ether/aqueous sodium hydrogen carbonate solution, and the ether layer was dried on magnesium sulfate. After distilling off the ether, the residue was purified by distillation at 2 mm Hg to obtain 17.4 g (26.5 mmol, yield of 62%) of Compound 4.

### (Synthesis of Compound 5)

In 300 ml of diethyl ether was dispersed 3.5 g of lithium aluminum hydride and 100 ml of a diethyl ether solution containing 10 g (15.2 mmol) of Compound 4 was dropwise added thereto at a temperature of 10° C. or lower. The reaction solution was stirred at a room temperature for 6 hours, and 100 ml of ethyl acetate was gradually added dropwise thereto. The solution was gradually poured into a mixture of diluted aqueous hydrochloric acid/ice/ethyl acetate and an insoluble material was removed by filtration. The organic layer was washed with water and then with an aqueous sodium chloride solution, dried on magnesium sulfate and concentrated under a reduced pressure. The residue was purified by column chromatography (developing solvent: ethyl acetate/hexane=1/1) to obtain 8.0 g (14.0 mmol, yield of 92%) of Compound 5 as a viscous oily product.

### (Synthesis of Compound F-1)

In 120 ml of acetonitrile solution containing 5.7 g (10 mmol) and 9.0 g of potassium carbonate was dropwise added 2.7 ml of acrylic chloride at a temperature of 10° C. or lower. After stirring the reaction mixture at a room temperature for 5 hours, 8 g of potassium carbonate and 2.5 ml of acrylic chloride were added thereto, followed by further stirring 20 hours. The reaction solution was poured into a mixture of 500 ml of ethyl acetate and 500 ml of diluted aqueous hydrochloric acid to separate. The organic layer was washed with an aqueous sodium hydrogen carbonate solution and then an aqueous sodium chloride solution and purified by column chromatography (developing solvent: ethyl acetate/hexane=1/3) to obtain 5.4 g (yield of 74%) of Compound F-1.

### 2-2: Synthesis of Compound P-11

In a 100 ml content stainless steel autoclave equipped with a stirrer were charged 40 ml of ethyl acetate, 14.7 g of hydroxyethyl vinyl ether and 0.55 g of dilauroyl peroxide. The inside of the system was degassed and replaced with nitrogen gas. Then, 25 g of hexafluoropropylene (HFP) was introduced into the autoclave and the temperature was raised to 65° C. The pressure when the temperature in the autoclave was reached to 65° C. was 0.53 MPa (5.4 kg/cm²). While maintaining the temperature, the reaction was continued for 8 hours and when the pressure was reached to 0.31 MPa (3.2 kg/cm²), the heating was terminated, followed by allowing to cool. After the inner temperature was dropped to a room temperature, the unreacted monomer was expelled and the autoclave was opened to take out the reaction solution. The reaction solution was poured in a large excess of hexane, and by removing the solvent by decantation, the precipitated polymer was obtained. The polymer was dissolved in a small amount of ethyl acetate, and reprecipitation was conducted twice from hexane to completely remove the remaining monomer. After drying, 28 g of a polymer was obtained. Subsequently, 20 g of the polymer was dissolved in 100 ml of N,N-dimethylacetamide, and 11.4 g of acrylic chloride was dropwise added thereto under ice cooling, followed by stirring at a room temperature for 12 hours. Ethyl acetate was added to the reaction solution, and the resulting solution was washed with water. The organic layer was extracted and then concentrated, and the resulting polymer was reprecipitated from hexane to obtain 19 g of perfluoroolefin copolymer (P-11). The refractive index, weight average molecular weight and Mw/Mn of the polymer were 1.422, 33,000 and 1.7, respectively.

### 3. Preparation of Inorganic Fine Particle Dispersion (Silica Dispersion A-2)

To 500 g of a hollow silica fine particle sol (isopropyl alcohol silica sol, average particle size: 60 nm, thickness of shell: 10 nm, silica concentration: 20% by weight, refractive index of silica particle: 1.31, prepared according to Preparation Example 4 of JP-A-2002-79616, provided that the size was changed) were added 10 g of acryloyloxypropyltrimethoxysilane (produced by Shin-Etsu Chemical Co., Ltd.) and 1.0 g of diisopropoxyaluminum ethyl acetate to mix, and then 3 g of ion-exchanged water was added thereto. After reacting at 60° C. for 8 hours, the reaction solution was cooled to a room temperature, and 1.0 g of acetyl acetone was added thereto. While adding cyclohexanone to 500 g of the resulting dispersion so as to maintain the silica content almost constant, solvent replacement by reduced-pressure distillation was performed. The occurrence of a foreign material was not observed in the dispersion. The viscosity was 5 mPa·s, when the solid content concentration was controlled to 22% by weight with cyclohexanone. The remaining amount of isopropyl alcohol in Dispersion A-2 was analyzed by gas chromatography and found to be 1.0% by weight.

### 4. Preparation of Composition for Low Refractive Index Layer

Each of the components was mixed as shown in Table 4 and diluted with the solvent as shown in the following Table to prepare a coating solution for low refractive index layer having a solid content of 3.0% by weight. In Table 4, the amount of each component added is indicated by “part by weight”. Although Coating solutions Ln-2 to Ln-24 exhibited good solubility, Coating solution Ln-1 exhibited poor solubility and was not suitable for coating.

| | TABLE | | | | | | | |
|---|---|---|---|---|---|---|---|---|
| | Composition for low refractive index layer (solid content) | | | | | | | |
| | Fluorine-Containing | | Organic Conductive | | Polyfunctional | | Antifouling | |
| | Curable compound | | Compound | | Monomer | | Agent | |
| | Kind | Amount | Kind | Amount | Kind | Amount | Kind | Amount |
| Ln-1 | P-13 | 77 | (C) | 20 | — | 0 | — | 0 |
| Ln-2 | — | 0 | (A) | 20 | DPHA | 77 | — | 0 |
| Ln-3 | — | 0 | (A) | 10 | DPHA | 87 | — | 0 |
| Ln-4 | — | 0 | (A) | 30 | DPHA | 67 | — | 0 |
| Ln-5 | — | 0 | (A) | 65 | DPHA | 32 | — | 0 |
| Ln-6 | — | 0 | (A) | 20 | Compound | 80 | — | 0 |
| | | | | | (T) | | | |
| Ln-7 | P-13 | 77 | (A) | 20 | — | 0 | — | 0 |
| Ln-8 | P-13 | 67 | (A) | 20 | DPHA | 10 | — | 0 |
| Ln-9 | P-13 | 82 | (A) | 5 | DPHA | 10 | — | 0 |
| Ln-10 | P-13 | 77 | (A) | 10 | DPHA | 10 | — | 0 |
| Ln-11 | P-13 | 57 | (A) | 30 | DPHA | 10 | — | 0 |
| Ln-12 | P-13 | 67 | Quaternary | 20 | DPHA | 10 | — | 0 |
| | | | Ammonium | | | | | |
| | | | Salt | | | | | |
| | | | (PQ-10) | | | | | |
| Ln-13 | P-13 | 67 | (B) | 20 | DPHA | 10 | — | 0 |
| Ln-14 | P-13 | 67 | (D) | 20 | DPHA | 10 | — | 0 |
| Ln-15 | P-13 | 67 | (D) | 20 | DPHA | 6 | — | 0 |
| | | | | | HEAA | 4 | | |
| Ln-16 | F-1 | 67 | (A) | 20 | DPHA | 10 | — | 0 |
| Ln-17 | F-30 | 62 | (A) | 20 | DPHA | 15 | — | 0 |
| Ln-18 | P-13 | 40 | (A) | 20 | DPHA | 10 | — | 0 |
| | F-1 | 27 | | | | | | |
| Ln-19 | P-11 | 67 | (A) | 20 | DPHA | 10 | — | 0 |
| Ln-20 | P-16 | 67 | (A) | 20 | DPHA | 10 | — | 0 |
| Ln-21 | P-16 | 40 | (E) | 20 | DPHA | 10 | — | 0 |
| | F-1 | 27 | | | | | | |
| Ln-22 | P-13 | 40 | (E) | 20 | DPHA | 10 | — | 0 |
| | F-1 | 27 | | | | | | |
| Ln-23 | P-13 | 35 | (E) | 20 | DPHA | 10 | MF1 | 5 |
| | F-1 | 27 | | | | | | |
| Ln-24 | P-13 | 20 | (E) | 20 | DPHA | 10 | MF1 | 5 |
| | F-1 | 12 | | | | | | |

| | Composition for low refractive | | | | |
|---|---|---|---|---|---|
| | index layer (solid content) | | | | |
| | Polymerization | | | | |
| | Initiator | Inorganic | | | |
| | (IRGACURE-127) | Particle | | | |
| | Amount | Kind | Amount | Solvent for Dilution | Remarks |
| Ln-1 | 3 | — | 0 | MEK(85) | Comparative |
| | | | | Cyclohexanone(15) | Example |
| Ln-2 | 3 | — | 0 | Toluene(85) | Comparative |
| | | | | Cyclohexanone(15) | Example |
| Ln-3 | 3 | — | 0 | Toluene(85) | Comparative |
| | | | | Cyclohexanone(15) | Example |
| Ln-4 | 3 | — | 0 | Toluene(85) | Comparative |
| | | | | Cyclohexanone(15) | Example |
| Ln-5 | 3 | — | 0 | Toluene(85) | Comparative |
| | | | | Cyclohexanone(15) | Example |
| Ln-6 | 0 | — | 0 | Toluene(85) | Comparative |
| | | | | IPA(15) | Example |
| Ln-7 | 3 | — | 0 | Toluene(85) | Example |
| | | | | Cyclohexanone(15) | |
| Ln-8 | 3 | — | 0 | Toluene(85) | Example |
| | | | | Cyclohexanone(15) | |
| Ln-9 | 3 | — | 0 | Toluene(85) | Comparative |
| | | | | Cyclohexanone(15) | Example |
| Ln-10 | 3 | — | 0 | Toluene(85) | Example |
| | | | | Cyclohexanone(15) | |
| Ln-11 | 3 | — | 0 | Toluene(85) | Example |
| | | | | Cyclohexanone(15) | |
| Ln-12 | 3 | — | 0 | MEK(85) | Example |
| | | | | Cyclohexanone(15) | |
| Ln-13 | 3 | — | 0 | MEK(85) | Example |
| | | | | Cyclohexanone(15) | |
| Ln-14 | 3 | — | 0 | MEK(80) | Example |
| | | | | PEGMEA(20) | |
| Ln-15 | 3 | — | 0 | MEK(80) | Example |
| | | | | PEGMEA(20) | |
| Ln-16 | 3 | — | 0 | Toluene(85) | Example |
| | | | | Cyclohexanone(15) | |
| Ln-17 | 3 | — | 0 | Toluene(85) | Example |
| | | | | Cyclohexanone(15) | |
| Ln-18 | 3 | — | 0 | Toluene(85) | Example |
| | | | | Cyclohexanone(15) | |
| Ln-19 | 3 | — | 0 | Toluene(85) | Example |
| | | | | Cyclohexanone(15) | |
| Ln-20 | 3 | — | 0 | Toluene(85) | Example |
| | | | | Cyclohexanone(15) | |
| Ln-21 | 3 | — | 0 | MEK(80) | Example |
| | | | | PEGMEA(20) | |
| Ln-22 | 3 | — | 0 | MEK(80) | Example |
| | | | | PEGMEA(20) | |
| Ln-23 | 3 | — | 0 | MEK(80) | Example |
| | | | | PEGMEA(20) | |
| Ln-24 | 3 | A-2 | 30 | MEK(80) | Example |
| | | | | PEGMEA(20) | |

The compounds shown in Table 4 are described below.
PQ-10: Polymer type cationic antistatic agent (quaternary ammonium salt-containing acrylic resin, produced by Soken Chemical & Engineering Co., Ltd.)
DPHA: Mixture of dipentaerythritol pentaacrylate and dipentaerythritol hexaacrylate (produced by Nippon Kayaku Co., Ltd.)
HEAA: 2-Hydroxyethylacrylamide (produced by Kohjin Co., Ltd.)
IRGACURE-127: Photopolymerization initiator (produced by Ciba Specialty Chemicals Inc.)
MF1: Fluorine-containing unsaturated compound a-1 shown below.

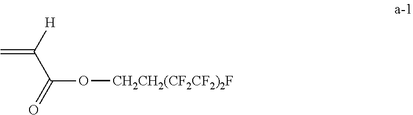

Dispersion A-2: Hollow silica fine particle dispersion (solid content ratio: 22% by weight)
Compound (T): Composition prepared by mixing 72 parts by weight of tetraethoxysilane (produced by Shin-Etsu Chemical Co., Ltd.), 5 parts by weight of perfluorooctylethyltriethoxysilane (produced by Dow Corning Toray Co., Ltd.) and 3 parts by weight of HNO₃.
MEK: Methyl ethyl ketone
PGMEA: Propylene glycol monomethyl ether acetate
P-11, P-13, P-16, F-1 and F-30: Fluorine—containing curable compound P-11, P-13, P-16, F-1 and F-30 described hereinbefore, respectively.

### Example 1

### [Production of Antireflective Film]

### (Formation of Hardcoat Layer)

On a triacetyl cellulose film (TAC-TD80U, produced by FUJIFILM Corp.) having a thickness of 80 μm and a width of 1,340 mm, Coating solution for hardcoat layer (HC-1) was coated by a die coater under a condition of transportation speed of 30 m/min and dried at 60° C. for 150 seconds, and the coated layer was cured by irradiating an ultraviolet ray at an illuminance of 400 mW/cm² and an irradiation dose of 150 mJ/cm² using an air-cooled metal halide lamp (produced by Eye Graphics Co., Ltd.) of 160 W/cm while purging the system with nitrogen (oxygen concentration of 0.5% or less), thereby forming a hardcoat layer having a thickness after curing of 6 μm.

(Formation of Low Refractive Index Layer)

On the hardcoat layer, the coating solution for low refractive index layer (any one of Ln-1 to LN-24) described above was coated by a die coater so as to control that a thickness of the low refractive index layer after curing is 100 nm and cured under the curing conditions shown below to form a low refractive index layer. Thus, Antireflective Film Sample Nos. 101 to 124 were prepared, respectively.

The curing conditions in the formation of low refractive index layer are shown below.
(1) Drying: at 80° C. for 120 seconds.
(2) Heat treatment before irradiation: at 95° C. for 30 seconds.
(3) UV curing: at 90° C. for one minute, at an illuminance of 120 mW/cm² and an irradiation dose of 240 mJ/cm² using an air-cooled metal halide lamp (produced by Eye Graphics Co., Ltd.) of 240 W/cm while purging the system with nitrogen so as to give an atmosphere having an oxygen concentration of 0.01% by volume or less.

### (4) Heat Treatment After Irradiation: at 30° C. for 5 Minutes.

### [Dope Treatment]

A 5% by weight of ethanol solution of p-benzoquinone and a 20% by weight aqueous solution of 1,5-dinaphthalenedisulfonic acid tetrahydrate were prepared. These solutions were mixed in an equal weight ratio to prepare a dope solution.

Into the dope solution, Antireflective Film Sample No. 113 for Example 1 was immersed at a room temperature for 10 minutes, washed with ethanol and dried at 60° C. for 20 minutes to perform the dope treatment.

### [Saponification Treatment of Antireflective Film]

The surface of the low refractive index layer side of the antireflective film sample thus-obtained was laminated to protect and the rare surface thereof was subjected to the saponification treatment in the manner shown below.

A 1.5 mol/l of aqueous sodium hydroxide solution was prepared and maintained at 55° C. A 0.005 mol/l of aqueous diluted sulfuric acid solution was prepared and maintained at 35° C. The antireflective film sample was immersed in the aqueous sodium hydroxide solution for 2 minutes and then immersed in water to thoroughly wash for removing the aqueous sodium hydroxide solution. Then, the antireflective film sample was immersed in the diluted sulfuric acid solution for one minute and then immersed in water to thoroughly wash for removing the diluted sulfuric acid solution. Finally, the antireflective film sample was dried at 120° C. for 3 minutes to prepare an antireflective film subjected to the saponification treatment.

### [Evaluation of Laminate]

With the laminate (antireflective film) obtained, the evaluations and determinations of the items shown below were conducted.

### (Evaluation 1) Determination of Uneven Distribution of Organic Conductive Material

The antireflective film was obliquely cut at an angle of 0.05° by a microtome and the cut section of the coated layer obtained was analyzed by TOF-SIMS method to measure the distribution of the organic conductive compound in the layer thickness direction.

Then, the lower part uneven distribution ratio was calculated according to the formula shown below.

Lower part uneven distribution ratio=[weight of the organic conductive compound present in a region from a center to a surface of the layer on the support side in the layer thickness direction of the low refractive index layer]/[total weight of the organic conductive compound present in the whole low refractive index layer]×100 (%)

The measurement by TOF-SIMS method was performed using the apparatus described below.

Apparatus: TRIFT II, produced by Physical Electronics (PHI) Inc.

The lower part uneven distribution ratio according to the invention is necessary to be from 55 to 100 percent.

### (Evaluation 2) Determination of Average Integrated Reflectance

The antireflective film was pasted on polarizing plates of cross Nicol and a spectral reflectance at an incident angle of 5° in a wavelength range of 380 to 780 nm was measured using a spectrophotometer (produced by JASCO Corp.). The integrating sphere average reflectance (%) in a wavelength range of 450 to 650 was used for the result. In the respective functional layers having same refractive index and layer thickness, when the affinity between the functional layers is poor, microscopic unevenness is generated and as a result, the integrated reflectance increases.

### (Evaluation 3) Evaluation of Antifouling Property by a Wiping Test of Magic Marker

The antireflective film was fixed on a glass surface with an adhesive, and a circle of 5 mm in diameter was drawn thereon in three turns with a pen tip (fine) of a black magic marker, “Macky Gokuboso (Macky Superfine)” (produced by ZEBRA Co., Ltd.), under the conditions of 25° C. and 60% RH. After 5 seconds, the surface of the antireflective film was wiped off with a 10-ply folded and bundled BEMCOT (produced by Asahi Kasei Fibers Corp.) by moving the bundle back and forth 20 times under a load large enough to make a dent in the BEMCOT bundle. The drawing and wiping were repeated under the above-described conditions until the magic marker stain could not be eliminated by the wiping, and the number of repetitions taken to wipe off the magic marker stain was measured to evaluate the antifouling property. The number of repetitions taken to wipe off the magic marker stain was measured up to an upper limit of 50 times. The number of repetitions until the magic marker stain cannot be eliminated is preferably 5 or more, more preferably 10 or more, and particularly preferably 15 or more.

### (Evaluation 4) Evaluation of Scratch Resistance

A rubbing test was conducted using a rubbing tester under the conditions shown below.
Environmental conditions for evaluation: 25° C., 60% RH
Rubbing material: Steel wool (Grade No. 0000, produced by Nihon Steel Wool Co., Ltd.) was wound on the rubbing tip (1 cm×1 cm) of the tester which would come into contact with the sample and fixed with a band not to move.
Moving distance (one way): 13 cm
Rubbing speed: 13 cm/sec
Load: 500 g/cm²
Contact area of the tip: 1 cm×1 cm
Number of times of rubbing: 10 reciprocations

To the rear side of the sample of antireflective film after the rubbing was applied oil-based black ink and the scratch mark in the rubbed portion was visually observed with reflection light and evaluated according to the criteria shown below.
A: No scratch mark was found even when observed extremely carefully.
AB: Slight weak scratch mark was found when observed extremely carefully.
B: Weak scratch mark was found.
BC: Scratch mark of medium degree was found.
C: Scratch mark was found at a glance.

In the evaluation of the scratch resistance, the criteria of A and AB are of high practical value.

### (Evaluation 5) Evaluation of Adhesion Property

The antireflective film sample was maintained under the conditions of 25° C. and 60% RH for 2 hours to conduct humidity conditioning. The surface of the film sample on the low refractive index layer side was notched in a grid-like pattern with 11 vertical lines and 11 horizontal lines, thereby forming 100 squares in total. A polyester adhesive tape (No. 31B, produced by Nitto Denko Corp.) was attached onto the surface of the film sample. After lapse of 30 minutes, the polyester adhesive tape was rapidly peeled off in the vertical direction from the film sample. A number of squares peeled off was counted on the film sample and evaluated according to the criteria shown below. The procedures for evaluating the adhesion property described above were repeated three times and an average value thereof was determined.
A: No peeling off was recognized at all in the 100 squares.
B: Peeling off of one or two squares was recognized in the 100 squares.
C: Peeling off of 3 to 10 squares was recognized in the 100 squares (within an acceptable range).
D: Peeling off of 11 or more squares was recognized in the 100 squares.

### (Evaluation 6) Evaluation of Surface Resistance

The surface resistance of the antireflective film on the low refractive index layer (outermost layer) side thereof was measured using an ultra-insulation resistance/micro ammeter (TR-8601, produced by Advantest Corp.) under the conditions of 25° C. and 60% RH. The result was indicated by a common logarithm value log (SR) of the surface resistivity.

The log (SR) of the laminate according to the invention is 13.0 or less.

### (Evaluation 7) Evaluation of Dust Resistance

The transparent support side of the antireflective film sample was laminated on a CRT surface and the laminate was used for 24 hours in a room having from 100 to 2,000,000 particles of dust of 0.5 μm or more and tissue paper scraps per 1 ft³ (cubic feet). The number of particles of dust and the number of the tissue paper scrapes attached per 100 cm² of the antireflective film were measured and the average value thereof was determined and evaluated according to the criteria shown below.
A: Less than 20 pieces.
B: From 20 to 49 pieces.
C: From 50 to 199 pieces.
D: 200 or more pieces.

In the evaluation of the dust resistance, the criteria of A and B are of high practical value.

### (Evaluation 8) Visual Evaluation of Optical Surface State

The antireflective film was subjected to (1) transmission surface state test under a three-wavelength florescent lamp. Also, after applying oil-based black ink on the side of the antireflective film opposite to the functional layer coated side, it was subjected to reflection surface state test under a three-wavelength florescent lamp. From these results, uniformity of the surface state (absence of unevenness, for example, unevenness due to wind, drying unevenness or coating streaks unevenness) was totally evaluated in detail according to the criteria shown below.
1: Surface state was extremely bad.
2: Surface state was insufficient.
3: Further improvement in surface state was required.
4: Surface state was fairly good.
5: Surface state was extremely good.

The results obtained are shown in the table below.

TABLE

| | | Performances | | | | | | | | |
|---|---|---|---|---|---|---|---|---|---|---|
| | Composition | | | | | Lower Part | | | | |
| | for Low | | | | | Uneven | | | Optical | |
| Sample | Refractive | Integrated | Antifouling | Scratch | Adhesion | Distribution | Surface | Dust | Surface | |
| No. | Index Layer | Reflectance | Property | Resistance | Property | Ratio | Resistance | Resistance | State | Remarks |
| 101 | Ln-1 | — | — | — | — | — | — | — | — | Comparative |
| | | | | | | | | | | Example |
| 102 | Ln-2 | 4.5 | 0 | A | A | 50 | 14.0 | C | 2 | Comparative |
| | | | | | | | | | | Example |
| 103 | Ln-3 | 4.5 | 0 | A | A | 50 | 14.2 | C | 2 | Comparative |
| | | | | | | | | | | Example |
| 104 | Ln-4 | 4.6 | 0 | AB | B | 50 | 13.8 | C | 2 | Comparative |
| | | | | | | | | | | Example |
| 105 | Ln-5 | 4.6 | 0 | C | D | 50 | 11.5 | B | 1 | Comparative |
| | | | | | | | | | | Example |
| 106 | Ln-6 | 4.5 | 0 | C | D | 50 | 14.0 | C | 1 | Comparative |
| | | | | | | | | | | Example |
| 107 | Ln-7 | 3.0 | 3 | AB | C | 55 | 12.5 | B | 4 | Example |
| 108 | Ln-8 | 3.1 | 3 | AB | B | 63 | 12.0 | B | 4 | Example |
| 109 | Ln-9 | 3.0 | 3 | A | A | 52 | 13.8 | D | 4 | Comparative |
| | | | | | | | | | | Example |
| 110 | Ln-10 | 3.0 | 3 | A | A | 65 | 12.2 | B | 4 | Example |
| 111 | Ln-11 | 3.2 | 3 | AB | B | 61 | 11.8 | A | 4 | Example |
| 112 | Ln-12 | 3.1 | 3 | AB | B | 65 | 12.3 | A | 4 | Example |
| 113 | Ln-13 | 3.1 | 3 | AB | B | 65 | 12.1 | A | 4 | Example |
| 114 | Ln-14 | 3.1 | 3 | AB | B | 70 | 10.5 | A | 4 | Example |
| 115 | Ln-15 | 3.1 | 3 | A | A | 76 | 10.0 | A | 4 | Example |
| 116 | Ln-16 | 3.0 | 5 | AB | B | 60 | 12.2 | A | 4 | Example |
| 117 | Ln-17 | 3.2 | 5 | AB | B | 60 | 12.2 | A | 4 | Example |
| 118 | Ln-18 | 3.0 | 5 | A | B | 65 | 11.7 | A | 5 | Example |
| 119 | Ln-19 | 3.1 | 3 | AB | B | 60 | 12.5 | A | 4 | Example |
| 120 | Ln-20 | 3.1 | 7 | A | B | 87 | 11.7 | A | 5 | Example |
| 121 | Ln-21 | 3.1 | 7 | A | B | 85 | 10.0 | A | 5 | Example |
| 122 | Ln-22 | 3.1 | 5 | A | B | 85 | 10.0 | A | 5 | Example |
| 123 | Ln-23 | 3.1 | 15 | A | A | 95 | 9.7 | A | 5 | Example |
| 124 | Ln-24 | 1.9 | 18 | A | B | 85 | 10.0 | A | 5 | Example |

As show in the table above, when the same amount of the organic conductive compound is used, the antireflective films (Samples 108, 110 and 111) of the example according to the invention in which the lower part uneven distribution of the organic conductive compound is formed exhibit the reduced surface resistance, have the excellent dust resistance, and exhibit the excellent surface state free from streak or unevenness, scratch resistance and adhesion property in comparison with the antireflective films in which the organic conductive compound is present in the whole layer as in Samples 102 to 106.

Further, the improvements in the adhesion property and scratch resistance are recognized when the non-fluorine-containing polyfunctional monomer is used together (comparison of Sample 107 with Sample 108, 114 or 115). Moreover, when a functional group having high polarity or a polysiloxane structure is introduced into the molecule of the fluorine-containing curable polymer, the lower part uneven distribution ratio of the organic conductive polymer increases and thus, not only the reduction of the surface resistance and the improvement in the dust resistance but also the improvements in the adhesion property and surface state are achieved (comparison of Sample 108 with Sample 118 or 119). Furthermore, when the fluorine-based antifouling agent is used together, the lower part uneven distribution ratio of the organic conductive compound proceeds, resulting in the reduction of the surface resistance and the improvement in the adhesion property, in addition to the improvement in the antifouling property (comparison of Sample 122 with Sample 123).

### Example 2

Samples 201 to 212 were prepared in the same manner as in Sample 111 or 123, expect for changing the thickness of the low refractive index layer to those shown in the table below, respectively. The evaluations were performed according to Example 1. The results obtained are shown in the table below.

TABLE

| | | | | Performances | | | | | | | | |
|---|---|---|---|---|---|---|---|---|---|---|---|---|
| | | | | | | | | Lower Part | | | | |
| | Low Refractive Index | | | | | | | Uneven | | | Optical | |
| Sample | Layer | | | Integrated | Antifouling | Scratch | Adhesion | Distribution | Surface | Dust | Surface | |
| No. | Composition | Thickness | | Reflectance | Property | Resistance | Property | Ratio | Resistance | Resistance | State | Remarks |
| 201 | Ln-11 | 15 | nm | 4.4 | 1 | C | C | 50 | 13.5 | D | 1 | Comparative |
| | | | | | | | | | | | | Example |
| 202 | Ln-11 | 40 | nm | 3.9 | 3 | AB | B | 58 | 12.2 | A | 4 | Example |
| 203 | Ln-11 | 105 | nm | 3.2 | 3 | AB | B | 61 | 11.8 | A | 4 | Example |
| 204 | Ln-11 | 300 | nm | 3.5 | 3 | A | B | 65 | 11.6 | A | 4 | Example |
| 205 | Ln-11 | 4 | μm | 3.6 | 3 | AB | B | 60 | 12.2 | B | 4 | Example |
| 206 | Ln-11 | 8 | μm | 3.6 | 3 | AB | B | 60 | 13.1 | C | 2 | Comparative |
| | | | | | | | | | | | | Example |
| 207 | Ln-23 | 70 | nm | 3.4 | 15 | A | A | 92 | 9.9 | A | 5 | Example |
| 208 | Ln-23 | 105 | nm | 3.0 | 15 | A | A | 95 | 9.7 | A | 5 | Example |
| 209 | Ln-23 | 140 | nm | 2.7 | 18 | A | A | 95 | 9.2 | A | 5 | Example |
| 210 | Ln-23 | 380 | nm | 3.1 | 20 | A | A | 95 | 8.7 | A | 5 | Example |
| 211 | Ln-23 | 690 | nm | 3.5 | 20 | A | B | 95 | 8.7 | A | 5 | Example |
| 212 | Ln-11 | 20 | nm | 4.1 | 3 | AB | B | 56 | 12.5 | B | 4 | Example |

As show in the table above, when the layer thickness of the low refractive index layer is controlled in a range of 20 nm to 5 μm, the antireflective films having the good surface state and low surface resistance are obtained. It is also found that when the layer thickness of the low refractive index layer deviates from the range of 20 nm to 5 μm, the thickness of the upper part of the low refractive index layer in which the fluorine-containing curable compound having a high insulating property is present in a large amount in comparison with the lower part of the low refractive index layer increases to much and as a result, the surface resistance rather increases (see Samples 201 to 206 and 212).

Further, it can be seen that there is the region excellent in the surface resistance and reflectance in the antireflective film samples in which the lower part uneven distribution is formed to a larger extent when the low refractive index layer is designed to have a thickness larger than about 100 nm, which is a ordinary thickness in the case of a system of pseudo-two-layers having different refractive indexes (see Samples 207 to 211).

### Example 3

Samples 301 to 309 were prepared in the same manner as in Sample 114 in Example 1, excepting that Coating solution for hardcoat layer (HC-1) was changed to Coating solution for hardcoat layer (HC-2) shown below, that the thickness of the hardcoat layer after curing was changed to 12 μm, and that the kind and amount (part by weight) of the polymerization initiator in the low refractive index layer to those shown below, respectively. The scratch resistance and adhesion property of each sample were evaluated according to Example 1. The results obtained are shown in the table below.

Coating Solution for Hardcoat Layer (HC-2)

| | |
|---|---|
| Binder | PET-30: 22.9 parts by weight |
| | BISCOAT 360: 22.9 parts by weight |
| Polymerization initiator | IRGACURE 127: 1.5 parts by weight |
| Light diffusion particle | 8 μm Crosslinked acryl/styrene particle |
| | (30% MIBK dispersion): 10 parts by weight |
| Solvent | MIBK: 19.2 parts by weight |
| | MEK: 25 parts by weight |

TABLE

| | | | Performances | | |
|---|---|---|---|---|---|
| Sample | Polymerization Initiator | | Scratch | Adhesion | |
| No. | Kind | Amount | Resistance | Property | Remarks |
| 301 | IRGACURE 127 | 3 | AB | B | Invention |
| 302 | Fluorine-Containing Initiator | 3 | A | C | Invention |
| 303 | IC-1 | 3 | AB | A | Invention |
| 304 | IRGACURE 2959 | 3 | AB | A | Invention |
| 305 | IC-6 | 3 | AB | A | Invention |
| 306 | Fluorine-Containing Initiator/IC-1 | 1.5/1.5 | A | A | Invention |
| 307 | Fluorine-Containing | 1.5/1.5 | A | A | Invention |
| | Initiator/IRGACURE 2959 | | | | |
| 308 | IRGACURE 127/IC-1 | 2/1 | A | A | Invention |
| 309 | IRGACURE 127/IC-6 | 2/1 | A | A | Invention |

The compounds shown in the table above are described below.
PET-30: Mixture of pentaerythritol triacrylate and pentaerythritol tetraacrylate (produced by Nippon Kayaku Co., Ltd.)
BISCOAT 360: Trimethylolpropane PO-modified triacrylate (produced by Osaka Organic Chemical Industry Ltd.)
8 μm Crosslinked acryl/styrene particle (30%): A dispersion in MIBK obtained by dispersing crosslinked acryl/styrene particles having an average particle size of 8.0 μm (produced by Sekisui Chemical Co., Ltd.) by a polytron disperser at 10,000 rpm for 20 minutes
IRGACURE 127: Photopolymerization initiator (produced by Ciba Specialty Chemicals Inc.)
Fluorine-containing initiator: Compound 1 described in JP-A-2007-11309, a fluoroalkyl group-containing polymerization initiator
IC-1: Chlorotriazine type polymerization initiator IC-1 described in JP-A-2007-168249 (SP value: 29.1)
IC-6: Quaternary ammonium cation moiety-containing polymerization initiator IC-6 described in JP-A-2007-168249 (SP value: 20 or more)
IRGACURE 2959: Photopolymerization initiator having two hydroxy groups in its molecule (produced by Ciba Specialty Chemicals Inc.)

From the results shown in the table above it can be seen that the improvements in both performances of the scratch resistance and adhesion property can be achieved by using a fluorine-containing polymerization initiator which is apt to be unevenly distributed in the upper part together with a polymerization initiator which is apt to be unevenly distributed in the lower part or other polymerization initiator (comparison of Samples 301 to 305 with Samples 306 to 309).

### Example 4

A composition for hardcoat layer shown below was prepared.

| | | HC-3 | HC-4 | HC-5 | HC-6 | HC-7 | HC-8 |
|---|---|---|---|---|---|---|---|
| Binder | Trimethylol- | 45 | 25 | 38 | 38 | 40 | 40 |
| | propane | | | | | | |
| | triacrylate | | | | | | |
| | Penta- | — | 20 | — | — | — | — |
| | erythritol | | | | | | |
| | triacrylate | | | | | | |
| | M-5300 | — | — | 7 | — | — | — |
| | KBM-5103 | — | — | — | 7 | — | — |
| | HEAA | — | — | — | — | 7 | — |
| Inorganic | MEK-ST | — | — | — | — | — | 5 |
| Filler | | | | | | | |
| Polymeri- | IRGACURE | 2.5 | 2.5 | 2.5 | 2.5 | 2.5 | 2.5 |
| zation | 184 | | | | | | |
| Initiator | | | | | | | |
| Solvent | MEK | 47 | 47 | 47 | 47 | 47 | 47 |
| | Cyclohexanone | 5.5 | 5.5 | 5.5 | 5.5 | 5.5 | 5.5 |

In the table above, the numerical values denote the amount of respective components indicated by “part by weight”. The compounds shown in the table above are described below.
M-5300: ARONICS M-5300 (produced by Toagosei Co., Ltd.) ω-carboxy-polycaprolactone monoacrylate (n≈2)
KBM-5103: KBM-5103 (produced by Shin-Etsu Chemical Co., Ltd.) 3-acryloxypropyltrimethoxysilane
KEK-ST: Organosilica sol (30% by weight MEK dispersion) silica of about 5 to 10 nm
IRGACURE 184: Photopolymerization initiator (produced by Ciba Specialty Chemicals Inc.)

Samples 401 to 407 were prepared in the same manner as in Sample 114 of Example 1 except for changing the base material for coating the composition containing component (A) and component (B) according to the invention to those shown in the table below, respectively. The evaluations of performances were performed according to Example 1. The results obtained are shown in the table below.

TABLE

| | | Performances | | | | |
|---|---|---|---|---|---|---|
| | | | | Lower Part | | |
| | Base Material | | | Uneven | | |
| Sample | Support/Composition | Scratch | Adhesion | Distribution | Surface | |
| No. | for Hardcoat Layer | Resistance | Property | Ratio | Resistance | Remarks |
| 401 | TAC/HC-3 | AB | B | 65 | 10.8 | Example |
| 402 | TAC/HC-4 | AB | B | 68 | 10.6 | Example |
| 403 | TAC/HC-5 | AB | A | 70 | 10.5 | Example |
| 404 | TAC/HC-6 | AB | A | 70 | 10.5 | Example |
| 405 | TAC/HC-7 | AB | A | 72 | 10.2 | Example |
| 406 | TAC/HC-8 | AB | B | 70 | 10.5 | Example |
| 407 | Glass/— | A | A | 78 | 9.9 | Example |

From the results shown in the table above it can be seen that when the binder or filler containing a hydroxy group, a carboxyl group, a silanol group or an amido group is used as the base material which comes directly into contact with the composition containing component (A) and component (B) according to the invention, the adhesion property is increased, the lower part uneven distribution ratio of the organic conductive compound is increased, and the surface resistance is decreased (comparison of Sample 401 with Samples 402 to 406). Further, in the case where a glass plate (ordinarily having hydroxy groups on its surface) is directly used as the base material without using a hardcoat layer, the laminate which is excellent in the scratch resistance and adhesion property and has the high lower part uneven distribution ratio and low surface resistance is also obtained.

### Example 5

### [Evaluation Using Liquid Crystal Display Device]

### (Preparation of Polarizing Plate)

A triacetyl cellulose film (TAC-TD80U, produced by FUJIFILM Corp.) having a thickness of 80 μm which had been substituted to immersion treatment with a 1.5 mol/l aqueous sodium hydroxide solution at 55° C. for 2 minutes, neutralization and washing with water and each of the antireflective films subjected to the saponification treatment of Examples and Comparative Examples were adhered to the both surfaces of a polarizer prepared by adsorbing iodine to polyvinyl alcohol and stretching, in order to protect the both surfaces, thereby preparing a polarizing plate.

### (Preparation of Liquid Crystal Display Device)

A polarizing plate provided in a VA-mode liquid crystal display device (LC-37GS10, produced by Sharp Corp.) was peeled and instead, the polarizing plate prepared above was attached thereon so that the transmission axes correspond to those of polarizing plate provided in the device to prepare a liquid crystal display device having each of the anti-reflective films obtained in Examples and Comparative Examples. The polarizing plate was attached so as to be arranged the anti-reflective film on the viewing side.

The polarizing plate and image display device thus prepared using any of the anti-reflective films in Examples exhibited the excellent surface state free form streak or unevenness, scratch resistance, antifouling property, dust resistance and adhesion property similar to those of the anti-reflective films attached in comparison with those prepared using any of the anti-reflective films in Comparative Examples. Further, the image display device exhibited very high display quality with very few formation of reflected glare image and was excellent in antifouling property.

1. A laminate comprising a support and a layer formed from a composition containing at least (A) an organic conductive compound and (B) a fluorine-containing curable compound, wherein a common logarithm value (log SR) of surface resistivity SR (a/sq) of a surface of the laminate on the layer side is 13.0 or less, and a lower part uneven distribution ratio of the organic conductive compound (A) in the layer defined by the following formula is from 55 to 100 percent:
Lower part uneven distribution ratio=[weight of the component (A) present in a region from a center to a surface of the layer on the support side in a layer thickness direction of the layer formed from the composition containing at least the component (A) and the component (B)]/[total weight of the component (A) present in the whole layer formed from the composition containing at least the component (A) and the component (B)]×100 (%).

2. The laminate as claimed in claim 1, wherein the organic conductive compound (A) is a π-conjugated system conductive polymer or a derivative thereof.

3. The laminate as claimed in claim 2, wherein the π-conjugated system conductive polymer is one selected from polythiophene, polyaniline, a polythiophene derivative and a polyaniline derivative.

4. The laminate as claimed in claim 1, wherein the fluorine-containing curable compound (B) comprises a repeating unit having a crosslinkable moiety and the crosslinkable moiety is at least any one of a hydroxy group, a silyl group having a hydrolyzable group, a group having a reactive unsaturated double bond, an ring-opening polymerization reactive group, a group having an active hydrogen atom, a group capable of being substituted with a nucleophilic agent, and an acid anhydride.

5. The laminate as claimed in claim 1, wherein the fluorine-containing curable compound (B) is a compound represented by the following formula (1):
(MF1)ₐ-(MF2)_{b}-(MF3)_{c}-(MA)_{d}-(MB)_{c} (1)
wherein, a to e each represents a mole fraction of each constituting component and satisfy 0≦a≦70, 0≦b≦70, 30≦a+b≦70, 0≦c≦50, 5≦d≦50, and 0≦e≦50,
(MF1) represents a constituting component polymerized from a monomer represented by CF₂═CF—Rf₁, wherein Rf₁ represents a perfluoroalkyl group having from 1 to 5 carbon atoms,
(MF2) represents a constituting component polymerized from a monomer represented by CF₂═CF—ORf₁₂, wherein Rf₁₂ represents a fluorine-containing alkyl group having from 1 to 30 carbon atoms,
(MF3) represents a constituting component polymerized from a monomer represented by CH₂═CH—ORf₁₃, wherein Rf₁₃ represents a fluorine-containing alkyl group having from 1 to 30 carbon atoms,
(MA) represents a constituting component having at least one crosslinkable group, and
(MB) represents a constituting component having a polysiloxane structure.

6. The laminate as claimed in claim 1, wherein the composition further contains at least one of (C) a fluorine-containing antifouling agent and (D) a silicone type antifouling agent.

7. The laminate as claimed in claim 1, wherein the composition further contains at least one good solvent for the component (A) and at least one good solvent for the component (B).

8. The laminate as claimed in claim 1, wherein a thickness of the layer formed from the composition is from 20 nm to 5 μm.

9. An antireflective film comprising a laminate comprising a support and a layer formed from a composition containing at least (A) an organic conductive compound and (B) a fluorine-containing curable compound, wherein a common logarithm value(log SR) of surface resistivity SR (Ω/sq) of a surface of the laminate on the layer side is 13.0 or less and a lower part uneven distribution ratio of the organic conductive compound A in the layer defined by the following formula is from 55 to 100 percent:
Lower part uneven distribution ratio=[weight of the component (A) present in a region from a center to a surface of the layer on the support side in a layer thickness direction of the layer formed from the composition containing at least the component (A) and the component (B)]/[total weight of the component (A) present in the whole layer formed from the composition containing at least the component (A) and the component (B)]×100 (%),
wherein the support is a transparent support, and the laminate comprises a low refractive index layer formed from the composition containing at least (A) an organic conductive compound and (B) a fluorine-containing curable compound.

10. A polarizing plate comprising two protective films and a polarizing film provided between the two protective films, wherein at least one of the protective films is an antireflective film comprising a laminate comprising a support and a layer formed from a composition containing at least (A) an organic conductive compound and (B) a fluorine-containing curable compound, wherein a common logarithm value (log SR) of surface resistivity SR (Ω/sq) of a surface of the laminate on the layer side is 13.0 or less, and a lower part uneven distribution ratio of the organic conductive compound (A) in the layer defined b the following formula is from 55 to 100 percent:
Lower part uneven distribution ratio=[weight of the component (A) present in a region from a center to a surface of the layer on the support side in a layer thickness direction of the layer formed from the composition containing at least the component (A) and the component (B)]/[total weight of the component (A) present in the whole layer formed from the composition containing at least the component (A) and the component (B)]×100(%)
wherein the support is a transparent support, and the laminate comprises a low refractive index layer formed from the composition containing at least (A) an organic conductive compound and (B) a fluorine-containing curable compound.

11. An image display device comprising an antireflective film comprising a laminate comprising a and a layer formed from a composition containing at least (A) an organic conductive compound and (B) a fluorine-containing curable compound, wherein a common logarithm value (log SR) of surface resistivity SR (Ω/sq) of a surface of the laminate on the layer side is 13.0 or less, and a lower part uneven distribution ratio of the organic conductive compound (A) in the layer defined by the following formula is from 55 to 100 percent:
Lower art uneven distribution ratio=weight of the component (A) present in a region from a center to a surface of the layer on the support side in a layer thickness direction of the layer formed from the composition containing at least the component (A) and the component (B)]/[total weight of the component (A) present in the whole layer formed from the composition containing at least the component (A) and the component (B)]×100 (%),
wherein the support is a transparent support, and the laminate comprises a low refractive index layer formed from the composition containing at least (A) an organic conductive compound and (B) a fluorine-containing curable compound.
